(19) United States
(12) Patent Application Publication
(10) Pub. No.: US 2006/0171463 A1
(43) Pub. Date: Aug. 3, 2006

(54) Apparatus, system for, method of and computer program product for separating and merging coded signal

(75) Inventors: Tsuyoshi Hanamura, Tokyo (JP); Isao Nagayoshi, Tokyo (JP); Hideyoshi Tominaga, Tokyo (JP)

Correspondence Address: RATNERPRESTIA, P.O. BOX 1596, WILMINGTON, DE, 19899, US

(73) Assignee: Media Glue Corporation, Tokyo 169-0072 (JP)

(21) Appl. No.: 10/547,010

(22) PCT Filed: Feb. 20, 2004
(86) PCT No.: PCT/JP04/02039

§ 371 Date: Jan. 30, 2006

(30) Foreign Application Priority Data
Feb. 28, 2003 (JP) 2003-054048

(51) Int. Cl. H04N 11/04

(52) U.S. Cl. 375/240.13

(57) ABSTRACT

Herein disclosed is a bit stream separating and merging system comprising a bit stream separating apparatus (1000) for inputting and transcoding an original bit stream A to separate into and generate a base bit stream B and one or more extended differential bit streams E*, each having a partial differential information segment between the original bit stream A and the base bit stream B, and a bit stream merging apparatus (2000) for inputting and merging the base bit stream B and the one or more extended differential bit streams E* to reconstruct the original bit stream A or a pseudo original bit stream B* approximately similar to the original bit stream A. The bit stream separating and merging system thus constructed makes it possible for a user to receive the one or more extended differential bit streams E* at respective bit rates each lower than that of original bit stream A to reconstruct the original bit stream A or the pseudo original bit stream B* in combination with the base bit stream B already received or stored.

### TECHNICAL FIELD

The present invention relates to an apparatus for, a system for, a method of, and a computer program for separating and merging a coded moving picture sequence signal, and more particularly to an apparatus for, a system for, a method of, and a computer program for transcoding a first coded moving picture sequence signal to separate into and generate a second coded moving picture sequence signal and one or more extended differential coded moving picture sequence signals each having a partial differential information segment between the first coded moving picture sequence signal and the second coded moving picture sequence signal, and merging the second coded moving picture sequence signal and the one or more extended differential coded moving picture sequence signals to reconstruct the first coded moving picture sequence signal or a pseudo first coded moving picture sequence signal approximately similar to the first coded moving picture sequence signal, and an apparatus for, a system for, a method of, and a computer program for generating and extracting the one or more extended differential coded moving picture sequence signals.

### BACKGROUND ART

Up until now, there have been proposed a wide variety of systems for compressing and encoding a moving picture having a considerable amount of data to produce a coded moving picture sequence signal. The international standard, ISO-IEC 13818 was created for a system operable to encode a digital video signal with an associated digital audio signal and commonly called “Moving Picture Expert Group Phase 2”, hereinlater simply referred to as “MPEG-2”. In such a system, the coded moving picture sequence signal is outputted in the form of bit streams. In particular, the bit streams conformable to the above MPEG-2 standard will be referred to as “MPEG-2 bit streams” hereinlater. Recently, the system of this type becomes more utilizable for various technical fields, such as a communications system, a television broadcasting service system, and so on.

The above MPEG-2 bit streams have a hierarchical structure consisting of: in turn, a top, sequence layer; a GROUP OF PICTURES layer; a picture layer; a slice layer; a macroblock layer; and a low, block layer.

The typical encoder is operable under the MPEG-2 standard through a method of compressing and encoding a moving picture as follows. The method comprises the steps of:

(a) inputting the moving picture sequence consisting of a series of pictures;

(b) temporally storing the series of pictures as frames in memories, respectively;

(c) computing a difference between one frame and another frame to eliminate redundancy in a time axis direction; and

(d) orthogonal transforming, e.g., discrete cosine transforming (DCT), a plurality of picture elements within each of the frames to eliminate redundancy in a spatial axis direction.

The encoder thus constructed can compress and encode the moving picture to generate and output a coded moving picture sequence signal in the form of the MPEG-2 bit stream through a transmitting path at a predetermined bit rate. The coded moving picture sequence signal is then transmitted from the encoder to a decoder which is operated to decode the coded signal to reproduce the moving picture.

The typical decoder is operated to decode the coded moving picture sequence signal through a so-called bi-directionally predicting method which comprises the steps of:

(a) storing one reproduced picture, generally referred to as “intra-picture”, i.e., “I-picture”, in a first frame memory;

(b) estimating another picture generally referred to as “predictive-picture”, i.e., “P-picture”, following the I-picture, on the basis of the information on a difference between the I-picture and P-picture;

(c) storing the estimated P-picture in a second frame memory; and

(d) estimating further another picture interposed between the I-picture and P-picture, generally referred to as “bi-directionally predictive-picture”, i.e., “B-picture”.

Here, the I-picture is encoded independently of the pictures of the other types, so that an I-picture can be reproduced as a single static image only by itself. A P-picture can be predicted on the basis of the I-picture or another P-picture located on a position prior to the P-picture to be encoded. I-picture is referred to as “intra-picture” while P-picture and B-picture are referred to as “inter-pictures”.

In the above encoder, the amount of information on the coded moving picture sequence signal is, however, variable. In particular, the amount of information increases remarkably when a scene is changed. The decoder is generally provided with an input buffer for receiving the coded moving picture sequence signal from the encoder. The input buffer of the decoder, however, has a limited storage capacity. Therefore, when a large number of bits of the coded moving picture sequence signal are transmitted from the encoder to the decoder, the input buffer overflows with the bits of the coded moving picture sequence signal thereby making the decoder difficult to process the coded moving picture sequence signal. In order to transmit such a coded moving picture sequence signal having a variable number of bits through the transmitting path at a predetermined bit rate and to make it possible for any decoder to receive the whole of the coded moving picture sequence signal without overflow, the encoder comprises: an output buffer for temporally storing the coded moving picture sequence signal before transmitting the coded moving picture sequence signal through the transmitting path; and a rate controller for controlling the amount of bits of the coded moving picture sequence signal stored in the output buffer so as to keep the amount of bits of the coded moving picture sequence signal to be transmitted to the decoder for a predetermined time from exceeding the capacity of the input buffer of the decoder, thereby controlling the bit rate of the coded moving picture sequence signal.

A typical rate controlling method in the MPEG-2 standard is described in “ISO-IEC/JTC1/SC29/WG11/N0400 Test Model 5”, April, 1993, hereinlater referred to as “TM-5”. The rate controlling method according to the TM-5 comprises the steps of:

(I) allocating a target number of bits to a picture of each type on the basis of the total number of bits, i.e., R, available to the pictures to be encoded in the GROUP OF PICTURES;

(II) computing the reference value of a quantization parameter used for the quantization of each of macroblocks in the picture on the basis of the utilization capacity of a “virtual buffer” to perform the rate control; and

(III) modulating the reference value of the quantization parameter in accordance with the spatial activity in the macroblock.

Furthermore, there are many types of decoders. The decoder of one type is designed to decode the coded signal in a unique compression format different from that of the MPEG-2 bit stream, and another example of the decoder is connectable to a transmitting path having a different bit rate. The those types of decoders are therefore required to be provided with an apparatus, a so-called transcoder, for converting the MPEG-2 bit streams into another appropriate coded signal in the specified format having the required bit rate. The transcoder makes it possible for the encoder to transmit the coded signal to any types of decoders.

Referring to FIG. 18 of the drawings, there is shown a transcoder of one typical type, hereinlater referred to as a first conventional transcoder 50. The first conventional transcoder 50 has an input terminal a₁ electrically connected to a first transmitting path, not shown, and an output terminal a₂ electrically connected to a second transmitting path, not shown. The first conventional transcoder 50 is designed to input original bit streams b₁ at a predetermined input bit rate through the input terminal a₁, to convert the original bit streams b₁ into base bit streams b₂ to be outputted at a predetermined output bit rate, i.e., a target bit rate, lower than the input bit rate of the inputted original bit streams b₁, and then to output the base bit streams b₂ through the output terminal a₂. The first conventional transcoder 50 comprises a variable length decoder 51, referred to as “VLD” in the drawings, an inverse quantizer 53, referred to as “IQ” in the drawings, a quantizer 55, referred to as “Q” in the drawings, a variable length encoder 57, referred to as “VLC” in the drawings, and a rate controller 59.

The variable length decoder 51 is electrically connected to the input terminal a₁ and designed to decode a coded moving picture sequence signal within the original bit streams b₁ inputted through the input terminal a₁ to reconstruct original picture data for each of pictures including a matrix of original quantization coefficients, referred to as “level”, for each of macroblocks within each of the pictures and an original quantization parameter, hereinlater referred to as “first quantization parameter Q₁”.

The inverse quantizer 53 is electrically connected to the variable length decoder 51 and designed to input the matrix of original quantization coefficients level from the variable length decoder 51 and the first quantization parameter Q₁. The inverse quantizer 53 is further designed to inversely quantize the inputted matrix of original quantization coefficients level with the first quantization parameter Q₁ to generate a matrix of inverse-quantization coefficients, referred to as “dequant”, i.e., DCT coefficients, for each of macroblocks as follows:

$$\begin{matrix}dequant = \{ 2 \times level + sign ( level ) \} \times \frac{{Q}_{1} \times QM}{32} or & equation ( a1 ) \\ dequant = level \times \frac{{Q}_{1} \times QM}{16} & equation ( a2 )\end{matrix}$$

where the equation (a1) is used for the intra-picture while the equation (a2) is used for the inter-picture. QM is a matrix of quantization parameters stored in a predetermined quantization table. The first quantization parameter Q₁ and the matrix of quantization parameters QM are derived from the inputted original bit streams b₁ by the decoder 51. Here, the original quantization coefficients level, the inverse-quantization coefficients dequant, the matrix of quantization parameters QM, and the first quantization parameter Q₁ are integers. The inverse-quantization coefficients dequant calculated by the equations (a1) and (a2) should be rounded down to the nearest one.

The quantizer 55 is electrically connected to the inverse quantizer 53 and designed to input the matrix of inverse-quantization coefficients dequant from the inverse quantizer 53 and then quantize the inputted matrix of inverse-quantization coefficients dequant for each of macroblocks with a second quantization parameter, referred to as “Q₂” hereinlater, to generate a matrix of re-quantization coefficients, referred to as “tlevel”, as follows:

$$\begin{matrix}tlevel = dequant \times \frac{16}{{Q}_{2} \times QM} or & equation ( a3 ) \\ tlevel = dequant \times \frac{16}{{Q}_{2} \times QM} + sign ( dequant ) \times \frac{1}{2} & equation ( a4 )\end{matrix}$$

where the equation (a3) is used for the inter-picture, while the equation (a4) is used for the inter-picture. The second quantization parameter Q₂ is obtained by the rate controller 59. Here, the re-quantization coefficients tlevel and the second quantization parameter Q₂ are also integers. The re-quantization coefficients tlevel calculated by the equations (a3) and (a4) should be rounded down to the nearest one. Such rounding operation for the integers will be omitted from the later description for avoiding tedious repetition.

The variable length encoder 57 is electrically connected to the quantizer 55 and designed to input the re-quantization coefficients tlevel from the quantizer 55 and then encode the inputted matrix of the re-quantization coefficients tlevel to generate objective picture data for each of pictures to sequentially output the objective picture data in the form of the base bit streams b₂ through the output terminal a₂. The variable length encoder 57 is further electrically connected to the variable length decoder 51 and designed to input a diversity of information data included in the original bit streams b₁ necessary for the base bit streams b₂ from the variable length decoder 51.

The rate controller 59 is electrically connected to the inverse quantizer 53 and designed to perform rate control process in accordance with the TM-5 on the basis of the information obtained from the inverse quantizer 53 as described below.

Referring to FIG. 19 of the drawings, there is shown a flowchart of the rate controlling process in accordance with the TM-5 carried out in the first conventional transcoder 50. As shown in FIG. 19, the rate controlling process comprises steps A1 to A14.

In the step A1, “1” is assigned to a picture number variable n representing the serial number of a picture within the original bit streams b₁. Hereinlater, an n-th picture in the original bit streams b₁ is referred to as “pic(n)”.

In the following step A2, a global complexity measure, referred to as Xᵢ, Xₚ, or X_{b}, for a picture of the corresponding type, i.e., L P or B-picture is computed as follows:
Xᵢ=SᵢxQᵢ equation (a5)
or
Xₚ=Sₚ×Qₚ equation (a6)
or
X_{b}=S_{b}×Q_{b} equation (a7)

where Sᵢ, Sₚ, or S_{b} is the number of bits generated for an encoded I, P or B-picture, and Qᵢ, Qₚ, or Q_{b} is the average quantization parameter computed by averaging the actual quantization values used during the quantization of the all macroblocks within L P or B-picture. The average quantization parameters Qᵢ, Qₚ, and Q_{b} are normalized within a range of 1 to 31. The average quantization parameters Qᵢ, Qₚ, and Q_{b} respectively correspond to the first quantization parameters Q₁ obtained from the variable length decoder 51.

The global complexity measure Xᵢ, Xₚ, or X_{b} of the corresponding picture is inversely proportional to the compressing ratio of the moving picture, namely, the ratio of the amount of information in the base bit streams b₂ to that in the original bit streams b₁. Namely, as the amount of information in the original bit streams b₁ becomes larger, the compressing ratio is decreased. Therefore, the global complexity measure Xᵢ, Xₚ, or X_{b} of the corresponding picture becomes larger, as the compressing ratio is decreased. In contrast, the global complexity measure Xᵢ, Xₚ, or X_{b} of the corresponding picture becomes smaller, as the compressing ratio is increased.

The initial value of global complexity measure Xᵢ, Xₚ, or X_{b} of the corresponding picture is given as follows:
Xᵢ=160×Target Bitrate/115 equation (a8)
or
Xₚ=60×Target_Bitrate/115 equation (a9)
or
X_{b}=42×Target Bitrate/115 equation (a10)

where Target_Bitrate is measured in bits/s and corresponds to the target bit rate of the first conventional transcoder 50.

In the following step A3, the target number of bits for a picture of the corresponding type, i.e., L P or B-picture to be encoded in the current GROUP OF PICTURES, referred to as Tᵢ, Tₚ, or T_{b} is computed as:

$$\begin{matrix}{T}_{i} = \frac{R}{1 + \frac{{N}_{p} {X}_{p}}{{X}_{i} {K}_{p}} + \frac{{N}_{b} {X}_{b}}{{X}_{i} {K}_{b}}} or & equation ( a11 ) \\ {T}_{p} = \frac{R}{{N}_{p} + \frac{{N}_{b} {K}_{p} {X}_{b}}{{K}_{b} {X}_{p}}} or & equation ( a12 ) \\ {T}_{b} = \frac{R}{{N}_{b} + \frac{{N}_{p} {K}_{b} {X}_{p}}{{K}_{p} {X}_{b}}} & equation ( a13 )\end{matrix}$$

where Nₚ and N_{b} are the number of P-pictures and B-pictures remained not yet encoded in the current GROUP OF PICTURES, respectively. Kₚ and K_{b} are constants computed on the basis of the ratio of the quantization value of P-picture to the quantization value of I-picture, and the ratio of the quantization parameter of B-picture to the quantization value of I-picture, respectively. When it is assumed that the quality of the image can be always optimized with Kₚ=1.0 and K_{b}=1.4.

In the following step A4, it is judged upon whether the picture number variable n is “1” or not, i.e., the current picture is the first picture pic(1) or not. When it is judged that the picture number variable n is “1”, i.e., the current picture is the first picture pic(1), the step A4 goes forward to the step A5. When, on the other hand, it is judged that the picture number variable n is not “1”, i.e., the current picture is not the first picture, the step A4 goes forward to the step A6. In the step A5, the total number of bits available to the pictures to be encoded in the current GROUP OF PICTURES, i.e., the remaining number of bits available to the GROUP OF PICTURES, hereinlater referred to as R, is initialized in accordance with the following equation (a14). This remaining number of bits available to the GROUP OF PICTURES R is computed before encoding the first picture pic(1) within the GROUP OF PICTURES, as follows:
R=Target_Bitrate×NPIC/picture_rate+R equation (a14)

where NPIC is the total number of pictures of any type in the GROUP OF PICTURES, and picture_rate is expressed in the number of pictures decoded and indicated per second. At the start of the sequence R=0.

In the step A6, the above remaining number of bits available to the GROUP OF PICTURES R is updated before encoding the current picture pic(n) as follows:
R=R−Sᵢ equation (a15)
or
R=R−Sₚ equation (a16)
or
R=R−S_{b} equation (a17)

where Sᵢ, Sₚ, or S_{b} is the number of bits generated in the previously encoded picture pic(n−1) of the corresponding type (I, P or B).

The step A5 or A6 goes forward to the step A7 wherein “1” is assigned to a macroblock number variable j (j>=1) representing the serial number of a macroblock within one of the pictures. Hereinlater, the j-th macroblock in the picture is referred to as “M(j)”.

In the following step A8, a utilization volume of the capacity of a virtual buffer for I, P or B-pictures, referred to as dᵢ(j), dₚ(j) or d_{b}(j), is computed before encoding the macroblock MB(j) as follows:

$$\begin{matrix}{d}_{i} ( j ) = {d}_{i} ( 0 ) + B ( j - 1 ) - \frac{{T}_{i} \times ( j - 1 )}{NMB} or & equation ( a18 ) \\ {d}_{p} ( j ) = {d}_{p} ( 0 ) + B ( j - 1 ) - \frac{{T}_{p} \times ( j - 1 )}{NMB} or & equation ( a19 ) \\ {d}_{b} ( j ) = {d}_{b} ( 0 ) + B ( j - 1 ) - \frac{{T}_{b} \times ( j - 1 )}{NMB} & equation ( a20 )\end{matrix}$$

where B(j−1) is the total number of bits generated for encoded macroblocks in the picture up to and including the (j−1)th macroblock MB(j−1). NMB is the total number of macroblocks in the picture. dᵢ(j), dₚ(j), or d_{b}(j) is the utilization volume of the capacity of the virtual buffer at the j-th macroblock MB(j) for L P, or B-picture.

dᵢ(0), dₚ(0), or d_{b(0)} is the initial utilization volume of the virtual buffer for L P, or B-picture and given by:
dᵢ(0)=10×r/31 equation (a21)
or
dₚ(0)=Kₚ×dᵢ(0) equation (a22)
or
d_{b(0)}=K_{b}dᵢ(0) equation (a23)

where r is referred to as “reaction parameter” and used for the control of the reaction rate of the feed back loop as follows:
r=2×Target_Bitrate/picture_rate equation (a24)

The final utilization volume of the virtual buffer, referred to as, dᵢ(NMB), dₚ(NMB), or d_{b}(NMB) of the last macroblock, i.e., NMB-th macroblock MB(NMB) of the current picture pic(n) will be used as the initial utilization volume of the virtual buffer for I, P, or B-picture, i.e., dᵢ(0), dₚ(0), or d_{b(0)} of the same type to encode the first macroblock MB(1) within the next picture pic(n+1).

In the following step A9, the reference quantization parameter Q(j) of the j-th macroblock MB(j) for each of the pictures is computed on the basis of the aforesaid utilization volume of the virtual buffer, i.e., d(j) as follows:
Q(j)=d(j)×31/r equation (a25)

Here, the reference quantization parameter Q(j) is identical with the aforesaid second quantization parameter Q₂ of the j-th macroblock MB(j).

In the following step A10, the j-th macroblock MB(j) is quantized with the reference quantization parameter Q(j) computed in the step A9. In the following step A11, the macroblock number variable j is incremented by one. The step A11 goes forward to the step A12 wherein it is judged upon whether the macroblock number variable j is more than the total number of macroblocks NMB within the n-th picture pic(n) or not. When it is judged that the macroblock number variable j is not more than the total number of macroblocks NMB within the n-th picture pic(n), the step A12 returns to the step A8. When, on the other hand, it is judged that the macroblock number variable j is more than the total number of macroblocks NMB within the n-th picture pic(n), the step A12 goes forward to the step A13.

The macroblock number variable j thus serves as a loop counter for repeating the process from the steps A8 to A11 to encode all the macroblocks from the 1^{st} macroblock MB(1) up to the j-th macroblock MB(j) in the present picture pic(n). The entire macroblocks starting from the first macroblock MB(1) up to the NMB-th macroblock MB(NMB) in the n-th picture pic(n) can be thus encoded sequentially.

In the step A13, the picture number variable n is incremented by one. Then the step A13 goes forward to the step A14 wherein it is judged upon whether the picture number variable n is more than the total number of pictures, i.e., NPIC or not. When it is judged that the picture number variable n is not more than the total number of pictures, NPIC, the step A14 returns to the step A2. When, on the other hand, it is judged that the picture number variable n is more than the total number of pictures, NPIC, this routine of the rate controlling process is terminated. The picture number variable n thus serves as a loop counter for repeating the process from steps A2 to A13 to process all the pictures from the first picture pic(1) to the n-th picture pic(n) in the present GROUP OF PICTURES. The entire pictures starting from the first picture pic(1) up to the NPIC-th picture pic(NPIC), in the present GROUP OF PICTURES can be therefore processed sequentially.

The aforesaid first conventional transcoder 50, however, has no information on the structure of GROUP OF PICTURES such as a picture cycle of I or P-pictures within each of the GROUP OF PICTURES, so that the first conventional transcoder 50 must estimate the structure of GROUP OF PICTURES within the inputted moving picture sequence signal to allocate the number of bits to pictures of each type within the estimated structure of GROUP OF PICTURES.

Furthermore, the first conventional transcoder 50 is required to decode the original bit streams b₁ almost all over the layers such as the sequence layer, the GROUP OF PICTURES layer, the picture layer, the slice layer, and the macroblock layer in order to derive necessary data for transcoding the original bit streams b₁ into the base bit streams b₂. The operation takes time, thereby causing the delay in the transcoding process.

Referring to FIG. 20 of the drawings, there is shown an improvement of the above first conventional transcoder 50, hereinlater referred to as a second conventional transcoder 60. The second conventional transcoder 60 is operated to perform the rate control without estimating the structure of GROUP OF PICTURES. As shown in FIG. 20, the second conventional transcoder 60 comprises a delay circuit 61 and a rate controller 62 in addition to the variable length decoder 51, the inverse quantizer 53, the quantizer 55 and the variable length encoder 57 same as those of the first conventional transcoder 50 shown in FIG. 18. The same constitutional elements are simply represented by the same reference numerals as those of the first conventional transcoder 50, and will be thus omitted from the later description for avoiding tedious repetition.

The delay circuit 61 is interposed between the variable length decoder 51 and the inverse quantizer 53 and designed to control the flow of the signal from the variable length decoder 51 to the inverse quantizer 53. The delay circuit 61 is operated to delay the operation start time of the inverse quantizer 53 so that the inverse quantizer 53 does not start the inverse-quantizing process until the variable length decoder 51 terminates the process of decoding one of the pictures in the coded moving picture sequence signal.

As shown in FIG. 20, the rate controller 62 of the second conventional transcoder 60 includes a target ratio computing unit 63, an input bit summing unit 65, a bit difference computing unit 67, a target output bit updating unit 69, and a quantization parameter computing unit 71.

The target ratio computing unit 63 is electrically connected to the variable length decoder 51 and designed to input an input bit rate of the original bit streams b₁, hereinlater referred to as “Input_Bitrate”, from the variable length decoder 51, and input a target bit rate, hereinlater referred to as “Target_Bitrate” through a terminal a₃. Alternatively, the target bit rate Target_Bitrate may have been stored in an internal memory, or determined on the basis of internal switches. The target ratio computing unit 63 is designed to then compute a target ratio, hereinlater referred to as “ioRatio” of the target bit rate Target_Bitrate to the input bit rate Input_Bitrate for each of pictures as follows:

$$ioRatio = \frac{Target\_Bitrate}{Input\_Bitrate} \qquad equation ( a26 )$$

The input bit summing unit 65 is designed to sum up the number of inputting bits of the picture decoded by the variable length decoder 51 to produce the total number of inputting bits, hereinlater referred to as “Tᵢₙ”. On the other hand, the target output bit updating unit 69 is designed to compute a target number of outputting bits to be generated by the variable length encoder 57, hereinlater referred to as “Tₒᵤₜ”. The target number of outputting bits Tₒᵤₜ is computed by multiplying the total number of inputting bits Tin by the target ratio ioRatio as follows:
Tₒᵤₜ=Tᵢₙ×ioRatio equation (a27)

The bit difference computing unit 67 is electrically connected to the variable length encoder 57 and the target output bit updating unit 69, and designed to input a real number of outputting bits encoded by the variable length encoder 57, hereinlater referred to as “Tᵣₑₐₗ”, and input the target number of outputting bits Tₒᵤₜ. The bit difference computing unit 67 is designed to then compute a difference between the target number of outputting bits Tₒᵤₜ and the real number of outputting bits Tᵣₑₐₗ, hereinlater referred to as a “difference number of bits”, i.e., “T_{diff}” as follows:
T_{diff}=Tᵣₑₐₗ−Tₒᵤₜ equation (a28)

The target output bit updating unit 69 is electrically connected to the target ratio computing unit 63, the input bit summing unit 65, and the bit difference computing unit 67. The target output bit updating unit 69 is designed to update the target number of outputting bits Tₒᵤₜ on the basis of the difference number of bits T_{diff} as follows:
Tₒᵤₜ=Tₒᵤₜ−T_{diff} equation (a29)

The quantization parameter computing unit 71 is electrically connected to the target output bit updating unit 69 and designed to compute the reference quantization parameter Q(j) for each of macroblocks MB(j) on the basis of the target outputting bits Tₒᵤₜ updated by the target output bit updating unit 69 in accordance with the step 11 of the TM-5.

FIG. 21 shows the flowchart of the rate controlling process performed by the above second conventional transcoder 60. The rate controlling process performed in the second conventional transcoder 60 comprises the steps B1 to B13. The steps B6 to B13 are almost the same as those of the steps A7 to A14, respectively, in the rate controlling process shown in FIG. 19 except for the step B7 wherein the utilization volume of the capacity of the virtual buffer is computed on the basis of the target number of outputting bits Tₒᵤₜ given by the target output bit updating unit 69 instead of the target number of bits Tᵢ, Tₚ or T_{b} computed in the step A3 shown in FIG. 19. The same steps will be thus omitted from the later description for avoiding tedious repetition.

In the step B1, “1” is assigned to the picture number variable n. The step B1 then goes forward to the step B2 wherein the target ratio ioRatio is computed by the above equation (a26). In the following step B3, the difference number of bits T_{diff} is computed for the present picture pic(n) by the above equation (a28). The step B3 then goes forward to the step B4 wherein the number of inputting bits Tᵢₙ is summed up within the original bit streams b1. In the step B5, the target number of outputting bits Tₒᵤₜ is computed by the above equation (a27), and further updated by the above equation (a29).

In the second conventional transcoder 60 thus constructed, the inverse quantizer 53, however, cannot start the inverse-quantization process until the target transcoding frame is completely decoded, thereby causing the delay in the transcoding process.

Referring to FIGS. 21 and 22 of the drawings, there is shown another improvement of the above fist conventional transcoder 50 as a third conventional transcoder 80. The third conventional transcoder 80 is also adaptable to perform the rate control without estimating the structure of GROUP OF PICTURES. As shown in FIG. 22, the third conventional transcoder 80 comprises an input terminal a₁ electrically connected to a first transmitting path and designed to input an input bit streams b₃ at the input bit rate, and an output terminal a₂ electrically connected to a second transmitting path and designed to output an output bit streams b₄ at the target bit rate. In the third conventional transcoder 80, the input bit streams b₃ may have a format, non-adaptable for the MPEG-2, different from that of the bit streams b₁ of the first and second conventional transcoders 50 and 60. The input bit streams b₃ have information on the number of coding bits previously recorded thereon by the encoder, not shown.

The third conventional transcoder 80 comprises a variable length decoder 81 electrically connected to the input terminal a₁, and a rate controller 82 in addition to the inverse quantizer 53, the quantizer 55, and the variable length encoder 57 which are same as those of the second conventional transcoder 60 shown in FIG. 20. The rate controller 82 includes a target output bit updating unit 83, and a quantization parameter computing unit 85 in addition to the target ratio computing unit 63, and the bit difference computing unit 67 which are same as those of the second conventional transcoder 60 shown in FIG. 20.

The third conventional transcoder 80 thus constructed can perform the rate control on the basis of the formation on the number of coding bits previously recorded in the input bit streams b₃. The variable length decoder 81 is operated to decode the coded moving picture sequence signal within the third bit streams b₃ to reconstruct the pictures and the information on the number of coding bits, and transmit the information to the inverse quantizer 53. The variable length decoder 81 is also operated to transmit the number of inputting bits Tᵢₙ to the target output bit updating unit 83.

The outputting bit updating unit 83 is designed to compute the target number of outputting bits Tₒᵤₜ on the basis of the number of inputting bits Tᵢₙ and the target ratio ioRatio by the above equation (a26). The quantization parameter computing unit 85 is designed to compute the reference quantization parameter Q(j) of the macroblocks MB(j) for each of pictures on the basis of the target number of outputting bits Tₒᵤₜ updated by the outputting bit updating unit 83 in accordance with the step II in the TM-5. The quantizer 55 is then operated to quantize the j-th macroblock MB(j) on the basis of the reference quantization parameter Q(j) given by the quantization parameter computing unit 85.

FIG. 23 shows the flowchart of the rate controlling process performed by the above third conventional transcoder 80. The rate controlling process performed in the transcoder 80 comprises the steps C1 to C13. All the steps C1 to C13 are the same as those of the steps B1 to B13, respectively, in the rate controlling process shown in FIG. 21 except for the step C4 wherein the number of inputting bits Tᵢₙ in the current picture pic(n) is derived from the third bit streams b₃ by the decoder 81 to compute the total number of inputting bits Tᵢₙ.

The third conventional transcoder 80 thus constructed has information on the number of coding bits previously recorded in the third bit streams b₃ thereby making it possible to solve the problem of the delay in the second conventional transcoder 60. The third conventional transcoder 80, however, encounters another problem to restrict the form of the inputted bit streams. Moreover, the encoder which is linked with the third transcoder 80 must provide with the above information on the number of coding bits to be recorded in the bit streams, thereby causing the delay of process in the encoder.

In any one of the conventional transcoders 50, 60 and 80, the matrix of the inverse-quantization coefficients dequant is necessary for only the quantizer 55, but unnecessary for the transcoder itself to generate the desired bit streams. In order to eliminate the redundant matrix of the inverse-quantization coefficients dequant, there is proposed a fourth conventional transcoder 90 comprising a level converter 91 instead of the inverse quantizer 53 and the quantizer 55 of the transcoder 50, as shown in FIG. 24.

The level converter 91 is interposed between the variable length decoder 51 and the variable length encoder 57. The level converter 91 is designed to input the original picture data for each of pictures. The original picture data includes a matrix of original quantization coefficients level for each of macroblocks within the corresponding picture. The level converter 91 is electrically connected to the rate controller 59 and designed to input the second quantization parameter Q2 from the rate controller 59.

The level converter 91 is further designed to convert the original picture data for each of pictures including the matrix of original quantization coefficients level into the objective picture data including the matrix of re-quantization coefficients tlevel without generating the matrix of the inverse-quantization coefficients dequant. The following equations (30a) and (31a) for the matrix of re-quantization coefficients tlevel are lead by eliminating the matrix of the inverse-quantization coefficients dequant from the above equations (a1), (a2), (a3) and (a4).

$$\begin{matrix}tlevel = \{ ( level + sign ( level ) \times \frac{1}{2} \} \times \frac{{Q}_{1}}{{Q}_{2}} or & equation ( 30 a ) \\ tlevel = level \times \frac{{Q}_{1}}{{Q}_{2}} + \frac{sign ( level )}{2} & equation ( 31 a )\end{matrix}$$

where the above equation (30a) is used for the inter-picture, while the above equation (31a) is used for the intra-picture. The level converter 91 is thus operable to convert the original picture data, for each of pictures, into the second picture data with the first quantization parameter Q₁ and the second quantization parameter Q₂. The first quantization parameter Q₁ is decoded from the original bit streams b₁ by the variable length decoder 51, while the second quantization parameter Q₂ is obtained from the rate controller 59.

In the fourth conventional transcoder 90, the rate controller 59 is designed to perform the rate control over the encoding process in the transcoder 90 according to the TM-5. The variable length encoder 57 is electrically connected to the level converter 91 and to input the above matrix of re-quantization coefficients tlevel from the level converter 91.

The fourth conventional transcoder 90 thus constructed can efficiently perform the transcoding process at high speed without storing the matrix of inverse-quantization coefficients dequant in a memory.

The above conventional transcoders 50, 60, 80 and 90, however, encounters another problem with the rate-distortion performance in converting the quantization level. In short, the rate-distortion performance in converting the quantization level is unstable and variable in accordance with the first and second quantization parameters and the level of the original quantization coefficients level. Therefore, as the amount of reduced information becomes larger, the quantization error is liable to increase, thereby causing the unstable rate control in transcoding.

The applicant of the present invention disclosed an apparatus, a method and a computer program for transcoding a coded moving picture sequence signal, being operable to compute the optimized quantization parameter on the basis of the inverse-quantization parameter and the previously computed quantization parameter in consideration of the characteristics of the rate-distortion performance dependent on the quantization parameter and the inverse-quantization parameter in U.S. Pat. No. 6,587,508, filed Jun. 28, 2000.

The transcoder disclosed in the aforesaid U.S. Pat. No. 6,587,508, comprising the inverse quantizer for performing the inverse-quantization operation and the quantizer for performing the quantization operation, is characterized in that the transcoder further comprises quantization parameter switching means for switching the quantization parameter in consideration of the characteristics of the rate-distortion performance dependent on the inputted quantization parameter, thereby making it possible for the transcoder to minimize the quantization error occurred when the matrix of original quantization coefficients is transformed to the matrix of re-quantization coefficients.

There are provided methods such as data partitioning and SNR scalability for dividing a picture signal conveying picture information into two separate picture signals consisting of a base layer picture signal indicative of basic picture information and enhancement layer picture signal indicative of high quality picture information in order to prevent the quality of picture from deteriorating.

The data partitioning provides a method of dividing a bit stream conveying original picture information into two separate bit streams consisting of a base layer bit stream having low-frequency DCT coefficients and an enhancement layer bit stream having a high-frequency DCT coefficient before encoding, and the thus divided base layer bit stream and enhancement layer bit stream are recombined before decoding. The original picture information can be roughly decoded and reproduced on the basis of the base layer bit streams indicative having the low-frequency DCT coefficients alone, but not on the basis of the enhancement layer bit streams having the high-frequency DCT coefficients alone. The high quality of the original picture information can be decoded and reproduced on the basis of the recombination of the base layer bit streams having the low-frequency DCT coefficients and the enhancement layer having the high-frequency DCT coefficients.

The SNR scalability provides a method of dividing a picture signal containing picture information into two separate picture signals consisting of a base layer picture signal indicative of a low-SNR image and an enhancement layer picture signal indicative of a high-SNR image before encoding. The method of SNR scalability will be described in detail hereinlater. The original picture signal has original DCT coefficients. The quantizer is operative to roughly quantize the base layer bit picture signal indicative of the low-SNR image to generate low-SNR bit streams. The inverse quantizer is operated to inversely quantize the thus generated low-SNR bit stream to roughly reproduce DCT coefficients. Then, the difference information between the original DCT coefficients and the reproduced DCT coefficients is extracted and quantized to generate the enhancement layer picture signal. The enhancement layer picture signal thus generated is used as auxiliary information in combination with the base layer picture signal (low-SNR signal) to reproduce a high-SNR signal.

The above described methods, however, encounter a problem of decreasing the quality of service, i.e., QoS. The transcoding process as previously described is non-reversible. The transcoder, in general, is operated to decode and inversely quantized DCT coefficients of input bit streams and re-quantize the DCT coefficients thus inversely quantized with re-quantization parameters greater then the original quantization parameters to reduce the amount of bits. This means that the QoS of the input bit streams cannot be reproduced.

The method of the data partitioning is operated to divide bit streams into two separate bit streams consisting of base layer bit streams having low-frequency DCT coefficients and enhancement layer bit streams having high-frequency DCT coefficients before encoding. There is, however, provided no method of dividing MPEG-2 bit streams in conformable with MP@ML, which are nonhierarchical in structure, into a base layer bit stream and an enhancement layer bit stream. Furthermore, although the method of the data partitioning is performed to divide a bit stream into the base layer bit streams and the enhancement layer bit streams before encoding, the base layer bit streams and enhancement layer bit streams thus divided cannot be decoded by a decoder conformable to MP@ML. This leads to the fact that a decoder dedicated to the data partitioning is required in place of the MP@ML conformable decoder in order to decode the base layer bit streams and enhancement layer bit streams. According to the syntax of the data partitioning, the code specifying a boundary between the low-frequency coefficients and the high-frequency coefficients is defined as “Priority_break_point”, which makes it possible for the data partitioning dedicated decoder to distinguish the low-frequency coefficients from the high-frequency coefficients. The MP@ML conformable decoder, on the other hand, cannot recognize the code “Priority_break_point”. Furthermore, the MP@ML conformable decoder cannot reproduce the bit streams having low-frequency coefficients because of the fact that the bit streams having the low-frequency coefficients include no EOB code.

Similarly to the data partitioning, the method of the SNR scalability is operative to divide a bit stream into two separate bit stream consisting of a base layer bit stream indicative of a low-SNR image and a enhancement layer bit stream having an auxiliary signal before encoding. A MP@ML conformable encoder cannot divide the bit stream into a base layer bit stream indicative of a low-SNR image and an enhancement layer bit stream having an auxiliary signal and encode the base layer bit stream and enhancement layer bit stream thus divided. Nor can a MP@MP conformable decoder decode the base layer bit stream and the enhancement layer bit stream. This leads to the fact that an encoder and a decoder dedicated to the SNR scalability are required in place of the MP@ML conformable encoder and decoder.

The SNR scalability conformable encoder and decoder have the following drawbacks. Firstly, the SNR scalability conformable encoder and decoder are complex and difficult to design because of the fact that the base layer bit stream and the enhancement layer bit stream are required to be processed in parallel. Secondly, the SNR scalability conformable decoder is operative to receive the base layer bit streams and the enhancement layer bit streams to reproduce and output original picture signals not in the form of bit streams. This means that the picture signals thus reproduced and outputted are required to be encoded again if the original picture signals are requested to be in the form of bit streams.

That fact that the above data partitioning and SNR scalability operations require respective dedicated encoders and decoders is attributed to the fact that the respective dedicated decoders and encoders are operative to perform the process of dividing bit streams into base layer bit streams and the enhancement layer bit streams, and the process of recombining the base layer bit streams and the enhancement layer bit streams to reconstruct original bit streams.

In order to solve the above problems, the present invention is to propose an apparatus for, a method of, and a computer program for transcoding a first coded moving picture sequence signal to separate into and generate a second coded moving picture sequence signal and one or more extended differential coded moving picture sequence signals, each of which contains partial differential information between the first coded moving picture sequence signal and the second coded moving picture sequence signal, each of which contains partial differential information between the first coded moving picture sequence signal and the second coded moving picture sequence signal, and merging the second coded moving picture sequence signal and the extended differential coded moving picture sequence signal to reconstruct the first coded moving picture sequence signal, and apparatuses for, systems for, methods of, and computer programs for generating and extracting the extended differential coded moving picture sequence signal. The apparatus, method, and computer program thus constructed make it possible for a user to receive transcoded MPEG-2 bit streams at a bit rate lower than that of original MPEG-2 bit streams to reproduce low-quality picture information, and later receive the extended differential bit streams to reconstruct a pseudo original MPEG-2 bit streams approximately similar to the original MPEG-2 bit streams in combining with the earlier received transcoded MPEG-2 bit streams to reproduce high-quality picture information.

Furthermore, the apparatus, system, method, and computer program thus constructed make it possible for a user to decode and transcode MPEG-2 bit streams without any additional dedicated encoders or decoders unlike the aforesaid scalability and data partitioning methods.

### DISCLOSURE OF INVENTION

It is, therefore, an object of the present invention to provide an apparatus for transcoding a first coded moving picture sequence signal to separate into and generate a second coded moving picture sequence signal and one or more extended differential coded moving picture sequence signals, each of which contains partial differential information between the first coded moving picture sequence signal and the second coded moving picture sequence signal, and merging the second coded moving picture sequence signal and the extended differential coded moving picture sequence signal to reconstruct a pseudo first coded moving picture sequence signal, which is approximately similar to the first coded moving picture sequence signal, thereby making it possible for a user to receive the second coded moving picture sequence signal at a bit rate lower than that of first coded moving picture sequence signal to reproduce a low-quality picture information, and later receive the extended differential coded moving picture sequence signal to reconstruct a pseudo first coded moving picture sequence signal approximately similar to the first coded moving picture sequence signal. Furthermore the apparatus thus constructed makes it possible for a user to decode or transcode the moving picture sequence signal without any additional dedicated encoders or decoders unlike the aforesaid scalability and data partitioning methods.

It is another object of the present invention to provide an apparatus for generating and extracting an extended differential coded moving picture sequence signal, thereby making it possible for a user to receive the extended differential coded moving picture sequence signal at a bit rate lower than that of first coded moving picture sequence signal to reconstruct a pseudo first coded moving picture sequence signal approximately similar to the first coded moving picture sequence signal in combination with the second coded moving picture sequence signal already received or stored.

It is a further object of the present invention to provide a system for transcoding a first coded moving picture sequence signal to separate into and generate a second coded moving picture sequence signal and one or more extended differential coded moving picture sequence signals, each of which contains partial differential information between the first coded moving picture sequence signal and the second coded moving picture sequence signal, and merging the second coded moving picture sequence signal and the extended differential coded moving picture sequence signal to reconstruct a pseudo first coded moving picture sequence signal, which is approximately similar to the first coded moving picture sequence signal, thereby making it possible for a user to receive the second coded moving picture sequence signal at a bit rate lower than that of first coded moving picture sequence signal to reproduce a low-quality picture information, and later receive the extended differential coded moving picture sequence signal to reconstruct a pseudo first coded moving picture sequence signal approximately similar to the first coded moving picture sequence signal. Furthermore the system thus constructed makes it possible for a user to decode or transcode the moving picture sequence signal without any additional dedicated encoders or decoders unlike the aforesaid scalability and data partitioning methods.

It is a still further object of the present invention to provide a method of transcoding a first coded moving picture sequence signal to separate into and generate a second coded moving picture sequence signal and one or more extended differential coded moving picture sequence signals, each of which contains partial differential information between the first coded moving picture sequence signal and the second coded moving picture sequence signal, and merging the second coded moving picture sequence signal and the extended differential coded moving picture sequence signal to reconstruct a pseudo first coded moving picture sequence signal, which is approximately similar to the first coded moving picture sequence signal, thereby making it possible for a user to receive the second coded moving picture sequence signal at a bit rate lower than that of first coded moving picture sequence signal to reproduce a low-quality picture information, and later receive the extended differential coded moving picture sequence signal to reconstruct a pseudo first coded moving picture sequence signal approximately similar to the first coded moving picture sequence signal. Furthermore the method thus constructed makes it possible for a user to decode or transcode the moving picture sequence signal without any additional dedicated encoders or decoders unlike the aforesaid scalability and data partitioning methods.

It is a yet further object of the present invention to provide a method of generating and extracting an extended differential coded moving picture sequence signal, thereby making it possible for a user to receive the extended differential coded moving picture sequence signal at a bit rate lower than that of first coded moving picture sequence signal to reconstruct a pseudo first coded moving picture sequence signal approximately similar to the first coded moving picture sequence signal in combination with the second coded moving picture sequence signal already received or stored.

It is a yet further object of the present invention to provide a computer program for transcoding a first coded moving picture sequence signal to separate into and generate a second coded moving picture sequence signal and one or more extended differential coded moving picture sequence signals, each of which contains partial differential information between the first coded moving picture sequence signal and the second coded moving picture sequence signal, and merging the second coded moving picture sequence signal and the extended differential coded moving picture sequence signal to reconstruct a pseudo first coded moving picture sequence signal, which is approximately similar to the first coded moving picture sequence signal, thereby making it possible for a user to receive the second coded moving picture sequence signal at a bit rate lower than that of first coded moving picture sequence signal to reproduce a low-quality picture information, and later receive the extended differential coded moving picture sequence signal to reconstruct a pseudo first coded moving picture sequence signal approximately similar to the first coded moving picture sequence signal. Furthermore the computer program thus constructed makes it possible for a user to decode or transcode the moving picture sequence signal without any additional dedicated encoders or decoders unlike the aforesaid scalability and data partitioning methods.

It is a yet further object of the present invention to provide a computer program for generating and extracting an extended differential coded moving picture sequence signal, thereby making it possible for a user to receive the extended differential coded moving picture sequence signal at a bit rate lower than that of first coded moving picture sequence signal to reconstruct a pseudo first coded moving picture sequence signal approximately similar to the first coded moving picture sequence signal in combination with the second coded moving picture sequence signal already received or stored.

In accordance with a first aspect of the present invention, there is provided a coded signal separating apparatus (1000) for transcoding a first coded moving picture sequence signal (A) to generate a second coded moving picture sequence signal (B) and an extended differential coded moving picture sequence signal (E*) on the basis of the first coded moving picture sequence signal (A) and a partial differential information segment constituting differential information (E) between the first coded moving picture sequence signal (A) and the second coded moving picture sequence signal (B), comprising: inputting means (a1) for inputting the first coded moving picture sequence signal (A) therethrough, the first coded moving picture sequence signal (A) generated as a result of encoding an original moving picture sequence signal and having a series of first picture information including first coefficient information (QF1); coded signal converting means (1100) for converting the first coded moving picture sequence signal (A) inputted through the inputting means (a1) to generate the second coded moving picture sequence signal (B), the second coded moving picture sequence signal (B) to be decoded into a second moving picture sequence signal approximately similar to the original moving picture sequence signal and having a series of second picture information including second coefficient information (QF2); and differential coded signal generating means (1200) for inputting the first coded moving picture sequence signal (A) and the second coded moving picture sequence signal (B) from the coded signal converting means (1100) to generate the extended differential coded moving picture sequence signal (E*). The differential coded signal generating means (1200) is operative to generate the extended differential coded moving picture sequence signal (E*) on the basis of the partial differential information segment constituting the differential information (E) including a difference between the first coefficient information (QF1) of the first picture information of the first coded moving picture sequence signal (A) and the second coefficient information (QF2) of the second picture information of the second coded moving picture sequence signal (B).

The differential information (E) may be in the form of a hierarchical structure including one or more sequence layers each having a plurality of screens sharing common information, one or more picture layers each having a plurality of slices sharing common information with respect to one of the screens, one or more slice layers each having a plurality of macroblocks with respect to one of the slices, one or more macroblock layers each having a plurality of blocks with respect to one of the macroblocks, and one or more block layers each having block information with respect to one of the block. The differential coded signal generating means (1200) may be operative to generate the extended differential coded moving picture sequence signal (E*) in accordance with the hierarchical structure. The differential coded signal generating means (1200) may be operative to generate a plurality of extended differential coded moving picture sequence signals (E1 to En) respectively on the basis of a plurality of partial differential information segments constituting the differential information (E). The plurality of partial differential information segments may be different from one another in size. The differential information (E) may be collectively constituted by the plurality of partial differential information segments.

In the aforementioned coded signal separating apparatus (1000), the second coefficient information (QF2) may include second zero coefficient information (QF2=0) consisting of zero coefficients and second non-zero coefficient information (QF2≠0) consisting of non-zero coefficients, and the first coefficient information (QF1) may include zero conversion first coefficient information (QF1(QF2=0)) consisting of zero conversion first coefficients to be converted by the coded signal converting means (1100) to the zero coefficients and non-zero conversion first coefficient information (QF1 (QF2≠0)) consisting of non-zero conversion first coefficients to be converted by the coded signal converting means (1100) to the non-zero coefficients. The differential coded signal generating means (1200) may include: a coefficient information separating section (1220) for inputting the first coefficient information (QF1) and the second coefficient information (QF2) from the coded signal converting means (1100) to separate into the zero conversion first coefficient information (QF1 (QF2=0)), the non-zero conversion first coefficient information (QF1 (QF2≠0)), and the second non-zero coefficient information (QF2≠0), respectively; a zero coefficient encoding section (1240) for inputting the zero conversion first coefficient information (QF1 (QF2=0)) from the coefficient information separating section (1220) to extract differential information between the zero conversion first coefficient information (QF1 (QF2=0)) and the second zero coefficient information (QF2=0) to generate differential zero coefficient information (run, level); and a non-zero coefficient encoding section (1230) for inputting the non-zero conversion first coefficient information (QF1 (QF2*0)) and the second non-zero coefficient information (QF2*0) from the coefficient information separating section (1220) to extract differential information between the non-zero conversion first coefficient information (QF1(QF2*0)) and the second non-zero coefficient information (QF2≠0) to generate differential non-zero coefficient information (ΔQF). The non-zero coefficient encoding section (1230) may be operative to generate the differential non-zero coefficient information (ΔQF) on the basis of the values of the first coefficients of the non-zero conversion first coefficient information (QF1 (QF2≠0)) and the values of the second coefficients of the second non-zero coefficient information (QF2≠0).

In the aforementioned coded signal separating apparatus (1000), each of the first coded moving picture sequence signal (A) and the second coded moving picture sequence signal (B) may be in the form of a hierarchical structure including one or more sequence layers each having a plurality of screens sharing common information, one or more picture layers each having a plurality of slices sharing common information with respect to one of the screens, one or more slice layers each having a plurality of macroblocks with respect to one of the slices, one or more macroblock layers each having a plurality of blocks with respect to one of the macroblocks, and one or more block layers each having block information with respect to one of the blocks, the original moving picture sequence signal having coefficient information to be formed in a plurality of macroblocks. The coded signal converting means (1100) may be operative to obtain a first macroblock quantization parameter (MQ1) used for the quantization of each of the macroblocks contained in the original moving picture sequence signal to generate the macroblocks contained in the first coded moving picture sequence signal (A) from the first coded moving picture sequence signal (A), and a second macroblock quantization parameter (MQ2) to be used for the inverse-quantization of each of the macroblocks contained in the second coded moving picture sequence signal (B) from the second coded moving picture sequence signal (B), and the non-zero coefficient encoding section (1230) may be operative to input the first macroblock quantization parameter (MQ1) and the second macroblock quantization parameter (MQ2) from the coded signal converting means (1100), and compute a prediction error (ΔQF) between the non-zero conversion first coefficient information (QF1 (QF2≠0)) and an estimated non-zero conversion first coefficient information (QF1 (QF2≠0)) on the basis of a ratio of the second macroblock quantization parameter (MQ2) to the first macroblock quantization parameter (MQ1), and the second non-zero coefficient information (QF2≠0). Each of the zero conversion first coefficients may have a value. The zero coefficient encoding section (1240) may be operative to extract the differential information between the zero conversion first coefficient information (QF1 (QF2=0)) and the second zero coefficient information (QF2=0) for each of the values of the zero conversion first coefficients to generate a plurality of differential zero coefficient information groups (S(1), S(2), S(3)) each for one of the values (level) of the zero conversion first coefficients. The differential coded signal generating means (1200) may be operative to generate a plurality of extended differential coded moving picture sequence signals (E1 to En) respectively on the basis of a plurality of partial differential information segments constituting the differential information (E), the partial differential information segments respectively having the plurality of differential zero coefficient information groups (S(1), S(2), S(3)). The zero coefficient encoding section (1240) may be operative to generate the plurality of differential zero coefficient information groups (S(1), S(2), S(3)) in order of the values (level) of the zero conversion first coefficients, and delimit adjacent two differential zero coefficient information groups (S(1), S(2), S(3)) with a coefficient end code (EOR), each of differential zero coefficient information groups (S(1), S(2), S(3)) includes position indicators (run) indicating positions of the values (level). The zero coefficient encoding section (1240) may be operative to judge whether or not each of the values of the zero conversion first coefficients is less than a predetermined threshold value, to extract the differential information between the zero conversion first coefficient information (QF1 (QF2=0)) and the second zero coefficient information (QF2=0) for each of the values of the zero conversion first coefficients judged as being less than the threshold value, and to generate the plurality of differential zero coefficient information groups (S(1), S(2), S(3)) in order of the values (level) of the zero conversion first coefficients judged as being less than the threshold value. Each of differential zero coefficient information groups (S(1), S(2), S(3)) may include position indicators (run) indicating positions of the values (level).

In accordance with a second aspect of the present invention, there is provided a differential coded signal generating apparatus (1200) for inputting a first coded moving picture sequence signal (A) and a second coded moving picture sequence signal (B) to generate an extended differential coded moving picture sequence signal (E*) on the basis of partial differential information segments constituting differential information (E) between the first coded moving picture sequence signal (A) and the second coded moving picture sequence signal (B), comprising: first inputting means (b1) for inputting the first coded moving picture sequence signal (A) therethrough, the first coded moving picture sequence signal (A) generated as a result of encoding an original moving picture sequence signal and having first coefficient information (QF1); second inputting means (b2) for inputting the second coded moving picture sequence signal (B) therethrough, the second coded moving picture sequence signal (B) generated as a result of transcoding the first moving picture sequence signal and having second coefficient information (QF2); and differential coded signal generating means (1200) for generating the extended differential coded moving picture sequence signal (E*) on the basis of the first coded moving picture sequence signal (A) inputted by the first inputting means (b1) and the second coded moving picture sequence signal (B) inputted by the second inputting means (b2) wherein the differential coded signal generating means (1200) is operative to generate the extended differential coded moving picture sequence signal (E*) on the basis of the partial differential information segment constituting the differential information (E) including a difference between the first coefficient information (QF1) of the first picture information of the first coded moving picture sequence signal (A) and the second coefficient information (QF2) of the second picture information of the second coded moving picture sequence signal (B).

In accordance with a third aspect of the present invention, there is provided a differential coded signal extracting apparatus (700) comprising: differential coded moving picture sequence signal storage means (1900) for storing a plurality of extended differential coded moving picture sequence signals (E1 to En) generated on the basis of partial differential information segments constituting differential information (E) between a first coded moving picture sequence signal (A) and a second coded moving picture sequence signal (B), the first coded moving picture sequence signal (A) generated as a result of encoding an original moving picture sequence signal and having a series of first picture information including first coefficient information (QF1), the second coded moving picture sequence signal (B) to be decoded into a second moving picture sequence signal approximately similar to the original moving picture sequence signal and having a series of second picture information including second coefficient information (QF2); differential coded moving picture sequence signal selecting means (750) for selecting a desired extended differential coded moving picture sequence signal (Ei) from among a plurality of extended differential coded moving picture sequence signals; and differential coded moving picture sequence signal extracting means (770) for extracting the desired extended differential coded moving picture sequence signal (Ei) selected by the differential coded moving picture sequence signal selecting means (750) from among the plurality of extended differential coded moving picture sequence signals (E1 to En) stored in the differential coded moving picture sequence signal storage means (1900), each of the extended differential coded moving picture sequence signals (E1 to En) generated on the basis of each of the partial differential information segments constituting the differential information (E) including a difference between the first coefficient information (QF1) of the first picture information of the first coded moving picture sequence signal (A) and the second coefficient information (QF2) of the second picture information of the second coded moving picture sequence signal (B).

In the aforementioned differential coded signal extracting apparatus (700), each of the extended differential coded moving picture sequence signals (E1 to En) may have a bit rate. The differential coded signal extracting apparatus (700) may further comprise bit rate specifying means (720) for specifying a desired bit rate of the extended differential coded moving picture sequence signal (E*). The differential coded moving picture sequence signal selecting means (750) may be operative to select a desired extended differential coded moving picture sequence signal (Ei) having the desired bit rate from among the plurality of extended differential coded moving picture sequence signals (E1 to En) on the basis of the desired bit rate of the extended differential coded moving picture sequence signal (E*) specified by the bit rate specifying means (720). The desired extended differential coded moving picture sequence signal (Ei) may be to be transmitted through a transmission path at a predetermined transmission bit rate for a predetermined transmission time period. The bit rate specifying means (720) may be operative to specify the bit rate of the extended differential coded moving picture sequence signal (E*) on the basis of the transmission bit rate and the transmission time period. The aforementioned differential coded signal extracting apparatus (700) may comprise excluding means (730) for excluding one or more extended differential coded moving picture sequence signals (E*) from among the plurality of extended differential coded moving picture sequence signals (E1 to En). The differential coded moving picture sequence signal selecting means (750) may be operative to select a desired extended differential coded moving picture sequence signal (Ei) from among the plurality of extended differential coded moving picture sequence signals (E1 to En) except for the one or more extended differential coded moving picture sequence signals (E*) excluded by the excluding means (730).

In the aforementioned differential coded signal extracting apparatus (700), the second coefficient information (QF2) may include second zero coefficient information (QF2=0) consisting of zero coefficients and second non-zero coefficient information (QF2≠0) consisting of non-zero coefficients, and the first coefficient information (QF1) may include zero conversion first coefficient information (QF1 (QF2=0)) consisting of zero conversion first coefficients to be converted by the coded signal converting means (1100) to the zero coefficients and non-zero conversion first coefficient information (QF1 (QF2*0)) consisting of non-zero conversion first coefficients to be converted by coded signal converting means (1100) to the non-zero coefficients. Each of the partial differential information segments of the extended differential coded moving picture sequence signals (E1 to En) may include partial differential zero coefficient information (run, level) and partial non-zero coefficient differential information (ΔQF). The partial differential zero coefficient information (run, level) may be indicative of partial differential information between the zero conversion first coefficient information (QF1 (QF2=0)) and the second zero coefficient information (QF2=0) and partial non-zero coefficient differential information (ΔQF) may be indicative of partial differential information between the non-zero conversion first coefficient information (QF1 (QF2≠0)) and the second non-zero coefficient information (QF2≠0). Each of the zero conversion first coefficients may have a value. The plurality of extended differential coded moving picture sequence signals (E1 to En) may have respective partial differential information segments and respective bit rates different from one another. The partial differential information segments may respectively have the plurality of differential zero coefficient information groups (S(1), S(2), S(3)) each generated for one of the values (level) of the zero conversion first coefficients.

In accordance with a fourth aspect of the present invention, there is provided a coded signal merging apparatus (2000) for inputting a second coded moving picture sequence signal (B) and an extended differential coded moving picture sequence signal (E*) to reconstruct a pseudo first coded moving picture sequence signal (B*), the extended differential coded moving picture sequence signal (E*) generated on the basis of a partial differential information segment constituting differential information (E) between a first coded moving picture sequence signal (A) and the second coded moving picture sequence signal (B), comprising: second coded signal inputting means (c1) for inputting the second coded moving picture sequence signal (B) therethrough, the second coded moving picture sequence signal (B) generated as a result of transcoding the first coded moving picture sequence signal (A) and having a series of second picture information including second coefficient information (QF2), the first coded moving picture sequence signal (A) generated as a result of encoding original moving picture sequence signal and having a series of first picture information including first coefficient information (QF1); differential coded signal inputting means (c2) for inputting the extended differential coded moving picture sequence signal (E*) therethrough, the extended differential coded moving picture sequence signal (E*) having the partial differential information segment constituting the differential information (E) including a difference between the first coefficient information (QF1) of the first picture information of the first coded moving picture sequence signal (A) and the second coefficient information (QF2) of the second picture information of the second coded moving picture sequence signal (B); and coded signal merging means (2110, 2120, 2130, 2140, 2150, 2160, 2170, 2190) for inputting the second coded moving picture sequence signal (B) from the second coded signal inputting means (c1) and the extended differential coded moving picture sequence signal (E*) from the differential coded signal inputting means (c2) to reconstruct the pseudo first coded moving picture sequence signal (B*), the pseudo first coded moving picture sequence signal (B*) being to be decoded into a pseudo original moving picture sequence signal approximately similar to the original moving picture sequence signal wherein the coded signal merging means (2110, 2120, 2130, 2140, 2150, 2160, 2170, 2190) is operative to reconstruct the pseudo first coded moving picture sequence signal (B*) by reconstructing a part of the first coefficient information (QF1) of the first picture information of the first coded moving picture sequence signal (A) on the basis of the second coefficient information (QF2) of the second picture information of the second coded moving picture sequence signal (B) inputted by the second coded signal inputting means (c1), and the difference between the first coefficient information (QF1) of the first picture information of the first coded moving picture sequence signal (A) and the second coefficient information (QF2) of the second picture information of the second coded moving picture sequence signal (B) included in the partial differential information segment of the extended differential coded moving picture sequence signal (E*) inputted by the differential coded signal inputting means (c2).

The aforementioned coded signal merging apparatus (2000) may further comprise storage means (2900) for storing the pseudo first coded moving picture sequence signal (B*) therein, the pseudo first coded moving picture sequence signal (B*) having the second coefficient information (QF2) of the second picture information of the second coded moving picture sequence signal (B) and the part of the first coefficient information (QF1) of the first picture information of the first coded moving picture sequence signal (A). In the aforementioned coded signal merging apparatus (2000), the differential coded signal inputting means (c2) may be operative to further input a subsequent extended differential coded moving picture sequence signal (E2) therethrough. The subsequent extended differential coded moving picture sequence signal (E2) may have a subsequent partial differential information segment constituting the differential information (E) including a subsequent difference between the first coefficient information (QF1) of the first picture information of the first coded moving picture sequence signal (A) and the second coefficient information (QF2) of the second picture information of the second coded moving picture sequence signal (B). The partial differential information segment and the subsequent partial differential information segment may complement each other to constitute the differential information (E). The coded signal merging means (2110, 2120, 2130, 2140, 2150, 2160, 2170, 2190) may be operative to reconstruct a subsequent pseudo first coded moving picture sequence signal (B1) by reconstructing a part of the first coefficient information (QF1) of the first picture information of the first coded moving picture sequence signal (A) on the basis of the second coefficient information (QF2) of the second picture information and the part of the first coefficient information (QF1) of the first picture information of the pseudo first coded moving picture sequence signal (B*) stored in the storage means (2900), and the subsequent difference between the first coefficient information (QF1) of the first picture information of the first coded moving picture sequence signal (A) and the second coefficient information (QF2) of the second picture information of the second coded moving picture sequence signal (B) included in the subsequent partial differential information segment of the subsequent extended differential coded moving picture sequence signal (E*) inputted by the differential coded signal inputting means (c2). The subsequent pseudo first coded moving picture sequence signal (B1) may be to be decoded into a subsequent pseudo original moving picture sequence signal more similar to the original moving picture sequence signal than the second moving picture sequence signal.

In the aforementioned coded signal merging apparatus (2000), the differential coded signal inputting means (c2) may be operative to input a plurality of extended differential coded moving picture sequence signals (E1 to Ej) therethrough. The plurality of extended differential coded moving picture sequence signals (E1 to Ej) may respectively have a plurality of partial differential information segments complementing one another to partly constitute the differential information (E). The plurality of extended differential coded moving picture sequence signals (E1 to Ej) may respectively include a plurality of differences between the first coefficient information (QF1) of the first picture information of the first coded moving picture sequence signal (A) and the second coefficient information (QF2) of the second picture information of the second coded moving picture sequence signal (B). The coded signal merging means (2110, 2120, 2130, 2140, 2150, 2160, 2170, 2190) may be operative to reconstruct a pseudo first coded moving picture sequence signal (Bi) by reconstructing a part of the first coefficient information (QF1) of the first picture information of the first coded moving picture sequence signal (A) on the basis of the second coefficient information (QF2) of the second picture information of the second coded moving picture sequence signal (B) inputted by the second coded signal inputting means (c1), and the plurality of differences between the first coefficient information (QF1) of the first picture information of the first coded moving picture sequence signal (A) and the second coefficient information (QF2) of the second picture information of the second coded moving picture sequence signal (B) included in the plurality of partial differential information segments of the extended differential coded moving picture sequence signals (E1 to Ej) inputted by the differential coded signal inputting means (c2).

The aforementioned coded signal merging apparatus (2000) may further comprise storage means (2900) for storing the pseudo first coded moving picture sequence signal (Bi) therein, the pseudo first coded moving picture sequence signal (Bi) having the second coefficient information (QF2) of the second picture information of the second coded moving picture sequence signal (B) and the part of the first coefficient information (QF1) of the first picture information of the first coded moving picture sequence signal (A). In the aforementioned coded signal merging apparatus (2000), the differential coded signal inputting means (c2) may be operative to input one or more extended differential coded moving picture sequence signals (Ej+1 to En) therethrough. The one or more extended differential coded moving picture sequence signals (Ej+1 to En) may respectively have one or more partial differential information segments complementing one another to partly constitute the differential information (E). The one or more extended differential coded moving picture sequence signals (Ej+1 to En) may respectively include one or more differences between the first coefficient information (QF1) of the first picture information of the first coded moving picture sequence signal (A) and the second coefficient information (QF2) of the second picture information of the second coded moving picture sequence signal (B). The coded signal merging means (2110, 2120, 2130, 2140, 2150, 2160, 2170, 2190) may be operative to reconstruct a pseudo first coded moving picture sequence signal (Bn) by reconstructing a part of the first coefficient information (QF1) of the first picture information of the first coded moving picture sequence signal (A) on the basis of the second coefficient information (QF2) of the second picture information and the part of the first coefficient information (QF1) of the first picture information of the pseudo first coded moving picture sequence signal (Bi) stored in the storage means (2900), and the one or more differences between the first coefficient information (QF1) of the first picture information of the first coded moving picture sequence signal (A) and the second coefficient information (QF2) of the second picture information of the second coded moving picture sequence signal (B) included in the one or more partial differential information segments of the one or more extended differential coded moving picture sequence signals (Ej+1 to En) inputted by the differential coded signal inputting means (c2).

In the aforementioned coded signal merging apparatus (2000), the second coefficient information (QF2) of the second picture information and the part of the first coefficient information (QF1) of the first picture information of the pseudo first coded moving picture sequence signal (Bi) stored in the storage means (2900) may be base partial differential information segments. The one or more partial differential information segments of the one or more extended differential coded moving picture sequence signals (Ej+1 to En) inputted by the differential coded signal inputting means (c2) and the plurality of partial differential information segments of the plurality of extended differential coded moving picture sequence signals (E1 to Ej) and the base partial differential information segments may complement one another to collectively constitute the differential information (E). The coded signal merging means (2110, 2120, 2130, 2140, 2150, 2160, 2170, 2190) may be operative to reconstruct the first coded moving picture sequence signal (A) by reconstructing substantially all of the first coefficient information (QF1) of the first picture information of the first coded moving picture sequence signal (A) on the basis of the second coefficient information (QF2) of the second picture information and the part of the first coefficient information (QF1) of the first picture information of the pseudo first coded moving picture sequence signal (Bi) stored in the storage means (2900), and the one or more differences between the first coefficient information (QF1) of the first picture information of the first coded moving picture sequence signal (A) and the second coefficient information (QF2) of the second picture information of the second coded moving picture sequence signal (B) included in the one or more partial differential information segments of the one or more extended differential coded moving picture sequence signals (Ej+1 to En) inputted by the differential coded signal inputting means (c2).

In the aforementioned coded signal merging apparatus (2000), the second coefficient information (QF2) may include second zero coefficient information (QF2=0) consisting of zero coefficients and second non-zero coefficient information (QF2≠0) consisting of non-zero coefficients, and he first coefficient information (QF1) may include zero conversion first coefficient information (QF1 (QF2=0)) consisting of zero conversion first coefficients to be converted by the coded signal converting means (1100) to the zero coefficients and non-zero conversion first coefficient information (QF1 (QF2≠0)) consisting of non-zero conversion first coefficients to be converted by the coded signal converting means (1100) to the non-zero coefficients. The partial differential information segment of the extended differential coded moving picture sequence signal (E*) may include partial differential zero coefficient information (run, level) and partial non-zero coefficient differential information (ΔQF). The partial differential zero coefficient information (run, level) may be indicative of partial differential information between the zero conversion first coefficient information (QF1 (QF2=0)) and the second zero coefficient information (QF2=0) and partial non-zero coefficient differential information (ΔQF) being indicative of partial differential information between the non-zero conversion first coefficient information (QF1 (QF2≠0)) and the second non-zero coefficient information (QF2≠0). The coded signal merging means (2110, 2120, 2130, 2140, 2150, 2160, 2170, 2190) may be provided with: a zero conversion first coefficient information generating section (2150, 2160) operative to reconstruct the zero conversion first coefficient information (QF1 (QF2=0)) on the basis of the second zero coefficient information (QF2=0) of the second coded moving picture sequence signal (B) and the partial differential zero coefficient information (run, level) of the differential coded moving picture sequence signal; a non-zero conversion first coefficient information generating section (2140) operative to reconstruct the non-zero conversion first coefficient information (QF1 (QF2≠0)) on the basis of the second non-zero coefficient information (QF2≠0) of the second coded moving picture sequence signal (B) and the partial non-zero coefficient differential information (ΔQF) of the extended differential coded moving picture sequence signal; and a first coefficient information merging section (2160, 2170) operative to merge the zero conversion first coefficient information (QF1 (QF2≠0)) reconstructed by the zero conversion first coefficient information generating section (2150, 2160) and non-zero conversion first coefficient information (QF1 (QF2≠0)) reconstructed by the non-zero conversion first coefficient information generating section (2140) to reconstruct a part of the first coefficient information (QF1).

In accordance with a fifth aspect of the present invention, there is provided a coded signal separating and merging system, comprising: coded signal separating apparatus (1000) for transcoding a first coded moving picture sequence signal (A) to generate a second coded moving picture sequence signal (B) and one or more extended differential coded moving picture sequence signals (E1 to En) on the basis of the first coded moving picture sequence signal (A) and one or more partial differential information segments constituting differential information (E) between the first coded moving picture sequence signal (A) and the second coded moving picture sequence signal (B); and coded signal merging apparatus (2000) for inputting the second coded moving picture sequence signal (B) and one of the extended differential coded moving picture sequence signals (Ei) to reconstruct a pseudo first coded moving picture sequence signal (Bi). The coded signal separating apparatus (1000) comprises: inputting means (a1) for inputting the first coded moving picture sequence signal (A) therethrough, the first coded moving picture sequence signal (A) generated as a result of encoding an original moving picture sequence signal and having a series of first picture information including first coefficient information (QF1); coded signal converting means (1100) for converting the first coded moving picture sequence signal (A) inputted through the inputting means (a1) to generate the second coded moving picture sequence signal (B), the second coded moving picture sequence signal (B) to be decoded into a second moving picture sequence signal approximately similar to the original moving picture sequence signal and having a series of second picture information including second coefficient information (QF2); and differential coded signal generating means (1200) for inputting the first coded moving picture sequence signal (A) and the second coded moving picture sequence signal (B) from the coded signal converting means (1100) to generate the one or more extended differential coded moving picture sequence signals (E1 to En) wherein the differential coded signal generating means (1200) is operative to generate the one or more extended differential coded moving picture sequence signals (E1 to En) on the basis of the one or more partial differential information segments constituting the differential information (E) including respective one or more differences between the first coefficient information (QF1) of the first picture information of the first coded moving picture sequence signal (A) and the second coefficient information (QF2) of the second picture information of the second coded moving picture sequence signal (B). The coded signal merging apparatus (2000) comprises: second coded signal inputting means (c1) for inputting the second coded moving picture sequence signal (B) therethrough, the second coded moving picture sequence signal (B); differential coded signal inputting means (c2) for inputting one of the extended differential coded moving picture sequence signals (Ei) therethrough; and coded signal merging means (2110, 2120, 2130, 2140, 2150, 2160, 2170, 2190) for inputting the second coded moving picture sequence signal (B) from the second coded signal inputting means (c1) and the extended differential coded moving picture sequence signal (Ei) from the differential coded signal inputting means (c2) to reconstruct the pseudo first coded moving picture sequence signal (Bi), the pseudo first coded moving picture sequence signal (Bi) being to be decoded into a pseudo original moving picture sequence signal approximately similar to the original moving picture sequence signal wherein the coded signal merging means (2110, 2120, 2130, 2140, 2150, 2160, 2170, 2190) is operative to reconstruct the pseudo first coded moving picture sequence signal (Bi) by reconstructing a part of the first coefficient information (QF1) of the first picture information of the first coded moving picture sequence signal (A) on the basis of the second coefficient information (QF2) of the second picture information of the second coded moving picture sequence signal (B) inputted by the second coded signal inputting means (c1), and the difference between the first coefficient information (QF1) of the first picture information of the first coded moving picture sequence signal (A) and the second coefficient information (QF2) of the second picture information of the second coded moving picture sequence signal (B) included in the partial differential information segment of the extended differential coded moving picture sequence signal (Ei) inputted by the differential coded signal inputting means (c2).

In accordance with a sixth aspect of the present invention, there is provided a coded signal separating method of transcoding a first coded moving picture sequence signal (A) to generate a second coded moving picture sequence signal (B) and an extended differential coded moving picture sequence signal (E*) on the basis of the first coded moving picture sequence signal (A) and a partial differential information segment constituting differential information (E) between the first coded moving picture sequence signal (A) and the second coded moving picture sequence signal (B), comprising the steps of: (a) inputting the first coded moving picture sequence signal (A) therethrough, the first coded moving picture sequence signal (A) generated as a result of encoding an original moving picture sequence signal and having a series of first picture information including first coefficient information (QF1); (b) converting the first coded moving picture sequence signal (A) inputted through the step (a) to generate the second coded moving picture sequence signal (B), the second coded moving picture sequence signal (B) to be decoded into a second moving picture sequence signal approximately similar to the original moving picture sequence signal and having a series of second picture information including second coefficient information (QF2); and (c) inputting the first coded moving picture sequence signal (A) and the second coded moving picture sequence signal (B) from the step (b) to generate the extended differential coded moving picture sequence signal (E*) wherein the step (c) has the step of generating the extended differential coded moving picture sequence signal (E*) on the basis of the partial differential information segment constituting the differential information (E) including a difference between the first coefficient information (QF1) of the first picture information of the first coded moving picture sequence signal (A) and the second coefficient information (QF2) of the second picture information of the second coded moving picture sequence signal (B).

In the aforementioned coded signal separating method, the differential information (E) may be in the form of a hierarchical structure including one or more sequence layers each having a plurality of screens sharing common information, one or more picture layers each having a plurality of slices sharing common information with respect to one of the screens, one or more slice layers each having a plurality of macroblocks with respect to one of the slices, one or more macroblock layers each having a plurality of blocks with respect to one of the macroblocks, and one or more block layers each having block information with respect to one of the block, and he step (c) may have the step of generating the extended differential coded moving picture sequence signal (E*) in accordance with the hierarchical structure. The step (c) may have the step of generating a plurality of extended differential coded moving picture sequence signals (E1 to En) respectively on the basis of a plurality of partial differential information segments constituting the differential information (E). The plurality of partial differential information segments may be different from one another in size. The differential information (E) may be collectively constituted by the plurality of partial differential information segments.

In the aforementioned coded signal separating method, second coefficient information (QF2) may include second zero coefficient information (QF2=0) consisting of zero coefficients and second non-zero coefficient information (QF2≠0) consisting of non-zero coefficients, and the first coefficient information (QF1) may include zero conversion first coefficient information (QF1 (QF2=0)) consisting of zero conversion first coefficients to be converted in the step (b) to the zero coefficients and non-zero conversion first coefficient information (QF1 (QF2≠0)) consisting of non-zero conversion first coefficients to be converted in the step (b) to the non-zero coefficients. The step (c) may include the steps of: (c1) inputting the first coefficient information (QF1) and the second coefficient information (QF2) from the step (b) to separate into the zero conversion first coefficient information (QF1 (QF2=0)), the non-zero conversion first coefficient information (QF1 (QF2≠0)), and the second non-zero coefficient information (QF2≠0), respectively; (c2) inputting the zero conversion first coefficient information (QF1 (QF2=0)) from the step (c1) to extract differential information between the zero conversion first coefficient information (QF1 (QF2=0)) and the second zero coefficient information (QF2=0) to generate differential zero coefficient information (run, level); and (c3) inputting the non-zero conversion first coefficient information (QF1 (QF2≠0)) and the second non-zero coefficient information (QF2=0) from the step (c1) to extract differential information between the non-zero conversion first coefficient information (QF1 (QF2*0)) and the second non-zero coefficient information (QF2≠0) to generate differential non-zero coefficient information (ΔQF). The step (c3) may have the step of generating the differential non-zero coefficient information (ΔQF) on the basis of the values of the first coefficients of the non-zero conversion first coefficient information (QF1 (QF2≠0)) and the values of the second coefficients of the second non-zero coefficient information (QF2≠0).

In the aforementioned coded signal separating method, each of the first coded moving picture sequence signal (A) and the second coded moving picture sequence signal (B) may be in the form of a hierarchical structure including one or more sequence layers each having a plurality of screens sharing common information, one or more picture layers each having a plurality of slices sharing common information with respect to one of the screens, one or more slice layers each having a plurality of macroblocks with respect to one of the slices, one or more macroblock layers each having a plurality of blocks with respect to one of the macroblocks, and one or more block layers each having block information with respect to one of the blocks, the original moving picture sequence signal having coefficient information to be formed in a plurality of macroblocks. The step (b) may have the step of obtaining a first macroblock quantization parameter (MQ1) used for the quantization of each of the macroblocks contained in the original moving picture sequence signal to generate the macroblocks contained in the first coded moving picture sequence signal (A) from the first coded moving picture sequence signal (A), and a second macroblock quantization parameter (MQ2) to be used for the inverse-quantization of each of the macroblocks contained in the second coded moving picture sequence signal (B) from the second coded moving picture sequence signal (B), and the step (c3) may have the step of inputting the first macroblock quantization parameter (MQ1) and the second macroblock quantization parameter (MQ2) from the step (b), and compute a prediction error (ΔQF) between the non-zero conversion first coefficient information (QF1 (QF2≠0)) and an estimated non-zero conversion first coefficient information (QF1 (QF2≠0)) on the basis of a ratio of the second macroblock quantization parameter (MQ2) to the first macroblock quantization parameter (MQ1), and the second non-zero coefficient information (QF2≠0).

In the aforementioned coded signal separating method, each of the zero conversion first coefficients may have a value, the step (c2) may have the step of extracting the differential information between the zero conversion first coefficient information (QF1 (QF2=0)) and the second zero coefficient information (QF2=0) for each of the values of the zero conversion first coefficients to generate a plurality of differential zero coefficient information groups (S(1), S(2), S(3)) each for one of the values (level) of the zero conversion first coefficients, the step (c) may have the step of generating a plurality of extended differential coded moving picture sequence signals (E1 to En) respectively on the basis of a plurality of partial differential information segments constituting the differential information (E), wherein the partial differential information segments respectively may have the plurality of differential zero coefficient information groups (S(1), S(2), S(3)). In the aforementioned coded signal separating method, the step (c2) may have the step of generating the plurality of differential zero coefficient information groups (S(1), S(2), S(3)) in order of the values (level) of the zero conversion first coefficients, and delimit adjacent two differential zero coefficient information groups (S(1), S(2), S(3)) with a coefficient end code (EOR), wherein each of differential zero coefficient information groups (S(1), S(2), S(3)) may include position indicators (run) indicating positions of the values (level). In the aforementioned coded signal separating method, the step (c2) may have the step of judging whether or not each of the values of the zero conversion first coefficients is less than a predetermined threshold value, to extract the differential information between the zero conversion first coefficient information (QF1 (QF2=0)) and the second zero coefficient information (QF2=0) for each of the values of the zero conversion first coefficients judged as being less than the threshold value, and to generate the plurality of differential zero coefficient information groups (S(1), S(2), S(3)) in order of the values (level) of the zero conversion first coefficients judged as being less than the threshold value, wherein each of differential zero coefficient information groups (S(1), S(2), S(3)) may include position indicators (run) indicating positions of the values (level).

In accordance with a seventh aspect of the present invention, there is provided differential coded signal generating method of inputting a first coded moving picture sequence signal (A) and a second coded moving picture sequence signal (B) to generate an extended differential coded moving picture sequence signal (E*) on the basis of partial differential information segments constituting differential information (E) between the first coded moving picture sequence signal (A) and the second coded moving picture sequence signal (B), comprising the steps of: (a-a) inputting the first coded moving picture sequence signal (A) therethrough, the first coded moving picture sequence signal (A) generated as a result of encoding an original moving picture sequence signal and having first coefficient information (QF1); (a-b) inputting the second coded moving picture sequence signal (B) therethrough, the second coded moving picture sequence signal (B) generated as a result of transcoding the first moving picture sequence signal and having second coefficient information (QF2); and (a-c) generating the extended differential coded moving picture sequence signal (E*) on the basis of the first coded moving picture sequence signal (A) inputted in the step (a-a) and the second coded moving picture sequence signal (B) inputted in the step (a-b), wherein the step (a-c) has the step of generating the extended differential coded moving picture sequence signal (E*) on the basis of the partial differential information segment constituting the differential information (E) including a difference between the first coefficient information (QF1) of the first picture information of the first coded moving picture sequence signal (A) and the second coefficient information (QF2) of the second picture information of the second coded moving picture sequence signal (B).

In accordance with an eighth aspect of the present invention, there is provided a differential coded signal extracting method comprising the steps of: (d) storing a plurality of extended differential coded moving picture sequence signals (E1 to En) generated on the basis of partial differential information segments constituting differential information (E) between a first coded moving picture sequence signal (A) and a second coded moving picture sequence signal (B), the first coded moving picture sequence signal (A) generated as a result of encoding an original moving picture sequence signal and having a series of first picture information including first coefficient information (QF1), the second coded moving picture sequence signal (B) to be decoded into a second moving picture sequence signal approximately similar to the original moving picture sequence signal and having a series of second picture information including second coefficient information (QF2); (e) selecting a desired extended differential coded moving picture sequence signal (Ei) from among a plurality of extended differential coded moving picture sequence signals; and (f) extracting the desired extended differential coded moving picture sequence signal (Ei) selected in the step (e) from among the plurality of extended differential coded moving picture sequence signals (E1 to En) stored in the step (d), each of the extended differential coded moving picture sequence signals (E1 to En) generated on the basis of each of the partial differential information segments constituting the differential information (E) including a difference between the first coefficient information (QF1) of the first picture information of the first coded moving picture sequence signal (A) and the second coefficient information (QF2) of the second picture information of the second coded moving picture sequence signal (B).

In the aforementioned differential coded signal extracting method, each of the extended differential coded moving picture sequence signals (E1 to En) may have a bit rate. The differential coded signal extracting method may further comprises the step of (g) specifying a desired bit rate of the extended differential coded moving picture sequence signal (E*), the step (e) may have the step of selecting a desired extended differential coded moving picture sequence signal (Ei) having the desired bit rate from among the plurality of extended differential coded moving picture sequence signals (E1 to En) on the basis of the desired bit rate of the extended differential coded moving picture sequence signal (E*) specified in the step (g). In the aforementioned differential coded signal extracting method, the desired extended differential coded moving picture sequence signal (Ei) may be to be transmitted through a transmission path at a predetermined transmission bit rate for a predetermined transmission time period, and the step (g) may have the step of specifying the bit rate of the extended differential coded moving picture sequence signal (E*) on the basis of the transmission bit rate and the transmission time period. The differential coded signal extracting method may further comprise the step of (h) excluding one or more extended differential coded moving picture sequence signals (E*) from among the plurality of extended differential coded moving picture sequence signals (E1 to En). In the differential coded signal extracting method, the step (e) may have the step of selecting a desired extended differential coded moving picture sequence signal (Ei) from among the plurality of extended differential coded moving picture sequence signals (E1 to En) except for the one or more extended differential coded moving picture sequence signals (E*) excluded in the step (h).

In the aforementioned differential coded signal extracting method, the second coefficient information (QF2) may include second zero coefficient information (QF2=0) consisting of zero coefficients and second non-zero coefficient information (QF2≠0) consisting of non-zero coefficients, and the first coefficient information (QF1) may include zero conversion first coefficient information (QF1 (QF2=0)) consisting of zero conversion first coefficients to be converted in the step (b) to the zero coefficients and non-zero conversion first coefficient information (QF1 (QF2≠0)) consisting of non-zero conversion first coefficients to be converted by step (b) to the non-zero coefficients. Each of the partial differential information segments of the extended differential coded moving picture sequence signals (E1 to En) may include partial differential zero coefficient information (run, level) and partial non-zero coefficient differential information (ΔQF). The partial differential zero coefficient information (run, level) may be indicative of partial differential information between the zero conversion first coefficient information (QF1 (QF2=0)) and the second zero coefficient information (QF2=0) and partial non-zero coefficient differential information (ΔQF) may be indicative of partial differential information between the non-zero conversion first coefficient information (QF1 (QF2≠0)) and the second non-zero coefficient information (QF2≠0). Each of the zero conversion first coefficients may have a value. The plurality of extended differential coded moving picture sequence signals (E1 to En) may have respective partial differential information segments and respective bit rates different from one another. The partial differential information segments may respectively have the plurality of differential zero coefficient information groups (S(1), S(2), S(3)) each generated for one of the values (level) of the zero conversion first coefficients.

In accordance with a ninth aspect of the present invention, there is provided a coded signal merging method of inputting a second coded moving picture sequence signal (B) and an extended differential coded moving picture sequence signal (E*) to reconstruct a pseudo first coded moving picture sequence signal (B*), the extended differential coded moving picture sequence signal (E*) generated on the basis of a partial differential information segment constituting differential information (E) between a first coded moving picture sequence signal (A) and the second coded moving picture sequence signal (B), comprising the steps of: (i) inputting the second coded moving picture sequence signal (B) therethrough, the second coded moving picture sequence signal (B) generated as a result of transcoding the first coded moving picture sequence signal (A) and having a series of second picture information including second coefficient information (QF2), the first coded moving picture sequence signal (A) generated as a result of encoding original moving picture sequence signal and having a series of first picture information including first coefficient information (QF1); (j) inputting the extended differential coded moving picture sequence signal (E*) therethrough, the extended differential coded moving picture sequence signal (E*) having the partial differential information segment constituting the differential information (E) including a difference between the first coefficient information (QF1) of the first picture information of the first coded moving picture sequence signal (A) and the second coefficient information (QF2) of the second picture information of the second coded moving picture sequence signal (B); and (k) inputting the second coded moving picture sequence signal (B) from the step (i) and the extended differential coded moving picture sequence signal (E*) from the step (j) to reconstruct the pseudo first coded moving picture sequence signal (B*), the pseudo first coded moving picture sequence signal (B*) being to be decoded into a pseudo original moving picture sequence signal approximately similar to the original moving picture sequence signal, wherein the step (k) have the step of reconstructing the pseudo first coded moving picture sequence signal (B*) by reconstructing a part of the first coefficient information (QF1) of the first picture information of the first coded moving picture sequence signal (A) on the basis of the second coefficient information (QF2) of the second picture information of the second coded moving picture sequence signal (B) inputted in the step (i), and the difference between the first coefficient information (QF1) of the first picture information of the first coded moving picture sequence signal (A) and the second coefficient information (QF2) of the second picture information of the second coded moving picture sequence signal (B) included in the partial differential information segment of the extended differential coded moving picture sequence signal (E*) inputted in the step (j).

The aforementioned coded signal merging method may further comprise the step of (l) storing the pseudo first coded moving picture sequence signal (B*) therein. The pseudo first coded moving picture sequence signal (B*) may have the second coefficient information (QF2) of the second picture information of the second coded moving picture sequence signal (B) and the part of the first coefficient information (QF1) of the first picture information of the first coded moving picture sequence signal (A). In the aforementioned coded signal merging method, the step (j) may have the step of further inputting a subsequent extended differential coded moving picture sequence signal (E2) therethrough, the subsequent extended differential coded moving picture sequence signal (E2) may have a subsequent partial differential information segment constituting the differential information (E) including a subsequent difference between the first coefficient information (QF1) of the first picture information of the first coded moving picture sequence signal (A) and the second coefficient information (QF2) of the second picture information of the second coded moving picture sequence signal (B), the partial differential information segment and the subsequent partial differential information segment may complement each other to constitute the differential information (E). The step (k) may have the step of reconstructing a subsequent pseudo first coded moving picture sequence signal (B1) by reconstructing a part of the first coefficient information (QF1) of the first picture information of the first coded moving picture sequence signal (A) on the basis of the second coefficient information (QF2) of the second picture information and the part of the first coefficient information (QF1) of the first picture information of the pseudo first coded moving picture sequence signal (B*) stored in the step (l), and the subsequent difference between the first coefficient information (QF1) of the first picture information of the first coded moving picture sequence signal (A) and the second coefficient information (QF2) of the second picture information of the second coded moving picture sequence signal (B) included in the subsequent partial differential information segment of the subsequent extended differential coded moving picture sequence signal (E*) inputted in the step (j), wherein the subsequent pseudo first coded moving picture sequence signal (B1) may be to be decoded into a subsequent pseudo original moving picture sequence signal more similar to the original moving picture sequence signal than the second moving picture sequence signal.

In the aforementioned coded signal merging method, the step (j) may have the step of inputting a plurality of extended differential coded moving picture sequence signals (E1 to Ej) therethrough, the plurality of extended differential coded moving picture sequence signals (E1 to Ej) respectively having a plurality of partial differential information segments complementing one another to partly constitute the differential information (E), the plurality of extended differential coded moving picture sequence signals (E1 to Ej) respectively including a plurality of differences between the first coefficient information (QF1) of the first picture information of the first coded moving picture sequence signal (A) and the second coefficient information (QF2) of the second picture information of the second coded moving picture sequence signal (B); and the step (k) may have the step of reconstructing a pseudo first coded moving picture sequence signal (Bi) by reconstructing a part of the first coefficient information (QF1) of the first picture information of the first coded moving picture sequence signal (A) on the basis of the second coefficient information (QF2) of the second picture information of the second coded moving picture sequence signal (B) inputted in the step (i), and the plurality of differences between the first coefficient information (QF1) of the first picture information of the first coded moving picture sequence signal (A) and the second coefficient information (QF2) of the second picture information of the second coded moving picture sequence signal (B) included in the plurality of partial differential information segments of the extended differential coded moving picture sequence signals (E1 to Ej) inputted in the step (j).

The aforementioned coded signal merging method may further comprise the step of (m) storing the pseudo first coded moving picture sequence signal (Bi) therein, the pseudo first coded moving picture sequence signal (Bi) having the second coefficient information (QF2) of the second picture information of the second coded moving picture sequence signal (B) and the part of the first coefficient information (QF1) of the first picture information of the first coded moving picture sequence signal (A). In the aforementioned coded signal merging method, the step (j) may have the step of inputting one or more extended differential coded moving picture sequence signals (Ej+1 to En) therethrough, the one or more extended differential coded moving picture sequence signals (Ej+1 to En) respectively having one or more partial differential information segments complementing one another to partly constitute the differential information (E), the one or more extended differential coded moving picture sequence signals (Ej+1 to En) respectively including one or more differences between the first coefficient information (QF1) of the first picture information of the first coded moving picture sequence signal (A) and the second coefficient information (QF2) of the second picture information of the second coded moving picture sequence signal (B); and the step (k) may have the step of reconstructing a pseudo first coded moving picture sequence signal (Bn) by reconstructing a part of the first coefficient information (QF1) of the first picture information of the first coded moving picture sequence signal (A) on the basis of the second coefficient information (QF2) of the second picture information and the part of the first coefficient information (QF1) of the first picture information of the pseudo first coded moving picture sequence signal (Bi) stored in the step (m), and the one or more differences between the first coefficient information (QF1) of the first picture information of the first coded moving picture sequence signal (A) and the second coefficient information (QF2) of the second picture information of the second coded moving picture sequence signal (B) included in the one or more partial differential information segments of the one or more extended differential coded moving picture sequence signals (Ej+1 to En) inputted in the step (j).

In the aforementioned coded signal merging method, the second coefficient information (QF2) of the second picture information and the part of the first coefficient information (QF1) of the first picture information of the pseudo first coded moving picture sequence signal (Bi) stored in the step (m) may be base partial differential information segments, the one or more partial differential information segments of the one or more extended differential coded moving picture sequence signals (Ej+1 to En) inputted in the step (j) and the plurality of partial differential information segments of the plurality of extended differential coded moving picture sequence signals (E1 to Ej) and the base partial differential information segments may complement one another to collectively constitute the differential information (E), and the step (k) may have the step of reconstructing the first coded moving picture sequence signal (A) by reconstructing substantially all of the first coefficient information (QF1) of the first picture information of the first coded moving picture sequence signal (A) on the basis of the second coefficient information (QF2) of the second picture information and the part of the first coefficient information (QF1) of the first picture information of the pseudo first coded moving picture sequence signal (Bi) stored in the step (m), and the one or more differences between the first coefficient information (QF1) of the first picture information of the first coded moving picture sequence signal (A) and the second coefficient information (QF2) of the second picture information of the second coded moving picture sequence signal (B) included in the one or more partial differential information segments of the one or more extended differential coded moving picture sequence signals (Ej+1 to En) inputted in the step (j).

In the aforementioned coded signal merging method, the second coefficient information (QF2) may include second zero coefficient information (QF2=0) consisting of zero coefficients and second non-zero coefficient information (QF2≠0) consisting of non-zero coefficients, and the first coefficient information (QF1) may include zero conversion first coefficient information (QF1 (QF2=0)) consisting of zero conversion first coefficients to be converted in the step (b) to the zero coefficients and non-zero conversion first coefficient information (QF1 (QF2≠0)) consisting of non-zero conversion first coefficients to be converted in the step (b) to the non-zero coefficients. The partial differential information segment of the extended differential coded moving picture sequence signal (E*) may include partial differential zero coefficient information (run, level) and partial non-zero coefficient differential information (ΔQF), the partial differential zero coefficient information (run, level) being indicative of partial differential information between the zero conversion first coefficient information (QF1 (QF2=0)) and the second zero coefficient information (QF2=0) and partial non-zero coefficient differential information (ΔQF) being indicative of partial differential information between the non-zero conversion first coefficient information (QF1 (QF2≠0)) and the second non-zero coefficient information (QF2≠0). The step (k) may have the steps of: (k1) reconstructing the zero conversion first coefficient information (QF1 (QF2=0)) on the basis of the second zero coefficient information (QF2=0) of the second coded moving picture sequence signal (B) and the partial differential zero coefficient information (run, level) of the differential coded moving picture sequence signal; (k2) reconstructing the non-zero conversion first coefficient information (QF1 (QF2≠0)) on the basis of the second non-zero coefficient information (QF2≠0) of the second coded moving picture sequence signal (B) and the partial non-zero coefficient differential information (ΔQF) of the extended differential coded moving picture sequence signal; and (k3) merging the zero conversion first coefficient information (QF1 (QF2=0)) reconstructed in the step (k1) and non-zero conversion first coefficient information (QF1 (QF2*0)) reconstructed in the step (k2) to reconstruct a part of the first coefficient information (QF1).

In accordance with a tenth aspect of the present invention, there is provided a coded signal separating and merging method, comprising: a step (n) of transcoding a first coded moving picture sequence signal (A) to generate a second coded moving picture sequence signal (B) and one or more extended differential coded moving picture sequence signals (E1 to En) on the basis of the first coded moving picture sequence signal (A) and one or more partial differential information segments constituting differential information (E) between the first coded moving picture sequence signal (A) and the second coded moving picture sequence signal (B); and a step (o) of inputting the second coded moving picture sequence signal (B) and one of the extended differential coded moving picture sequence signals (Ei) to reconstruct a pseudo first coded moving picture sequence signal (Bi). The step (n) comprises the steps of: (n1) inputting the first coded moving picture sequence signal (A) therethrough, the first coded moving picture sequence signal (A) generated as a result of encoding an original moving picture sequence signal and having a series of first picture information including first coefficient information (QF1); (n2) converting the first coded moving picture sequence signal (A) inputted through the step (n1) to generate the second coded moving picture sequence signal (B), the second coded moving picture sequence signal (B) to be decoded into a second moving picture sequence signal approximately similar to the original moving picture sequence signal and having a series of second picture information including second coefficient information (QF2); and (n3) inputting the first coded moving picture sequence signal (A) and the second coded moving picture sequence signal (B) from the step (n2) to generate the one or more extended differential coded moving picture sequence signals (E1 to En), wherein the step (n3) has the step of generating the one or more extended differential coded moving picture sequence signals (E1 to En) on the basis of the one or more partial differential information segments constituting the differential information (E) including respective one or more differences between the first coefficient information (QF1) of the first picture information of the first coded moving picture sequence signal (A) and the second coefficient information (QF2) of the second picture information of the second coded moving picture sequence signal (B). The step (o) comprises the steps of: (o1) inputting the second coded moving picture sequence signal (B) therethrough, the second coded moving picture sequence signal (B); (o2) inputting one of the extended differential coded moving picture sequence signals (Ei) therethrough; and (o3) inputting the second coded moving picture sequence signal (B) from the step (o1) and the extended differential coded moving picture sequence signal (Ei) from the step (o2) to reconstruct the pseudo first coded moving picture sequence signal (Bi), the pseudo first coded moving picture sequence signal (Bi) being to be decoded into a pseudo original moving picture sequence signal approximately similar to the original moving picture sequence signal, wherein the step (o3) has the step of reconstructing the pseudo first coded moving picture sequence signal (Bi) by reconstructing a part of the first coefficient information (QF1) of the first picture information of the first coded moving picture sequence signal (A) on the basis of the second coefficient information (QF2) of the second picture information of the second coded moving picture sequence signal (B) inputted in the step (o1), and the difference between the first coefficient information (QF1) of the first picture information of the first coded moving picture sequence signal (A) and the second coefficient information (QF2) of the second picture information of the second coded moving picture sequence signal (B) included in the partial differential information segment of the extended differential coded moving picture sequence signal (Ei) inputted in the step (o2).

In accordance with an eleventh aspect of the present invention, there is provided a computer program product comprising a computer usable storage medium having computer readable code embodied therein for transcoding a first coded moving picture sequence signal (A) to generate a second coded moving picture sequence signal (B) and an extended differential coded moving picture sequence signal (E*) on the basis of the first coded moving picture sequence signal (A) and a partial differential information segment constituting differential information (E) between the first coded moving picture sequence signal (A) and the second coded moving picture sequence signal (B), the computer readable code comprising: computer readable program code (a) for inputting the first coded moving picture sequence signal (A) therethrough, the first coded moving picture sequence signal (A) generated as a result of encoding an original moving picture sequence signal and having a series of first picture information including first coefficient information (QF1); computer readable program code (b) for converting the first coded moving picture sequence signal (A) inputted through the computer readable program code (a) to generate the second coded moving picture sequence signal (B), the second coded moving picture sequence signal (B) to be decoded into a second moving picture sequence signal approximately similar to the original moving picture sequence signal and having a series of second picture information including second coefficient information (QF2); and computer readable program code (c) for inputting the first coded moving picture sequence signal (A) and the second coded moving picture sequence signal (B) from the computer readable program code (b) to generate the extended differential coded moving picture sequence signal (E*). The computer readable program code (c) has computer readable program code for generating the extended differential coded moving picture sequence signal (E*) on the basis of the partial differential information segment constituting the differential information (E) including a difference between the first coefficient information (QF1) of the first picture information of the first coded moving picture sequence signal (A) and the second coefficient information (QF2) of the second picture information of the second coded moving picture sequence signal (B).

In the aforementioned computer program product, the differential information (E) may be in the form of a hierarchical structure including one or more sequence layers each having a plurality of screens sharing common information, one or more picture layers each having a plurality of slices sharing common information with respect to one of the screens, one or more slice layers each having a plurality of macroblocks with respect to one of the slices, one or more macroblock layers each having a plurality of blocks with respect to one of the macroblocks, and one or more block layers each having block information with respect to one of the block, and the computer readable program code (c) may have computer readable program code for generating the extended differential coded moving picture sequence signal (E*) in accordance with the hierarchical structure.

In the aforementioned computer program product, the computer readable program code (c) may have computer readable program code for generating a plurality of extended differential coded moving picture sequence signals (E1 to En) respectively on the basis of a plurality of partial differential information segments constituting the differential information (E). The plurality of partial differential information segments may be different from one another in size. The differential information (E) may be collectively constituted by the plurality of partial differential information segments.

In the aforementioned computer program product, the second coefficient information (QF2) may include second zero coefficient information (QF2=0) consisting of zero coefficients and second non-zero coefficient information (QF2≠0) consisting of non-zero coefficients, and the first coefficient information (QF1) may include zero conversion first coefficient information (QF1 (QF2=0)) consisting of zero conversion first coefficients to be converted by the computer readable program code (b) to the zero coefficients and non-zero conversion first coefficient information (QF1 (QF20)) consisting of non-zero conversion first coefficients to be converted by the computer readable program code (b) to the non-zero coefficients. The computer readable program code (c) may include: computer readable program code (c1) inputting the first coefficient information (QF1) and the second coefficient information (QF2) from the computer readable program code (b) to separate into the zero conversion first coefficient information (QF1 (QF2=0)), the non-zero conversion first coefficient information (QF1 (QF2≠0)), and the second non-zero coefficient information (QF2≠0), respectively; computer readable program code (c2) inputting the zero conversion first coefficient information (QF1 (QF2=0)) from the computer readable program code (c1) to extract differential information between the zero conversion first coefficient information (QF1 (QF2=0)) and the second zero coefficient information (QF2=0) to generate differential zero coefficient information (run, level); and computer readable program code (c3) inputting the non-zero conversion first coefficient information (QF1 (QF2≠0)) and the second non-zero coefficient information (QF2≠0) from the computer readable program code (c1) to extract differential information between the non-zero conversion first coefficient formation (QF1 (QF2≠0)) and the second non-zero coefficient information (QF2≠0) to generate differential non-zero coefficient information (ΔQF). In the aforementioned computer program product, the computer readable program code (c3) may have computer readable program code for generating the differential non-zero coefficient information (ΔQF) on the basis of the values of the first coefficients of the non-zero conversion first coefficient information (QF1 (QF2≠0)) and the values of the second coefficients of the second non-zero coefficient information (QF2≠0).

In the aforementioned computer program product, each of the first coded moving picture sequence signal (A) and the second coded moving picture sequence signal (B) may be in the form of a hierarchical structure including one or more sequence layers each having a plurality of screens sharing common information, one or more picture layers each having a plurality of slices sharing common information with respect to one of the screens, one or more slice layers each having a plurality of macroblocks with respect to one of the slices, one or more macroblock layers each having a plurality of blocks with respect to one of the macroblocks, and one or more block layers each having block information with respect to one of the blocks, the original moving picture sequence signal having coefficient information to be formed in a plurality of macroblocks. The computer readable program code (b) may have computer readable program code for obtaining a first macroblock quantization parameter (MQ1) used for the quantization of each of the macroblocks contained in the original moving picture sequence signal to generate the macroblocks contained in the first coded moving picture sequence signal (A) from the first coded moving picture sequence signal (A), and a second macroblock quantization parameter (MQ2) to be used for the inverse-quantization of each of the macroblocks contained in the second coded moving picture sequence signal (B) from the second coded moving picture sequence signal (B), and the computer readable program code (c3) may have computer readable program code for inputting the first macroblock quantization parameter (MQ1) and the second macroblock quantization parameter (MQ2) from the computer readable program code (b), and compute a prediction error (ΔQF) between the non-zero conversion first coefficient information (QF1 (QF2≠0)) and an estimated non-zero conversion first coefficient information (QF1 (QF2≠0)) on the basis of a ratio of the second macroblock quantization parameter (MQ2) to the first macroblock quantization parameter (MQ1), and the second non-zero coefficient information (QF2≠0).

In the aforementioned computer program product, each of the zero conversion first coefficients may have a value, the computer readable program code (c2) may have computer readable program code for extracting the differential information between the zero conversion first coefficient information (QF1 (QF2=0)) and the second zero coefficient information (QF2=0) for each of the values of the zero conversion first coefficients to generate a plurality of differential zero coefficient information groups (S(1), S(2), S(3)) each for one of the values (level) of the zero conversion first coefficients, the computer readable program code (c) may have computer readable program code for generating a plurality of extended differential coded moving picture sequence signals (E1 to En) respectively on the basis of a plurality of partial differential information segments constituting the differential information (E), the partial differential information segments respectively having the plurality of differential zero coefficient information groups (S(1), S(2), S(3)). In the aforementioned computer program product, the computer readable program code (c2) may have computer readable program code for generating the plurality of differential zero coefficient information groups (S(1), S(2), S(3)) in order of the values (level) of the zero conversion first coefficients, and delimit adjacent two differential zero coefficient information groups (S(1), S(2), S(3)) with a coefficient end code (EOR), each of differential zero coefficient information groups (S(1), S(2), S(3)) includes position indicators (run) indicating positions of the values (level). The computer readable program code (c2) may have computer readable program code for judging whether or not each of the values of the zero conversion first coefficients is less than a predetermined threshold value, to extract the differential information between the zero conversion first coefficient information (QF1 (QF2=0)) and the second zero coefficient information (QF2=0) for each of the values of the zero conversion first coefficients judged as being less than the threshold value, and to generate the plurality of differential zero coefficient information groups (S(1), S(2), S(3)) in order of the values (level) of the zero conversion first coefficients judged as being less than the threshold value, each of differential zero coefficient information groups (S(1), S(2), S(3)) includes position indicators (run) indicating positions of the values (level).

In accordance with a twelfth aspect of the present invention, there is provided a computer program product comprising a computer usable storage medium having computer readable code embodied therein for inputting a first coded moving picture sequence signal (A) and a second coded moving picture sequence signal (B) to generate an extended differential coded moving picture sequence signal (E*) on the basis of partial differential information segments constituting differential information (E) between the first coded moving picture sequence signal (A) and the second coded moving picture sequence signal (B), the computer readable code comprising: computer readable program code (a-a) for inputting the first coded moving picture sequence signal (A) therethrough, the first coded moving picture sequence signal (A) generated as a result of encoding an original moving picture sequence signal and having first coefficient information (QF1); computer readable program code (a-b) for inputting the second coded moving picture sequence signal (B) therethrough, the second coded moving picture sequence signal (B) generated as a result of transcoding the first moving picture sequence signal and having second coefficient information (QF2); and computer readable program code (a-c) for generating the extended differential coded moving picture sequence signal (E*) on the basis of the first coded moving picture sequence signal (A) inputted by the computer readable program code (a-a) and the second coded moving picture sequence signal (B) inputted by the computer readable program code (a-b), wherein the computer readable program code (a-c) has computer readable program code for generating the extended differential coded moving picture sequence signal (E*) on the basis of the partial differential information segment constituting the differential information (E) including a difference between the first coefficient information (QF1) of the first picture information of the first coded moving picture sequence signal (A) and the second coefficient information (QF2) of the second picture information of the second coded moving picture sequence signal (B).

In accordance with a thirteenth aspect of the present invention, there is provided a computer program product comprising a computer usable storage medium having computer readable code embodied therein, the computer readable code comprising: computer readable program code (d) storing a plurality of extended differential coded moving picture sequence signals (E1 to En) generated on the basis of partial differential information segments constituting differential information (E) between a first coded moving picture sequence signal (A) and a second coded moving picture sequence signal (B), the first coded moving picture sequence signal (A) generated as a result of encoding an original moving picture sequence signal and having a series of first picture information including first coefficient information (QF1), the second coded moving picture sequence signal (B) to be decoded into a second moving picture sequence signal approximately similar to the original moving picture sequence signal and having a series of second picture information including second coefficient information (QF2); computer readable program code (e) selecting a desired extended differential coded moving picture sequence signal (Ei) from among a plurality of extended differential coded moving picture sequence signals; and computer readable program code (f) extracting the desired extended differential coded moving picture sequence signal (Ei) selected by the computer readable program code (e) from among the plurality of extended differential coded moving picture sequence signals (E1 to En) stored by the computer readable program code (d), each of the extended differential coded moving picture sequence signals (E1 to En) generated on the basis of each of the partial differential information segments constituting the differential information (E) including a difference between the first coefficient information (QF1) of the first picture information of the first coded moving picture sequence signal (A) and the second coefficient information (QF2) of the second picture information of the second coded moving picture sequence signal (B).

In the aforementioned computer program product, each of the extended differential coded moving picture sequence signals (E1 to En) may have a bit rate, and the computer readable program code may further comprise computer readable program code (g) for specifying a desired bit rate of the extended differential coded moving picture sequence signal (E*), the computer readable program code (e) may have computer readable program code for selecting a desired extended differential coded moving picture sequence signal (Ei) having the desired bit rate from among the plurality of extended differential coded moving picture sequence signals (E1 to En) on the basis of the desired bit rate of the extended differential coded moving picture sequence signal (E*) specified by the computer readable program code (g). In the aforementioned computer program product, the desired extended differential coded moving picture sequence signal (Ei) may be to be transmitted through a transmission path at a predetermined transmission bit rate for a predetermined transmission time period, the computer readable program code (g) may have computer readable program code for specifying the bit rate of the extended differential coded moving picture sequence signal (E*) on the basis of the transmission bit rate and the transmission time period. In the aforementioned computer program product, the computer readable code may further comprise computer readable program code (h) for excluding one or more extended differential coded moving picture sequence signals (E*) from among the plurality of extended differential coded moving picture sequence signals (E1 to En). In the aforementioned computer readable code, the computer readable program code (e) has computer readable program code for selecting a desired extended differential coded moving picture sequence signal (Ei) from among the plurality of extended differential coded moving picture sequence signals (E1 to En) except for the one or more extended differential coded moving picture sequence signals (E*) excluded by the computer readable program code (h).

In the aforementioned computer program product, the second coefficient information (QF2) may include second zero coefficient information (QF2=0) consisting of zero coefficients and second non-zero coefficient information (QF2≠0) consisting of non-zero coefficients, and the first coefficient information (QF1) may include zero conversion first coefficient information (QF1 (QF2=0)) consisting of zero conversion first coefficients to be converted by the computer readable program code (b) to the zero coefficients and non-zero conversion first coefficient information (QF1 (QF2≠0)) consisting of non-zero conversion first coefficients to be converted by computer readable program code (b) to the non-zero coefficients. Each of the partial differential information segments of the extended differential coded moving picture sequence signals (E1 to En) may include partial differential zero coefficient information (run, level) and partial non-zero coefficient differential information (ΔQF), the partial differential zero coefficient information (run, level) being indicative of partial differential information between the zero conversion first coefficient information (QF1 (QF2=0)) and the second zero coefficient information (QF2=0) and partial non-zero coefficient differential information (ΔQF) being indicative of partial differential information between the non-zero conversion first coefficient information (QF1 (QF2≠0)) and the second non-zero coefficient information (QF2≠0). Each of the zero conversion first coefficients may have a value, the plurality of extended differential coded moving picture sequence signals (E1 to En) may have respective partial differential information segments and respective bit rates different from one another, the partial differential information segments respectively having the plurality of differential zero coefficient information groups (S(1), S(2), S(3)) each generated for one of the values (level) of the zero conversion first coefficients.

In accordance with a fourteenth aspect of the present invention, there is provided a computer program product comprising a computer usable storage medium having computer readable code embodied therein for inputting a second coded moving picture sequence signal (B) and an extended differential coded moving picture sequence signal (E*) to reconstruct a pseudo first coded moving picture sequence signal (B*), the extended differential coded moving picture sequence signal (E*) generated on the basis of a partial differential information segment constituting differential information (E) between a first coded moving picture sequence signal (A) and the second coded moving picture sequence signal (B), the computer readable code comprising: computer readable program code (i) inputting the second coded moving picture sequence signal (B) therethrough, the second coded moving picture sequence signal (B) generated as a result of transcoding the first coded moving picture sequence signal (A) and having a series of second picture information including second coefficient information (QF2), the first coded moving picture sequence signal (A) generated as a result of encoding original moving picture sequence signal and having a series of first picture information including first coefficient information (QF1); computer readable program code (j) inputting the extended differential coded moving picture sequence signal (E*) therethrough, the extended differential coded moving picture sequence signal (E*) having the partial differential information segment constituting the differential information (E) including a difference between the first coefficient information (QF1) of the first picture information of the first coded moving picture sequence signal (A) and the second coefficient information (QF2) of the second picture information of the second coded moving picture sequence signal (B); and computer readable program code (k) inputting the second coded moving picture sequence signal (B) from the computer readable program code (i) and the extended differential coded moving picture sequence signal (E*) from the computer readable program code (j) to reconstruct the pseudo first coded moving picture sequence signal (B*), the pseudo first coded moving picture sequence signal (B*) being to be decoded into a pseudo original moving picture sequence signal approximately similar to the original moving picture sequence signal, wherein the computer readable program code (k) has computer readable program code for reconstructing the pseudo first coded moving picture sequence signal (B*) by reconstructing a part of the first coefficient information (QF1) of the first picture information of the first coded moving picture sequence signal (A) on the basis of the second coefficient information (QF2) of the second picture information of the second coded moving picture sequence signal (B) inputted by the computer readable program code (i), and the difference between the first coefficient information (QF1) of the first picture information of the first coded moving picture sequence signal (A) and the second coefficient information (QF2) of the second picture information of the second coded moving picture sequence signal (B) included in the partial differential information segment of the extended differential coded moving picture sequence signal (E*) inputted by the computer readable program code (j).

In the aforementioned computer program product, the computer readable code may further comprise the computer readable program code (l) for storing the pseudo first coded moving picture sequence signal (B*) therein, the pseudo first coded moving picture sequence signal (B*) having the second coefficient information (QF2) of the second picture information of the second coded moving picture sequence signal (B) and the part of the first coefficient information (QF1) of the first picture information of the first coded moving picture sequence signal (A), and in aforementioned computer program product, the computer readable program code (j) may have computer readable program code for further inputting a subsequent extended differential coded moving picture sequence signal (E2) therethrough, the subsequent extended differential coded moving picture sequence signal (E2) having a subsequent partial differential information segment constituting the differential information (E) including a subsequent difference between the first coefficient information (QF1) of the first picture information of the first coded moving picture sequence signal (A) and the second coefficient information (QF2) of the second picture information of the second coded moving picture sequence signal (B), the partial differential information segment and the subsequent partial differential information segment complement each other to constitute the differential information (E); and the computer readable program code (k) may have computer readable program code for reconstructing a subsequent pseudo first coded moving picture sequence signal (B1) by reconstructing a part of the first coefficient information (QF1) of the first picture information of the first coded moving picture sequence signal (A) on the basis of the second coefficient information (QF2) of the second picture information and the part of the first coefficient information (QF1) of the first picture information of the pseudo first coded moving picture sequence signal (B*) stored by the computer readable program code (l), and the subsequent difference between the first coefficient information (QF1) of the first picture information of the first coded moving picture sequence signal (A) and the second coefficient information (QF2) of the second picture information of the second coded moving picture sequence signal (B) included in the subsequent partial differential information segment of the subsequent extended differential coded moving picture sequence signal (E*) inputted by the computer readable program code (j), the subsequent pseudo first coded moving picture sequence signal (B1) being to be decoded into a subsequent pseudo original moving picture sequence signal more similar to the original moving picture sequence signal than the second moving picture sequence signal . . .

In the aforementioned computer program product, the computer readable program code (j) may have computer readable program code for inputting a plurality of extended differential coded moving picture sequence signals (E1 to Ej) therethrough, the plurality of extended differential coded moving picture sequence signals (E1 to Ej) respectively having a plurality of partial differential information segments complementing one another to partly constitute the differential information (E), the plurality of extended differential coded moving picture sequence signals (E1 to Ej) respectively including a plurality of differences between the first coefficient information (QF1) of the first picture information of the first coded moving picture sequence signal (A) and the second coefficient information (QF2) of the second picture information of the second coded moving picture sequence signal (B); and the computer readable program code (k) may have computer readable program code for reconstructing a pseudo first coded moving picture sequence signal (Bi) by reconstructing a part of the first coefficient information (QF1) of the first picture information of the first coded moving picture sequence signal (A) on the basis of the second coefficient information (QF2) of the second picture information of the second coded moving picture sequence signal (B) inputted by the computer readable program code (i), and the plurality of differences between the first coefficient information (QF1) of the first picture information of the first coded moving picture sequence signal (A) and the second coefficient information (QF2) of the second picture information of the second coded moving picture sequence signal (B) included in the plurality of partial differential information segments of the extended differential coded moving picture sequence signals (E1 to Ej) inputted by the computer readable program code (j).

In the aforementioned computer program product, the computer readable code may further comprise computer readable program code (m) for storing the pseudo first coded moving picture sequence signal (Bi) therein, the pseudo first coded moving picture sequence signal (Bi) having the second coefficient information (QF2) of the second picture information of the second coded moving picture sequence signal (B) and the part of the first coefficient information (QF1) of the first picture information of the first coded moving picture sequence signal (A), and in the computer program product, the computer readable program code (m) may have computer readable program code for inputting one or more extended differential coded moving picture sequence signals (Ej+1 to En) therethrough, the one or more extended differential coded moving picture sequence signals (Ej+1 to En) respectively having one or more partial differential information segments complementing one another to partly constitute the differential information (E), the one or more extended differential coded moving picture sequence signals (Ej+1 to En) respectively including one or more differences between the first coefficient information (QF1) of the first picture information of the first coded moving picture sequence signal (A) and the second coefficient information (QF2) of the second picture information of the second coded moving picture sequence signal (B); and the computer readable program code (k) may have computer readable program code for reconstructing a pseudo first coded moving picture sequence signal (Bn) by reconstructing a part of the first coefficient information (QF1) of the first picture information of the first coded moving picture sequence signal (A) on the basis of the second coefficient information (QF2) of the second picture information and the part of the first coefficient information (QF1) of the first picture information of the pseudo first coded moving picture sequence signal (Bi) stored by the computer readable program code (m), and the one or more differences between the first coefficient information (QF1) of the first picture information of the first coded moving picture sequence signal (A) and the second coefficient information (QF2) of the second picture information of the second coded moving picture sequence signal (B) included in the one or more partial differential information segments of the one or more extended differential coded moving picture sequence signals (Ej+1 to En) inputted by the computer readable program code (j).

In the aforementioned computer program product, the second coefficient information (QF2) of the second picture information and the part of the first coefficient information (QF1) of the first picture information of the pseudo first coded moving picture sequence signal (Bi) stored by the computer readable program code (m) may be base partial differential information segments, the one or more partial differential information segments of the one or more extended differential coded moving picture sequence signals (Ej+1 to En) inputted by the computer readable program code (j) and the plurality of partial differential information segments of the plurality of extended differential coded moving picture sequence signals (E1 to Ej) and the base partial differential information segments may complement one another to collectively constitute the differential information (E), and the computer readable program code (k) may have computer readable program code for reconstructing the first coded moving picture sequence signal (A) by reconstructing substantially all of the first coefficient information (QF1) of the first picture information of the first coded moving picture sequence signal (A) on the basis of the second coefficient information (QF2) of the second picture information and the part of the first coefficient information (QF1) of the first picture information of the pseudo first coded moving picture sequence signal (Bi) stored by the computer readable program code (m), and the one or more differences between the first coefficient information (QF1) of the first picture information of the first coded moving picture sequence signal (A) and the second coefficient information (QF2) of the second picture information of the second coded moving picture sequence signal (B) included in the one or more partial differential information segments of the one or more extended differential coded moving picture sequence signals (Ej+1 to En) inputted by the computer readable program code (j).

In the aforementioned computer program product, the second coefficient information (QF2) may include second zero coefficient information (QF2=0) consisting of zero coefficients and second non-zero coefficient information (QF2#0) consisting of non-zero coefficients, the first coefficient information (QF1) may include zero conversion first coefficient information (QF1 (QF2=0)) consisting of zero conversion first coefficients to be converted by the computer readable program code (b) to the zero coefficients and non-zero conversion first coefficient information (QF1 (QF2≠0)) consisting of non-zero conversion first coefficients to be converted by the computer readable program code (b) to the non-zero coefficients. The partial differential information segment of the extended differential coded moving picture sequence signal (E*) may include partial differential zero coefficient information (run, level) and partial non-zero coefficient differential information (ΔQF), the partial differential zero coefficient information (run, level) may be indicative of partial differential information between the zero conversion first coefficient information (QF1 (QF2=0)) and the second zero coefficient information (QF2=0) and partial non-zero coefficient differential information (ΔQF) may be indicative of partial differential information between the non-zero conversion first coefficient information (QF1 (QF2≠0)) and the second non-zero coefficient information (QF2≠0). The computer readable program code (k) may have: computer readable program code (k) reconstructing the zero conversion first coefficient information (QF1 (QF2=0)) on the basis of the second zero coefficient information (QF2=0) of the second coded moving picture sequence signal (B) and the partial differential zero coefficient information (run, level) of the differential coded moving picture sequence signal; computer readable program code (k2) reconstructing the non-zero conversion first coefficient information (QF1 (QF2≠0)) on the basis of the second non-zero coefficient information (QF2≠0) of the second coded moving picture sequence signal (B) and the partial non-zero coefficient differential information (ΔQF) of the extended differential coded moving picture sequence signal; and computer readable program code (k3) merging the zero conversion first coefficient information (QF1 (QF2=0)) reconstructed by the computer readable program code (k1) and non-zero conversion first coefficient information (QF1 (QF2≠0)) reconstructed by the computer readable program code (k2) to reconstruct a part of the first coefficient information (QF1).

In accordance with a fifteenth aspect of the present invention, there is provided computer program product comprising a computer usable storage medium having computer readable code embodied therein, the computer readable code comprising: computer readable program code (n) for transcoding a first coded moving picture sequence signal (A) to generate a second coded moving picture sequence signal (B) and one or more extended differential coded moving picture sequence signals (E1 to En) on the basis of the first coded moving picture sequence signal (A) and one or more partial differential information segments constituting differential information (E) between the first coded moving picture sequence signal (A) and the second coded moving picture sequence signal (B); and computer readable program code (o) for inputting the second coded moving picture sequence signal (B) and one of the extended differential coded moving picture sequence signals (Ei) to reconstruct a pseudo first coded moving picture sequence signal (Bi). The computer readable program code (n) comprises: computer readable program code (n1) for inputting the first coded moving picture sequence signal (A) therethrough, the first coded moving picture sequence signal (A) generated as a result of encoding an original moving picture sequence signal and having a series of first picture information including first coefficient information (QF1); computer readable program code (n2) for converting the first coded moving picture sequence signal (A) inputted through the computer readable program code (n1) to generate the second coded moving picture sequence signal (B), the second coded moving picture sequence signal (B) to be decoded into a second moving picture sequence signal approximately similar to the original moving picture sequence signal and having a series of second picture information including second coefficient information (QF2); and computer readable program code (n3) for inputting the first coded moving picture sequence signal (A) and the second coded moving picture sequence signal (B) from the computer readable program code (n2) to generate the one or more extended differential coded moving picture sequence signals (E1 to En), wherein the computer readable program code (n3) has computer readable program code for generating the one or more extended differential coded moving picture sequence signals (E1 to En) on the basis of the one or more partial differential information segments constituting the differential information (E) including respective one or more differences between the first coefficient information (QF1) of the first picture information of the first coded moving picture sequence signal (A) and the second coefficient information (QF2) of the second picture information of the second coded moving picture sequence signal (B). The computer readable program code (o) comprises: computer readable program code (o1) for inputting the second coded moving picture sequence signal (B) therethrough, the second coded moving picture sequence signal (B); computer readable program code (o2) for inputting one of the extended differential coded moving picture sequence signals (Ei) therethrough; and computer readable program code (o3) for inputting the second coded moving picture sequence signal (B) from the computer readable program code (o1) and the extended differential coded moving picture sequence signal (Ei) from the computer readable program code (o2) to reconstruct the pseudo first coded moving picture sequence signal (Bi), the pseudo first coded moving picture sequence signal (Bi) being to be decoded into a pseudo original moving picture sequence signal approximately similar to the original moving picture sequence signal, wherein the computer readable program code (o3) may have computer readable program code for reconstructing the pseudo first coded moving picture sequence signal (Bi) by reconstructing a part of the first coefficient information (QF1) of the first picture information of the first coded moving picture sequence signal (A) on the basis of the second coefficient information (QF2) of the second picture information of the second coded moving picture sequence signal (B) inputted by the computer readable program code (o1), and the difference between the first coefficient information (QF1) of the first picture information of the first coded moving picture sequence signal (A) and the second coefficient information (QF2) of the second picture information of the second coded moving picture sequence signal (B) included in the partial differential information segment of the extended differential coded moving picture sequence signal (Ei) inputted by the computer readable program code (o2).

### BRIEF DESCRIPTION OF THE DRAWINGS

The present invention and many of the advantages thereof will be better understood from the following detailed description when considered in connection with the accompanying drawings, wherein:

FIG. 1 is a schematic diagram explaining a concept of separating and merging operations performed by preferred embodiments of a bit stream separating apparatus, a bit stream extracting apparatus, and a bit stream merging apparatus according to the present invention;

FIG. 2 is a schematic diagram explaining an overview of separating operation performed by the preferred embodiment of the bit stream separating apparatus shown in FIG. 1;

FIG. 3 is a schematic diagram explaining a principle of merging operation performed by the bit stream merging apparatus shown in FIG. 1, showing that an extended differential bit stream is extracted by the bit stream extracting apparatus shown in FIG. 1;

FIG. 4 is a schematic diagram similar to FIG. 3 but showing that a plurality of extended differential bit stream are extracted by the bit stream extracting apparatus shown in FIG. 1;

FIG. 5 is a structural diagram showing the hierarchical structure of a differential bit stream;

FIG. 6 is a block diagram of the preferred embodiment of the bit stream separating apparatus shown in FIG. 1;

FIG. 7 is a conceptual diagram explaining the switching control operation of transcoded bit stream and the differential bit stream performed by the preferred embodiment of the bit stream merging apparatus according to the present invention;

FIG. 8 is a block diagram of the bit stream merging apparatus shown in FIG. 1;

FIG. 9 is a schematic view explaining a concept of encoding a differential coefficient information segment performed by the preferred embodiment of the bit stream separating apparatus shown in FIG. 1;

FIG. 10 is a schematic view explaining a principle of encoding a differential coefficient information segment performed by the preferred embodiment of the bit stream separating apparatus shown in FIG. 1;

FIG. 11 is a flowchart showing the flow of encoding a differential coefficient information segment performed by the preferred embodiment of the bit stream separating apparatus shown in FIG. 1;

FIG. 12 is a flowchart showing the flow of encoding the differential coefficient information segment performed by the preferred embodiment of the bit stream separating apparatus shown in FIG. 1;

FIG. 13 is a schematic view explaining a principle of reconstructing the differential coefficient information segment performed by the preferred embodiment of the bit stream merging apparatus shown in FIG. 6;

FIG. 14 is a flowchart showing the flow of reconstructing the differential coefficient information segment performed by the preferred embodiment of the bit stream merging apparatus shown in FIG. 6;

FIG. 15 is a flowchart showing the flow of reconstructing the differential coefficient information segment performed by the preferred embodiment of the bit stream merging apparatus shown in FIG. 6;

FIG. 16 is a schematic view explaining a principle of merging a second pseudo original bit stream with an extended differential bit stream performed by the preferred embodiment of the bit stream merging apparatus shown in FIG. 6;

FIG. 17 is a block diagram of the bit stream extracting apparatus shown in FIG. 1;

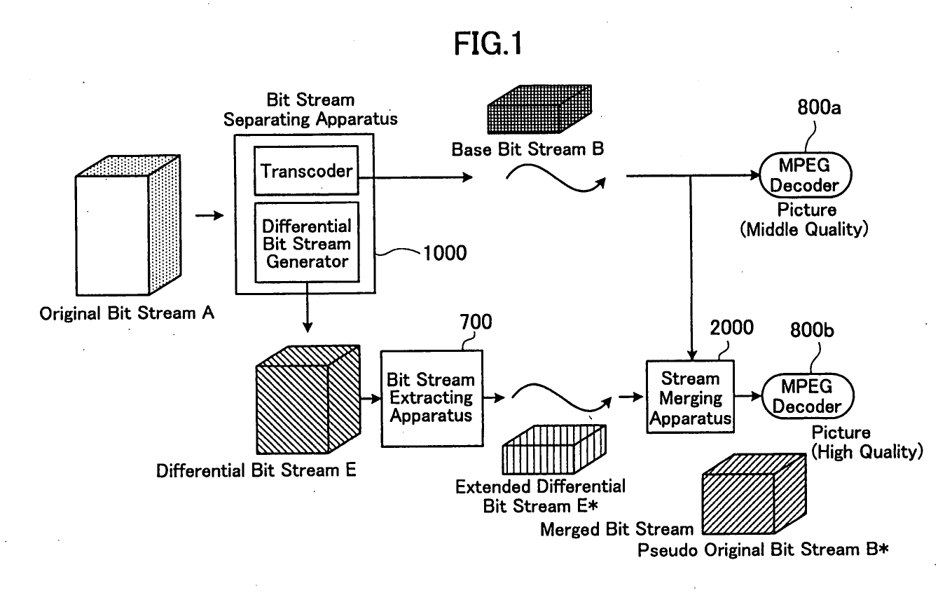

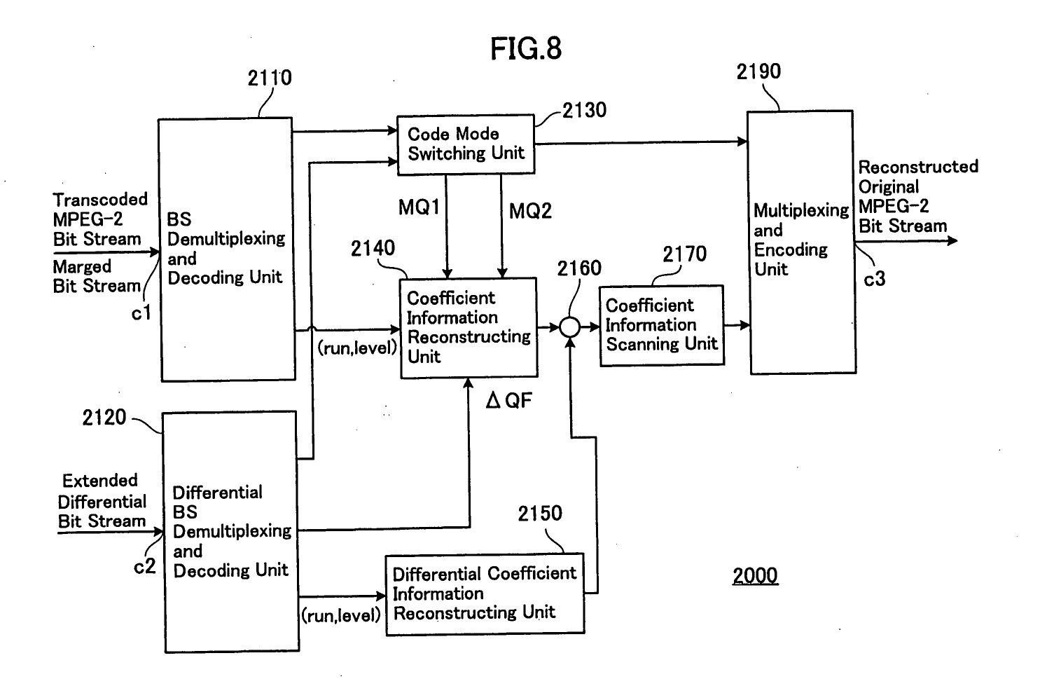

FIG. 8 is a block diagram of the bit stream merging apparatus shown in FIG. 1;

FIG. 18 is a schematic block diagram showing a first conventional transcoder;

FIG. 19 is a flowchart showing the flow of the rate control operation of MPEG-2 performed by the first conventional transcoder shown in FIG. 18;

FIG. 20 is a schematic block diagram showing a second conventional transcoder;

FIG. 21 is a flowchart showing the process performed by the second conventional transcoder shown in FIG. 20;

FIG. 22 is a schematic block diagram showing a third conventional transcoder;

FIG. 23 is a flowchart showing the process performed by the third conventional transcoder shown in FIG. 22; and

FIG. 24 is a schematic block diagram showing a fourth conventional transcoder.

### BEST MODE FOR CARRYING OUT THE INVENTION

A preferred embodiment of a coded signal separating apparatus, a preferred embodiment of a coded signal merging apparatus according to the present invention, a differential coded signal extracting apparatus according to the present invention, and a differential coded signal extracting apparatus according to the present invention will now be described in detail in accordance with the accompanying drawings.

Referring now to FIG. 1 of the drawings, there are shown a preferred embodiment of a coded signal separating apparatus according to the present invention as a bit stream separating apparatus 1000, a preferred embodiment of a coded signal merging apparatus according to the present invention as a bit stream merging apparatus 2000, and a differential coded signal extracting apparatus according to the present invention as a bit stream extracting apparatus 700. The bit stream separating apparatus 1000 is operative to transcode a first coded moving picture sequence signal in the form of an original bit stream A to generate a second coded moving picture sequence signal in the form of a base bit stream B and differential information between the original bit stream A and the base bit stream B in the form of differential bit stream E. In the present embodiment, the original bit stream A has, but is not limited to a MPEG-2 format The first coded moving picture sequence signal in the form of original bit stream A is generated as a result of encoding an original moving picture sequence signal. The differential bit stream E includes a plurality of extended differential moving picture sequence signals in the form of extended differential bit streams E1 to En each generated a plurality of partial differential information segments constituting the differential bit stream E. The bit stream extracting apparatus 700 is operative to extract one of the extended differential bit streams E1 to En from the differential bit stream E. The bit stream merging apparatus 2000 is operative to input the second coded moving picture sequence signal in the form of the base bit stream B and the extended differential coded moving picture sequence signal in the form of the extended differential bit stream E* to reconstruct a pseudo first coded moving picture sequence signal in the form of a pseudo original bit stream B*. The base bit stream B is outputted to a MPEG decoder 800a, and the pseudo original bit stream B* is outputted to a MPEG decoder 800b. The MPEG decoder 800a is operative to decode the base bit stream B into a base moving picture sequence signal, which is roughly similar to the original moving picture sequence signal. The MPEG decoder 800b is operative to decode the pseudo original bit stream B* into a pseudo original moving picture sequence signal. The pseudo original moving picture sequence signal is similar to the original moving picture sequence signal more than the base moving picture sequence signal. This leads to the fact that a picture of middle quality can be reproduced on the basis of the base moving picture sequence signal while, on the other hand, a picture of high quality can be reproduced on the basis of the pseudo original moving picture sequence signal. The bit stream separating apparatus 1000 and the bit stream merging apparatus 2000 collectively constitute a coded signal separating and merging system according to the present invention.

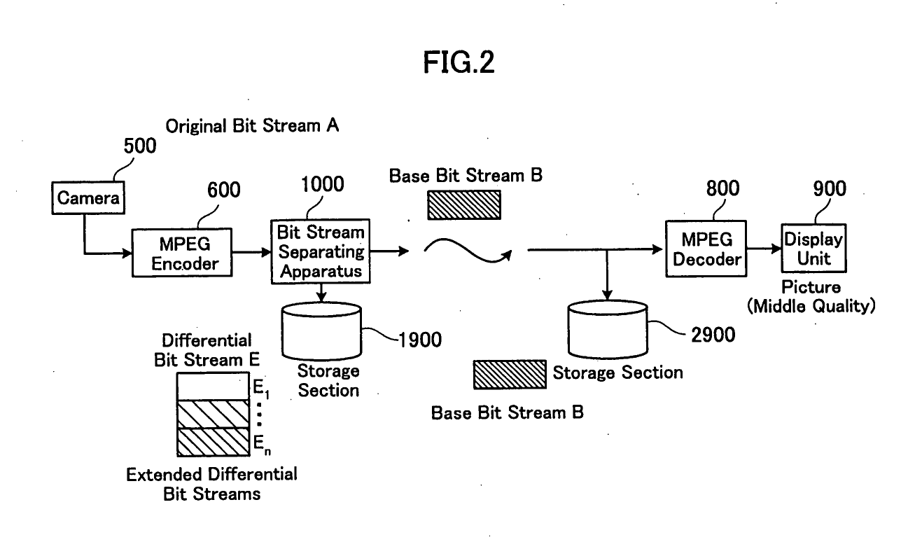

The overview of separating operation performed by the preferred embodiment of the bit stream separating apparatus 1000 will be described hereinlater with reference to FIG. 2. As illustrated in FIG. 2, there are shown a camera unit 500, an MPEG encoder 600, a bit stream separating apparatus 1000, a storage section 1900, a storage section 2900, an MPEG decoder 800, and a display unit 900. The camera unit 500, the MPEG encoder 600, the bit stream separating apparatus 1000, and the storage section 1900 constitute a transmitting party. The storage section 2900, the MPEG decoder 800, and the display unit 900 constitute a receiving party. In the transmitting party, the camera unit 500 is operative to take a moving picture to transform the moving picture into a moving picture sequence signal. The MPEG encoder 600 is operative to encode the moving picture sequence signal into a first coded moving picture sequence signal in the form of an original bit stream A. The bit stream separating apparatus 1000 is operative to input the original bit stream A from the MPEG encoder 600 through a first transmission path, not shown, to generate a base bit stream B, and a plurality of extended differential bit streams E1 to En respectively on the basis of a plurality of partial differential information segments constituting the differential bit stream E between the original bit stream A and the base bit stream B. The storage section 1900 is operative to store the differential bit stream E constituted by the extended differential bit streams E1 to En generated by the bit stream separating apparatus 1000. The base bit stream B is transmitted from the transmitting party through a second transmission path, not shown, to the receiving party. In the receiving party, the storage section 2900 is operative to store the base bit stream B therein. The MPEG decoder 800 is operative to decode the base bit stream B stored in the storage section 2900 into a base moving picture sequence signal.

As described above, the extended differential bit streams E1 to En are respectively generated on the basis of a plurality of partial differential information segments constituting the differential bit stream E. This means that relationship between the differential bit stream E and the extended differential bit streams E1 to En is represented by the expression as follows.
E=E1+E2+ . . . +En.

The relationship between the original bit stream A and the base bit stream B stored in the storage section 2900 is represented by the expression as follows.
B=A−(E1+E2+ . . . +En)=A−E

The above expression leads to the fact that the base bit stream B stored in the storage section 2900 is roughly similar to the original bit stream A. The MPEG decoder 800 is operative to decode the base bit stream B stored in the storage section 2900 into a base moving picture sequence signal. The display unit 900 is operative to receive the base moving picture sequence signal from the MPEG decoder 800 and display a moving picture of middle quality on the basis of the base moving picture sequence signal. The display unit 900 is operative to receive the base moving picture sequence signal from the MPEG decoder 800 and display a moving picture of middle quality on the basis of the base moving picture sequence signal.

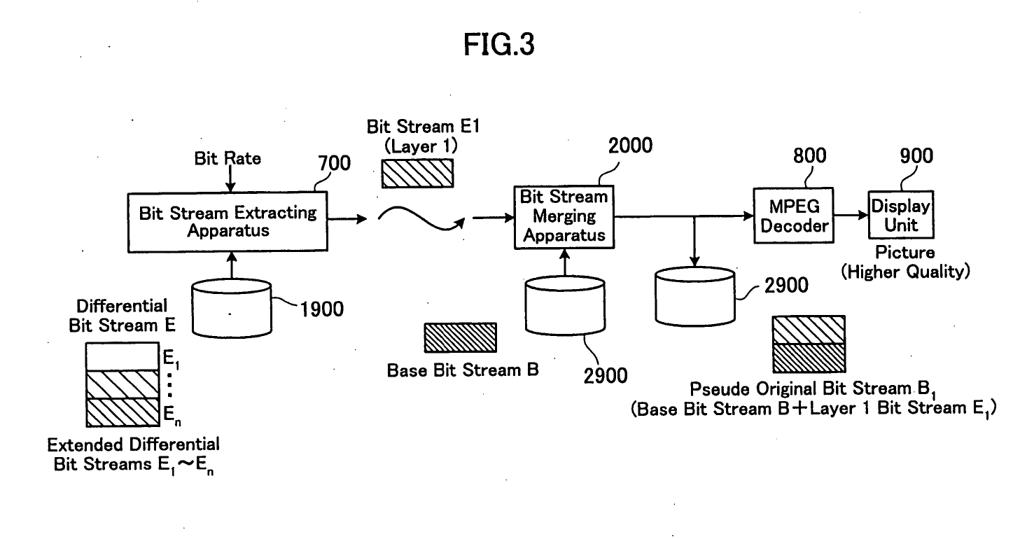

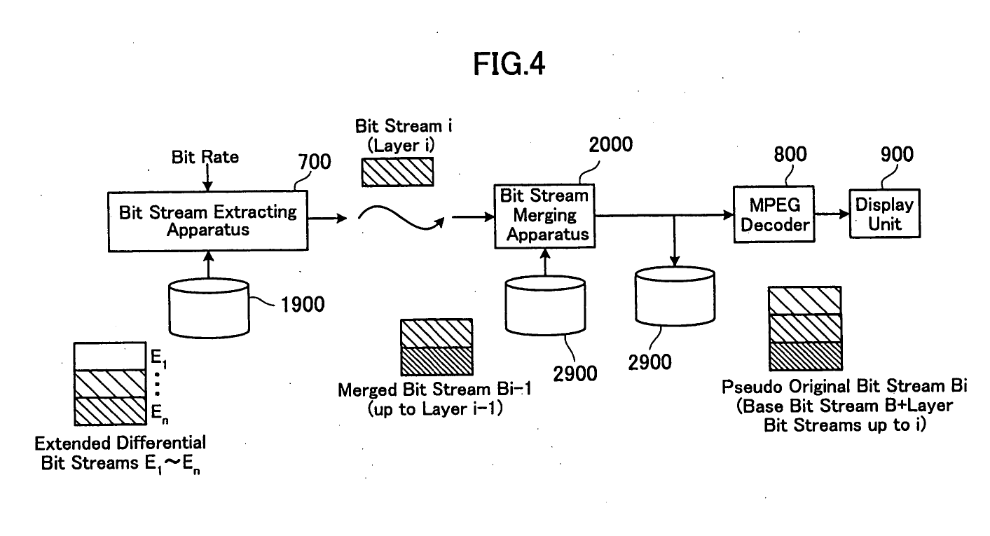

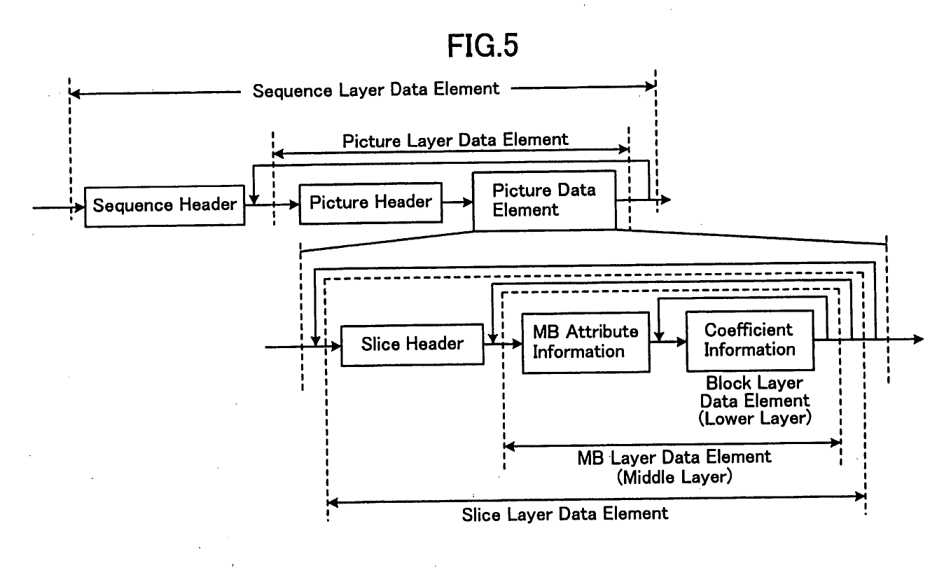

The principle of merging operation performed by the preferred embodiments of the bit stream extracting apparatus 700 and the bit stream merging apparatus 2000 will be described hereinlater with reference to FIGS. 3 and 4.

As best shown in FIG. 3, the bit stream extracting apparatus 700 is operated to extract an extended differential bit stream E1, hereinlater referred to as a “layer 1 bit stream”, from the differential bit stream E stored in the storage section 1900. The layer 1 bit stream E1 thus extracted is transmitted from the transmitting party through a third transmission path, not shown, to the receiving party. The bit stream merging apparatus 2000 is operative to merge the extended differential bit stream E1 and the base bit stream B stored in the storage section 2900 to generate a pseudo original bit stream B1. The bit stream merging apparatus 2000 is then operated to store the pseudo original bit stream B1 thus generated into the storage section 2900. The relationship between the original bit stream A and the pseudo original bit stream B1 stored in the storage section 2900 is represented by the expression as follows.
B1=A−(E2+ . . . +En)=B+E1

The above expression leads to the fact that the pseudo original bit stream B1 stored in the storage section 2900 is similar to the original bit stream A more than the base bit stream B because of the fact that the pseudo original bit stream B1 includes the extended differential bit stream E1. The MPEG decoder 800 is operative to decode the pseudo original bit stream B1 stored in the storage section 2900 into a pseudo moving picture sequence signal. The display unit 900 is operative to receive the pseudo first moving picture sequence signal from the MPEG decoder 800 and display a moving picture on the basis of the pseudo moving picture sequence signal. The moving picture displayed on the basis of the pseudo original bit stream B1 is better in quality than the moving picture displayed on the basis of the base bit stream B.

The bit stream extracting apparatus 700 is then operated to extract a subsequent extended differential bit stream E2, hereinlater referred to as a “layer 2 bit stream”, from the differential bit stream E stored in the storage section 1900. The layer 2 bit stream E2 thus extracted is transmitted from the transmitting party through the third transmission path to the receiving party. The bit stream merging apparatus 2000 is operative to merge the extended differential bit stream E2 and the pseudo original bit stream B1 stored in the storage section 2900 to generate a pseudo original bit stream B2. The bit stream merging apparatus 2000 is then operated to store the pseudo original bit stream B2 thus generated into the storage section 2900.

Similarly, the bit stream extracting apparatus 700 is operated to extract a subsequent extended differential bit stream Ei, hereinlater referred to as a “layer i bit stream”, from the differential bit stream E stored in the storage section 1900 wherein i is an integer not greater than n. The layer i bit stream thus extracted is transmitted from the transmitting party through the third transmission path to the receiving party. The bit stream merging apparatus 2000 is operative to merge the extended differential bit stream Ei and the pseudo original bit stream Bᵢ₋₁, stored in the storage section 2900 to generate a pseudo original bit stream Bi. The bit stream merging apparatus 2000 is then operated to store the pseudo original bit stream Bi thus generated into the storage section 2900 as shown in FIG. 4. The relationship between the original bit stream A and the pseudo original bit stream Bi stored in the storage section 2900 is represented by the expression as follows.
Bi=A−(Ei+1+ . . . +En)=B+(E1+ . . . +Ei)

The above expression leads to the fact that the pseudo original bit stream Bi stored in the storage section 2900 is similar to the original bit stream A more than the pseudo original bit stream Bᵢ₋₁ because of the fact that the pseudo original bit stream Bi includes the extended differential bit stream Ei. The MPEG decoder 800 is operative to decode the pseudo original bit stream Bi stored in the storage section 2900 into a pseudo moving picture sequence signal. The display unit 900 is operative to receive the pseudo first moving picture sequence signal from the MPEG decoder 800 and display a moving picture on the basis of the pseudo moving picture sequence signal. The moving picture displayed on the basis of the pseudo original bit stream Bi is better in quality than the moving picture displayed on the basis of the pseudo original bit stream Bi.

Each of the original bit stream A, the base bit stream B, the extended differential bit stream Ei, and the pseudo original bit stream Bi has a bit rate. As will be seen from the above expressions, the bit rate of the original bit stream A is greater than that of the base bit stream B and that of the extended differential bit stream Ei.

Though it has been described in the above that the bit stream extracting apparatus 700 is operative to extract an extended differential bit stream Ei, the bit stream extracting apparatus 700 according to the present invention may concurrently extract a plurality of extended differential bit streams.

While it has been described in the above that the bit stream merging apparatus 2000 is operative to merge the base bit stream B or the pseudo original bit stream Bᵢ₋₁ with an extended differential bit stream Ei to reconstruct a pseudo original bit stream Bi, the bit stream merging apparatus 2000 according to the present invention may merge the base bit stream B or the pseudo original bit stream Bᵢ₋₁ with a plurality of extended differential bit stream Ei to Ej to reconstruct a pseudo original bit stream Bj.

The construction of the bit stream separating apparatus 1000 and the bit stream merging apparatus 2000 will be described hereinlater.

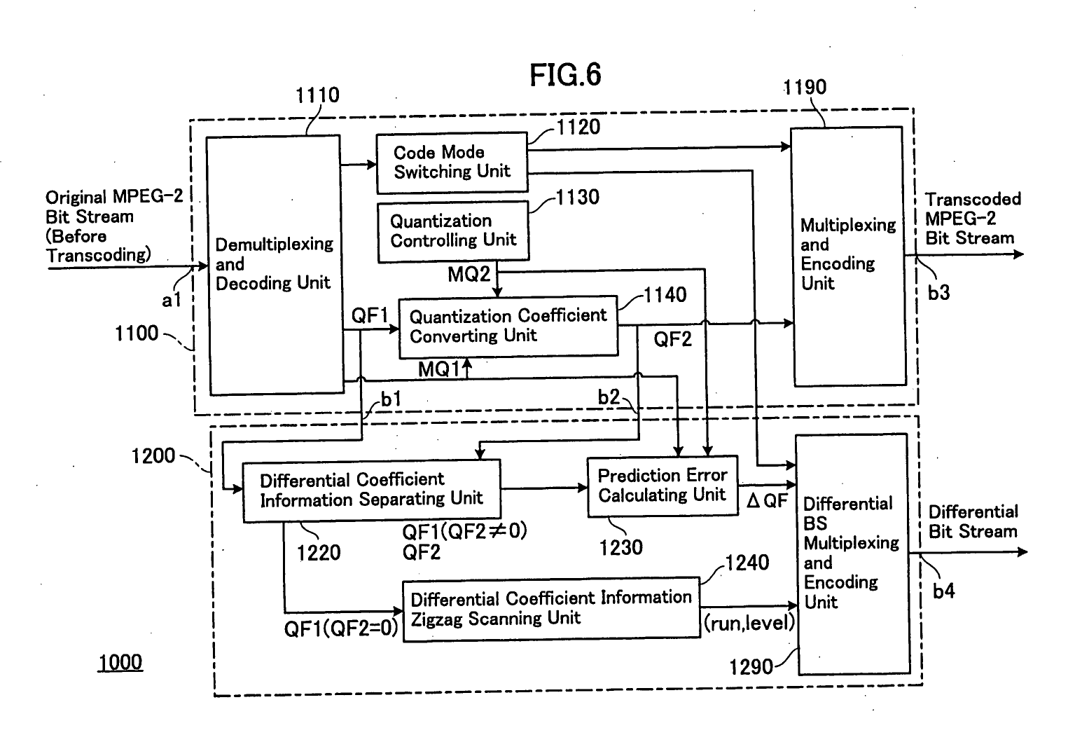

The bit stream separating apparatus 1000 is shown in FIG. 6 as comprising inputting means as an input terminal a1, coded signal converting means as a transcoder 1100, and differential coded signal generating means as a differential bit stream generator 1200. The input terminal a1 is electrically connected with the first transmission path to input the original bit stream A therethrough. The original bit stream A is generated by the MPEG encoder 600 as a result of encoding an original moving picture sequence signal.

The transcoder 1100 is operative to convert the original bit stream A inputted through the input terminal a1 to generate a transcoded bit stream, hereinlater referred to as “a base bit stream B”. The base bit stream B is later transmitted to the receiving party and decoded by the MPEG decoder 800 into a base moving picture sequence signal approximately similar to the original moving picture sequence signal. The transcoder 1100 has an output terminal b3 connected to the second transmission path for outputting the base bit stream B therethrough.

The original bit stream A and the base bit stream B respectively have a series of first picture information including first coefficient information designated by legend QF1 in FIG. 6 and a series of second picture information including second coefficient information designated by legend QF2 in FIG. 6, which will be described hereinlater.

Each of the original bit stream A and the base bit stream B is in the form of a hierarchical structure including one or more sequence layers each having a plurality of screens sharing common information, one or more picture layers each having a plurality of slices sharing common information with respect to one of the screens, one or more slice layers each having a plurality of macroblocks with respect to one of the slices, one or more macroblock layers each having a plurality of blocks with respect to one of the macroblocks, and one or more block layers each having block information with respect to one of the blocks.

As best shown in FIG. 5, the sequence layer, the picture layer, the slice layer, the macroblock layer, and the block layer contain sequence layer data elements, picture layer data elements, slice layer data elements, macroblock layer data elements, and block layer data elements, respectively. This means that the sequence layer contains the sequence layer data elements including a sequence header and the picture layer data elements. The picture layer contains picture layer data elements including a picture header and picture data elements. The picture data element contains slice layer data elements. The slice layer data element contains a slice header and MB layer data elements. The MB layer data element contains MB attribute information and block layer data elements. The block layer data element contains coefficient information. The coefficient information includes a matrix of coefficients. Similarly, the original moving picture sequence signal has coefficient information to be formed in a plurality of macroblocks.

The sequence layer, the picture layer, and the slice layer are as a whole referred to as “upper layer”, the macroblock layer, i.e., MB layer is referred to as “middle layer”, and the block layer is referred to as “lower layer”, hereinlater. Furthermore, the information contained in the upper layer, the middle layer, or the lower layer is referred to as “upper layer information”, “middle layer information”, or “lower layer information, respectively.

The differential bit stream generator 1200 is operative to input the original bit stream A and the base bit stream B from the transcoder 1100 to generate one or more extended differential coded moving picture sequence signals in the form of an extended differential bit streams E*.

The differential bit stream generator 1200 has a first input terminal b1 for inputting the original bit stream A, a second input terminal b2 for inputting the base bit stream B from the transcoder 1100, and an output terminal b4 connected to the third transmission path for outputting the extended differential bit streams E* therethrough. This means that the differential bit stream generator 1200 is operative to generate one or more extended differential bit streams E1 to En respectively on the basis of a plurality of partial differential information segments constituting the differential bit stream E. Each of the partial differential information segments includes a difference between the first coefficient information QF1 of the first picture information of the original bit stream A and the second coefficient information QF2 of the second picture information of the base bit stream B.

Furthermore, the differential bit stream generator 1200 is operative to generate a differential bit stream E and one or more extended differential bit streams E* in accordance with the hierarchical structure. This means that the bit stream separating apparatus 1000 is operative to input an original bit stream A conformable to MP@ML (“Main Profile at Main Level”, a form of MPEG-2 coding which covers broadcast television formats up to and including 720 pixels by 576 lines at 30 fps using 4:2:0 sampling) to separate into and generate a base bit stream B and one or more extended differential bit streams E1 to En. The differential bit stream E is a difference between the original bit stream A and the base bit stream B. As best shown in FIG. 5, the differential bit stream E is, similar to the original bit stream A and the base bit stream B, in the form of a hierarchical structure including one or more sequence layers each having a plurality of screens sharing common information, one or more picture layers each having a plurality of slices sharing common information with respect to one of the screens, one or more slice layers each having a plurality of macroblocks with respect to one of the slices, one or more macroblock layers each having a plurality of blocks with respect to one of the macroblocks, and one or more block layers each having block information with respect to one of the block. The fact that the differential bit stream E is in the form of a hierarchical structure leads to the fact that the differential bit stream E can be separately processed for each of the layers.

Similar to the original bit stream A and the base bit stream B, the sequence layer, the picture layer, the slice layer, the macroblock layer, and the block layer of the differential bit stream E contain sequence layer data elements, picture layer data elements, slice layer data elements, macroblock layer data elements, and block layer data elements, respectively. This means that the sequence layer of the differential bit stream E contains the sequence layer data elements including a sequence header and the picture layer data elements. The picture layer of the differential bit stream E contains picture layer data elements including a picture header and picture data elements. Picture data element of the differential bit stream E contains slice layer data elements. The slice layer data element of the differential bit stream E contains a slice header and MB layer data elements. The MB layer data element of the differential bit stream E contains MB attribute information and block layer data elements. The block layer data element of the differential bit stream E contains coefficient information. The MB attribute information is used to indicate the positions of macroblocks, i.e., MBs and their code modes. The coefficient information includes the information about quantization coefficients.

As described in the above, the differential bit stream generator 1200 is operative to generate one or more extended differential bit streams E1 to En respectively on the basis of a plurality of partial differential information segments constituting the differential bit stream E. The differential bit stream E is collectively constituted by the plurality of partial differential information segments. The plurality of partial differential information segments are different from one another in size. This leads to the fact that the extended differential bit streams E1 to En thus respectively generated on the basis of a plurality of partial differential information segments are different from one another in size and, accordingly, bit rate. This makes it possible for the bit stream separating apparatus 1000 to selectively transmit the extended differential bit streams E1 to En through a plurality of transmission paths having respective bit rates.

The coefficient information of each of the original bit stream A, the base bit stream B, and the differential bit stream E include coefficients in the form of a matrix. Each of the coefficients has a value. The values of the coefficients contained in the coefficient information of each of the original bit stream A, the base bit stream B, and the differential bit stream E include zero and non-zero. A coefficient whose absolute value is equal to zero will be hereinlater referred to as “zero coefficient”, and a coefficient whose value is not equal to zero will be hereinlater referred to as “non-zero coefficient”. The second coefficient information QF2 of the base bit stream B includes second zero coefficient information designated in FIG. 6 by legend QF2=0 consisting of zero coefficients and second non-zero coefficient information designated in FIG. 6 by legend QF2≠0 consisting of non-zero coefficients.

Coefficients in the first coefficient information QF1 of the original bit stream A are converted by the transcoder 1100 into zero coefficients QF2=0 or non-zero coefficients QF2≠0 in the second coefficient information of the base bit stream B. Accordingly, coefficients in the first coefficient information QF1 to be converted by the transcoder 1100 into zero coefficients will be hereinlater referred to as “zero conversion first coefficients” and coefficients in the first coefficient information QF1 to be converted by the transcoder 1100 into non-zero coefficients will be hereinlater referred to as “non-zero conversion first coefficients”. This means that the first coefficient information QF1 includes zero conversion first coefficient information designated in FIG. 6 by legend QF1 (QF2=0) consisting of zero conversion first coefficients to be converted by the transcoder 1100 into the zero coefficients, and non-zero conversion first coefficient information designated in FIG. 6 by legend QF1 (QF2≠0) consisting of non-zero conversion first coefficients to be converted by the transcoder 1100 into the non-zero coefficients.

The construction of the transcoder 1100 will be described hereinlater with reference to FIG. 6.

The transcoder 1100 is shown in FIG. 6 as comprising a demultiplexing and decoding unit 1110, a code mode switching unit 1120, a quantization controlling unit 1130, a quantization coefficient converting unit 1140, and a multiplexing and encoding-unit 1190.

The demultiplexing and decoding unit 1110 is operative to input the original bit stream A from the input terminal a1, demultiplex and decode the original bit stream A inputted from the inputting terminal a1 to reconstruct the upper layer information, the middle layer information and the lower layer information, and output the upper layer information and the middle layer information to the code mode switching unit 1120, and the lower layer information to the quantization coefficient converting unit 1140 and a prediction error calculating unit 1230 of the differential bit stream generator 1200, which will be described later.

The code mode switching unit 1120 is operative to input the upper layer information and the middle layer information from the demultiplexing and decoding unit 1110. Each of the upper layer information and the middle layer information has a code having a picture coding type. The code mode switching—unit 1120 is operative to judge if the codes are to be modified or not on the basis of the picture coding types of codes. If it is judged that the codes are to be modified, the code mode switching unit 1120 is operative to modify the codes in accordance with the picture coding types of codes and output the upper layer information and the middle layer information including the codes thus modified to the multiplexing and encoding unit 1190 and the differential bit stream generator 1200. The code to be modified may be a code such as for example MB information, CBP, or the like. If, on the other hand, it is judged that the codes are not to be modified, the code mode switching unit 1120 is operative to output the upper layer information and the middle layer information to the multiplexing and encoding unit 1190 and the differential bit stream generator 1200 without modifying the codes.

The quantization controlling unit 1130 is operative to output a second macroblock quantization parameter, hereinlater referred to as “a macroblock re-quantization parameter” designated by legend MQ2 with respect to each of macroblocks, i.e., MB to the quantization coefficient converting unit 1140 and the prediction error calculating unit 1230 of the differential bit stream generator 1200 in order to control the amount of bits. The macroblock re-quantization parameter MQ2 is used as a macroblock re-quantization parameter to quantize each of the macroblocks contained in the original moving picture sequence information decoded from the original bit stream A to generate macroblocks to be contained in the base bit stream B as well as a macroblock inverse-quantization parameter to inversely quantize each of the macroblocks contained in the base bit stream B to reconstruct the macroblocks of the original moving picture sequence information.

The quantization coefficient converting unit 1140 is operative to input the first coefficient information QF1 and a first macroblock quantization parameter, hereinlater referred to simply as, “macroblock quantization parameter” designated by legend MQ1 from the demultiplexing and decoding unit 1110, and the re-quantization parameter MQ2 from the quantization controlling unit 1130. Here, the first coefficient information QF1 is constituted by a matrix of coefficients decoded from the original bit stream A, and the macroblock quantization parameter MQ1 is a macroblock quantization parameter used to quantize each of the macroblocks contained in the original moving picture sequence information to generate the macroblocks to be contained in the original bit stream A as well as a macroblock inverse-quantization parameter used to inversely quantize each of the macroblocks contained in the original bit stream A to reconstruct the macroblocks contained in the original moving picture sequence information. Then, the quantization coefficient converting unit 1140 is operative to inversely quantize the first coefficient information QF1 with the quantization parameter MQ1 and quantize the coefficient information thus inversely quantized with the re-quantization parameter MQ2 to generate second coefficient information designated by legend QF2. The second coefficient information QF2 is constituted by a matrix of coefficients to be encoded into the base bit stream B. The quantization coefficient converting unit 1140 is operative to output the second coefficient information QF2 to the multiplexing and encoding unit 1190, and the first coefficient information QF1 and the second coefficient information QF2 to the differential bit stream generator 1200. The first coefficient information QF1 and the second coefficient information QF2 respectively constitute the lower layer information of the original bit stream A and the base bit stream B.

The multiplexing and encoding unit 1190 is operative to multiplex and encode the upper layer information and the middle layer information inputted from the code mode switching unit 1120 and the lower layer information inputted from the quantization coefficient converting unit 1140 to generate a base bit stream B to be outputted to the output terminal b3.

As shown in FIG. 6, the differential bit stream generator 1200 includes a coefficient information separating section constituted by a differential coefficient information separating unit 1220, and a non-zero coefficient encoding section constituted by a prediction error calculating unit 1230, a zero coefficient encoding section constituted by a differential coefficient information zigzag scanning unit 1240, and a differential BS multiplexing and encoding unit 1290.

The differential coefficient information separating unit 1220 is operative to input the first coefficient information QF1 and the second coefficient information QF2 from the transcoder 1100 to separate into the zero conversion first coefficient information QF1 (QF2=0), the non-zero conversion first coefficient information QF1 (QF2≠0), and the second non-zero coefficient information QF2≠0, respectively. The differential coefficient information separating unit 1220 is operative to output the non-zero conversion first coefficient information QF1 (QF2≠0) and the second non-zero coefficient information QF2≠0 to the prediction error calculating unit 1230 and the zero conversion first coefficient information QF1 (QF2=0) to the differential coefficient information zigzag scanning unit 1240.

The prediction error calculating unit 1230 is operative to generate the differential non-zero coefficient information designated in FIG. 6 by legend ΔQF on the basis of the non-zero conversion first coefficient information QF1 (QF2≠0) and the second non-zero coefficient information QF2≠0. This means that the prediction error calculating unit 1230 is operative to input the non-zero conversion first coefficient information QF1 (QF2≠0) and the second non-zero coefficient information QF2≠0 from the differential coefficient information separating unit 1220, the macroblock quantization parameter MQ1 from the demultiplexing and decoding unit 1110, and the macroblock re-quantization parameter MQ2 from the quantization controlling unit 1130 to extract differential information between the values of the non-zero conversion first coefficient information QF1 (QF2≠0) and the values of the second non-zero coefficient information QF2≠0 to generate differential non-zero coefficient information ΔQF on the basis of the values of the first coefficients of the non-zero conversion first coefficient information QF1 (QF2≠0) and the values of the second coefficients of the second non-zero coefficient information QF2≠0.

The differential coefficient information zigzag scanning unit 1240 is operative to input the zero conversion first coefficient information QF1 (QF2=0) from the differential coefficient information separating unit 1220 to extract differential information between the zero conversion first coefficient information QF1 (QF2=0) and the second zero coefficient information QF2=0 to generate differential zero coefficient information in the form of run and level. Here, the value of level indicates the value of a coefficient in a block and the value of run indicates the position of the coefficient in the block.

More specifically, the prediction error calculating unit 1230 is operative to compute a prediction error between the real non-zero conversion first coefficient information QF1 (QF2≠0) and an estimated non-zero conversion first coefficient information on the basis of the ratio of the macroblock re-quantization parameter MQ2 to the macroblock quantization parameter MQ1, the values of coefficients of the non-zero conversion first coefficient information QF1 (QF2≠0) and the values of the coefficients of the second non-zero coefficient information QF2≠0, and output the prediction error thus computed to the differential BS multiplexing and encoding unit 1290 as the differential non-zero coefficient information ΔQF. The differential non-zero coefficient information ΔQF in part constitutes lower layer information of the differential bit stream E. Here, the estimated non-zero conversion first coefficient information is estimated by the bit stream merging apparatus 2000 on the basis of the macroblock re-quantization parameter MQ2 and the macroblock quantization parameter MQ1, and the second non-zero coefficient information QF2≠0, which will be described later.

The differential non-zero coefficient information ΔQF thus generated is constituted by coefficients only and does not need to have any additional information indicating the position of the coefficients or does not need to be in the form of combination of run and level. This leads to the fact that the prediction error calculating unit 1230 can produce a small amount of information as the differential non-zero coefficient information, thereby enhancing encoding efficiency.

Furthermore, the differential coefficient information zigzag scanning unit 1240 is operative to scan the zero conversion first coefficient information QF1 (QF2=0) in a zigzag order to generate the differential zero coefficient information and output the differential zero coefficient information to the differential BS multiplexing and encoding unit 1290. The differential non-zero coefficient information generated by the prediction error calculating unit 1230 and the differential zero coefficient information generated by the differential coefficient information zigzag scanning unit 1240 collectively constitute the lower layer information of the differential bit stream E.

The differential zero coefficient information is constituted by combinations of run and level. The run is the number of consecutive zero-value coefficients, and the level is the value of a non-zero value coefficient immediately following the consecutive zero-value coefficient. The differential coefficient information zigzag scanning unit 1240 is therefore operative to eliminate zero coefficients in the zero conversion first coefficient information QF1 (QF2=0), thereby reducing the amount of information in the differential zero coefficient information.

The differential BS multiplexing and encoding unit 1290 is operative to multiplex and encode the upper layer information and the middle layer information inputted from the code mode switching unit 1120 and the lower layer information inputted from the prediction error calculating unit 1230 and the differential coefficient information zigzag scanning unit 1240 to generate the differential bit stream E to be outputted to the output terminal b4.

As will be seen from the foregoing description, it is to be understood that the transcoder 1100 thus constructed is operative to obtain a first macroblock quantization parameter MQ1 from the original bit stream A, and a second macroblock quantization parameter MQ2 from the base bit stream B, and the prediction error calculating unit 1230 is operative to input the first macroblock quantization parameter MQ1 and the second macroblock quantization parameter MQ2 from the transcoder 1100, and compute a prediction error ΔQF between the non-zero conversion first coefficient information QF1 (QF2≠0) and an estimated non-zero conversion first coefficient information QF1 (QF2≠0) on the basis of a ratio of the second macroblock quantization parameter MQ2 to the first macroblock quantization parameter MQ1, and the second non-zero coefficient information QF2≠0 wherein the first macroblock quantization parameter MQ1 is used for the quantization of each of the macroblocks contained in the original moving picture sequence signal to generate the macroblocks contained in the original bit stream A, and the second macroblock quantization parameter MQ2 is to be used for the inverse-quantization of each of the macroblocks contained in the base bit stream B.

The bit stream separating apparatus 1000 thus construct is operative to input the original bit stream A and to alternately output the base bit stream B and the differential bit stream E. Each of the original bit stream A, the base bit stream B, and the differential bit stream E has information data formed by codes. The bit stream separating apparatus 1000 is operative to alternately output the information data of the base bit stream B and the differential bit stream E. This means that the bit stream separating apparatus 1000 is operative to alternately output the codes of the base bit stream B and the differential bit stream E in response to the codes of the original bit stream A sequentially inputted. This leads to the fact that the bit stream separating apparatus 1000 is operative to alternately switch the codes to be outputted from the base bit stream B to the differential bit stream E and vice versa for every one header while outputting the upper layer codes, and for every one macroblock while outputting the middle and lower layer codes during the output operation.

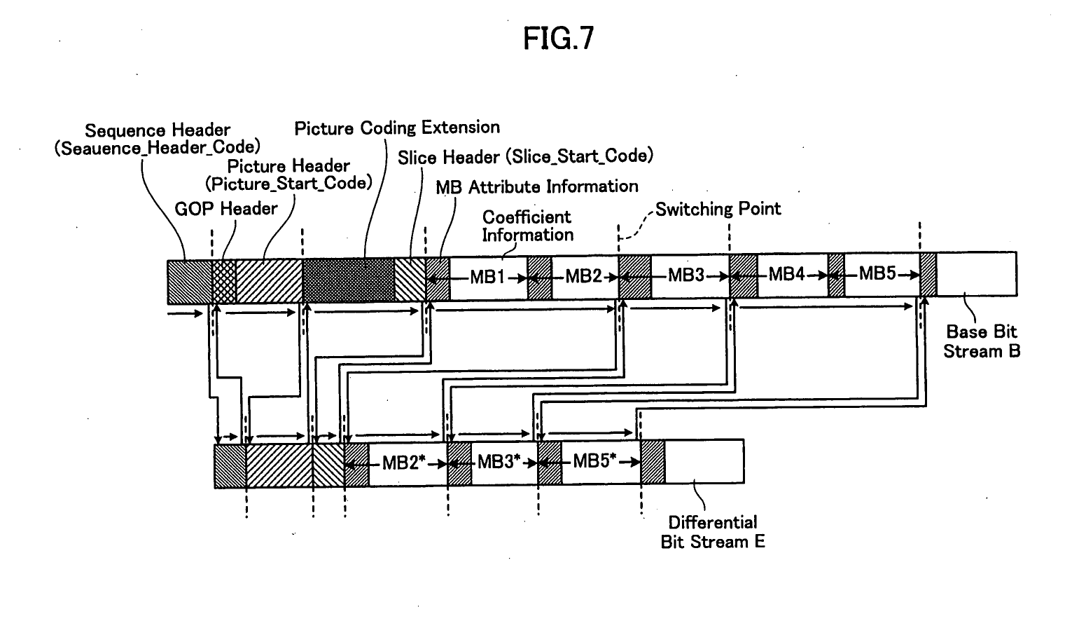

The operation of switching the base bit stream B and the differential bit stream E performed during the output operation by the bit stream separating apparatus 1000 will be described in detail hereinlater with reference to FIG. 7.

The codes of the base bit stream B and the differential bit stream E to be outputted include sequence headers, picture headers, slice headers, MB data elements, viz., MB attribute information, and block data elements, viz., coefficient information as shown in FIG. 7. The sequence headers, the picture headers, and the slice headers are referred to as “codes of the upper layer information” or “upper layer codes”. MB attribute information and coefficient information are referred to as “codes of middle layer information” and “codes of lower layer information”, or “middle layer codes” and “lower layer codes”, respectively.

With respect to the upper layer code, each of the codes of the base bit stream B correspond to each of the codes of the differential bit stream E in a one-to-one relationship, thereby making it possible for the bit stream separating apparatus 1000 to alternately output the codes of the base bit stream B and the differential bit stream E one code after another code in response to the upper layer code of the original bit stream A as designated by an arrow in FIG. 7.

This means that the bit stream separating apparatus 1000 is operated to output a sequence header Sequence Header_Code of the base bit stream B after receiving a sequence header Sequence_Header_Code of the original bit stream A, and subsequently output a sequence header Sequence Header Code of the differential bit stream E.

In a similar manner, the bit stream separating apparatus 1000 is operated to output a picture header Picture Start_Code of the differential bit stream E following a picture header Picture_Start_Code of the base bit stream B after receiving a picture header Picture Start_Code of the original bit stream A. The bit stream separating apparatus 1000 is then operated to output a slice header Slice_Start_Code of the base bit stream B after receiving a slice header Slice Start_Code of the original bit stream A, and subsequently output a slice header Slice_Start_Code of the differential bit stream E.

With respect to the middle and lower layer codes, the bit stream separating apparatus 1000 is operated to judge whether or not there is a difference between the coefficient information of the original bit stream A and that of the base bit stream B for the corresponding macroblock after the middle layer and lower layer codes of the base bit stream B is outputted. The bit stream separating apparatus 1000 is operated to sequentially output the middle layer codes and lower layer codes of the differential bit stream E when it is judged that there is a difference between the coefficient information of the original bit stream A and that of the base bit stream B for the corresponding macroblock.

While it has been described in the present embodiment that the bit stream separating apparatus 1000 comprises a transcoder 1100 and a differential bit stream generator 1200 integrated therein, the differential bit stream generator 1200 of the bit stream separating apparatus 1000 according to the present invention may be constituted by any other means as long as the differential bit stream generator 1200 can receive the original bit stream A and the base bit stream B from the transcoder 1100. This means that, for example, the differential bit stream generator 1200 may be provided separately from the transcoder 1100. In this case, the differential bit stream generator 1200 may be provided with an original bit stream inputting means for inputting therethrough an original bit stream A and a base bit stream inputting means for inputting therethrough a base bit stream B from the transcoder 1100. The original bit stream inputting means constitutes first inputting means according to the present invention, and the base bit stream inputting means constitutes second inputting means according to the present invention.

The bit stream merging apparatus 2000 is operative to input a base bit stream B and a differential bit stream E or an extended differential bit stream E* to reconstruct a pseudo original bit stream B*. The extended differential bit stream E* is generated on the basis of a partial differential information segment constituting differential bit stream E between an original bit stream A and the base bit stream B, which will be described later.

The bit stream merging apparatus 2000 is shown in FIG. 8 as comprising a second coded signal inputting means as a transcoded bit stream input terminal c1 connected to the first transmission path such as for example a network or the like, not shown, for inputting the base bit stream B therethrough, a differential bit stream input terminal c2 connected to the third transmitting path such as for example a network or the like, not shown, for inputting the extended differential bit stream E* therethrough, a BS demultiplexing and decoding unit 2110, a differential BS demultiplexing and decoding unit 2120, a code mode switching unit 2130, a coefficient information reconstructing unit 2140, a differential coefficient information reconstructing unit 2150, an adding unit 2160, a coefficient information scanning unit 2170, a multiplexing and encoding unit 2190, and an output terminal c3 connected to a forth transmission path, not shown.

The BS demultiplexing and decoding unit 2110 is operative to input the base bit stream B from the transcoded bit stream input terminal c1 to demultiplex and decode the base bit stream B into the upper layer information, the middle layer information, and the lower layer information, and output the upper layer information and the middle layer information of the base bit stream B to the code mode switching unit 2130 and the lower layer information of the base bit stream B to the coefficient information reconstructing unit 2140. The lower layer information of the base bit stream B includes coefficient information in the form of combinations of run and level.

The differential BS demultiplexing and decoding unit 2120 is operative to input the extended differential bit stream E* from the differential bit stream input terminal c2 to demultiplex and decode the extended differential bit stream E* into the upper layer information, the middle layer information, and the lower layer information, and output the upper layer information and the middle layer information of the extended differential bit stream E* to the code mode switching unit 2130 and the lower layer information of the extended differential bit stream E* to the coefficient information reconstructing unit 2140 and the differential coefficient information reconstructing unit 2150. The lower layer information of the extended differential bit stream E* includes coefficient information. The coefficient information of the extended differential bit stream E* includes non-zero coefficient information, viz., prediction error ΔQF, and zero coefficient information in the form of combinations of runs and levels as described hereinbefore.

This means that the differential BS demultiplexing and decoding unit 2120 is operative to output the differential non-zero coefficient information, viz., the prediction error ΔQF to the coefficient information reconstructing unit 2140 and the differential zero coefficient information, viz., the coefficient information in the form of run and level to the differential coefficient information reconstructing unit 2150.

The code mode switching unit 2130 is operative to input the upper layer information and the middle layer information from the BS demultiplexing and decoding unit 2110 and the differential BS demultiplexing and decoding unit 2120 to reconstruct the upper layer information and the middle layer information of the pseudo original bit stream B*, the macroblock quantization parameter MQ1, and the macroblock re-quantization parameter MQ2, and output the upper layer information and the middle layer information of the pseudo original bit stream B* thus reconstructed to the multiplexing and encoding unit 2190 and the macroblock quantization parameter MQ1 and macroblock re-quantization parameter MQ2 thus reconstructed to the coefficient information reconstructing unit 2140.

The coefficient information reconstructing unit 2140 is operative to input the lower layer information of the base bit stream B, viz., the coefficient information in the form of run and level from the BS demultiplexing and decoding unit 2110, the non-zero coefficient information of the extended differential bit stream E*, viz., the prediction error ΔQF from the differential BS demultiplexing and decoding unit 2120, and the macroblock quantization parameter MQ1 and macroblock re-quantization parameter MQ2 from the code mode switching unit 2130 to reconstruct partial non-zero coefficient information in the form of 8 by 8 matrix of coefficients and output the partial non-zero coefficient information in the form of the 8 by 8 matrix of coefficients thus reconstructed to the adding unit 2160.

The differential coefficient information reconstructing unit 2150 is operative to input the differential zero coefficient information of the extended differential bit stream E*, viz., the coefficient information in the form of run and level from the differential BS demultiplexing and decoding unit 2120 to reconstruct differential zero coefficient information in the form of 8 by 8 matrix of coefficients and output the differential zero coefficient information in the form of 8 by 8 matrix of coefficients thus reconstructed to the adding unit 2160.

The adding unit 2160 is operative to input the partial non-zero coefficient information in the form of 8 by 8 matrix of coefficients from the coefficient information reconstructing unit 2140 and the differential zero coefficient information in the form of 8 by 8 matrix of coefficients from the differential coefficient information reconstructing unit 2150 and add the differential zero coefficient information to the partial non-zero coefficient information to reconstruct coefficient information in the form of 8 by 8 matrix of coefficients and output the coefficient information in the form of 8 by 8 matrix of the coefficients thus reconstructed as coefficient information of the pseudo original bit stream B* to the coefficient information scanning unit 2170.

The coefficient information scanning unit 2170 is operative to input the reconstructed coefficient information in the form of 8 by 8 matrix of coefficients from the adding unit 2160 to scan the coefficients in a zigzag order to reconstruct one-dimensional combination of run and level as reconstructed first coefficient information, and output the reconstructed first coefficient information thus reconstructed to the multiplexing and encoding unit 2190. The reconstructed first coefficient information constitutes the lower layer information of the pseudo original bit stream B*.

The multiplexing and encoding unit 2190 is operative to input the upper layer information and the middle layer information of the pseudo original bit stream B* from the code mode switching unit 2130, and the lower layer information of the pseudo original bit stream B* from the coefficient information scanning unit 2170, multiplex and encode the upper layer information, middle layer information, and the lower layer information to reconstruct the pseudo original bit stream B*, and output the pseudo original bit stream B* thus reconstructed to the output terminal c3.

The bit stream merging apparatus 2000 thus constructed is operative to input and merge the base bit stream B and the extended differential bit stream E* to reconstruct the pseudo original bit stream B*.

The bit stream merging apparatus 2000 constitutes the coded signal merging apparatus according to the present invention. The transcoded bit stream input terminal c1 and the differential bit stream input terminal c2 constitute the second coded signal inputting means and the differential coded signal inputting means according to the present invention, respectively.

The BS demultiplexing and decoding unit 2110, the differential BS demultiplexing and decoding unit 2120, the code mode switching unit 2130, the coefficient information reconstructing unit 2140, the differential coefficient information reconstructing unit 2150, the adding unit 2160, the coefficient information scanning unit 2170, and the multiplexing and encoding unit 2190 collectively constitute a coded signal merging means according to the present invention.

The coefficient information reconstructing unit 2140 constitutes a non-zero conversion first coefficient information generating section according to the present invention. The differential coefficient information reconstructing unit 2150 and the adding unit 2160 collectively constitute a zero conversion first coefficient information generating section according to the present invention. The adding unit 2160 and the coefficient information scanning unit 2170 collectively constitute a first coefficient information merging section according to the present invention.

As will be understood from the foregoing description, the bit stream merging apparatus 2000 thus constructed is operative to input the base bit stream B and the extended differential bit stream E* to reconstruct the pseudo original bit stream B*. Each of the base bit stream B and the extended differential bit stream E* has information data formed by codes. The bit stream merging apparatus 2000 is operative to alternately input the information data of the base bit stream B and the extended differential bit stream E*. This means that the bit stream merging apparatus 2000 is operative to alternately switch the codes to be inputted from the base bit stream B to the extended differential bit stream E* and vice versa for every one header while inputting the upper layer codes, and for every one macroblock while inputting the middle and lower layer codes during the input operation.

The operation of switching the base bit stream B and the extended differential bit stream E* performed during the input operation by the bit stream merging apparatus 2000 will be described hereinlater.

With respect to the upper layer codes such as sequence headers, picture headers and slice headers, the codes of base bit stream B correspond to the codes of the extended differential bit stream E* in a one-to-one relationship, thereby making it possible for the bit stream merging apparatus 2000 to alternately input the codes of the base bit stream B and the extended differential bit stream E* one code after another code.

With respect to the middle layer codes and the lower layer codes such as MB attribute information and coefficient information, the bit stream merging apparatus 2000 is operative to judge if MB attribute information and coefficient information are provided in the macroblock of the differential bit stream E* every time when the MB attribute information and coefficient information in one macroblock of the base bit stream B is read. The bit stream merging apparatus 2000 is operative to input the MB attribute information and coefficient information in the macroblock of the extended differential bit stream E* following the corresponding MB attribute information and coefficient information of the base bit stream B in the related macroblock when it is judged that MB attribute information and coefficient information are provided in the macroblock of the extended differential bit stream E*.

While it has been described in the present embodiment that the bit stream separating apparatus 1000 and the bit stream merging apparatus 2000 are provided separately, the bit stream separating apparatus 1000 and the bit stream merging apparatus 2000 according to the present invention, on the other hand, may be integrated to a single system which enables to separate an original bit stream A into a base bit stream B and one or more extended differential bit streams E* and merge the base bit stream B or pseudo original bit stream Bᵢ₋₁ and the extended differential bit streams E* into a pseudo original bit stream Bi.

The major constructions and functions of the bit stream separating apparatus 1000 and the bit stream merging apparatus 2000 according to the present invention have thus far been described.

As described hereinearlier, the bit stream separating apparatus 1000 is operative to input the original bit stream A from the MPEG encoder 600 through a first transmission path, not shown, to generate a base bit stream B, and a plurality of extended differential bit streams E1 to En respectively on the basis of a plurality of partial differential information segments constituting the differential bit stream E between the original bit stream A and the base bit stream B, and the bit stream merging apparatus 2000 is operative to merge the base bit stream B or the pseudo original bit stream Bᵢ₋₁ with the extended differential bit stream Ei to reconstruct the pseudo original bit stream Bi.

The process of separating the original bit stream A to generate the base bit stream B and a plurality of extended differential bit streams E1 to En, and the process of merging the base bit stream B or the pseudo original bit stream Bᵢ₋₁ with the extended differential bit stream Ei to reconstruct a pseudo original bit stream Bi are similar to the process of separating the original bit stream A to generate the base bit stream B and the differential bit stream E, and the process of merging the base bit stream B and the differential bit stream E to reconstruct the original bit stream A disclosed in U.S. patent application Ser. No. 931,038, filed Aug. 17, 2001, by the same applicant.

The differential bit stream generator 1200 is operative to generate the extended differential bit stream E* in accordance with the hierarchical structure. Similar to the differential bit stream E, the extended differential bit stream E* thus generated is in the form of the hierarchical structure including one or more sequence layers, one or more picture layers, one or more slice layers, one or more macroblock layers, and one or more block layers.

With respect to the upper layer and the middle layer, the process of separating the original bit stream A to generate the base bit stream B and a plurality of extended differential bit streams E1 to En, and the process of merging the base bit stream B or the pseudo original bit stream Bᵢ₋₁ with the extended differential bit stream Ei to reconstruct the pseudo original bit stream Bi are similar to the process of separating the original bit stream A to generate the base bit stream B and the differential bit stream E, and the process of merging the base bit stream B and the differential bit stream E to reconstruct the original bit stream A, and will be thus omitted from the later description for avoiding tedious repetition.

The process of separating the original bit stream A to generate the base bit stream B and a plurality of extended differential bit streams E1 to En, and the process of merging the base bit stream B or the pseudo original bit stream Bᵢ₋₁ and the extended differential bit stream Ei to reconstruct the pseudo original bit stream Bi with respect to the lower layer will be described in detail hereinlater.

The block layer of the extended differential bit stream Ei includes partial differential coefficient information between the pseudo original bit stream Bᵢ₋₁ and the pseudo original bit stream Bi. The pseudo original bit stream Bᵢ₋₁ and the pseudo original bit stream Bi will be hereinlater referred to as a first bit stream B1 and a second bit stream B2 for simplicity and better understanding.

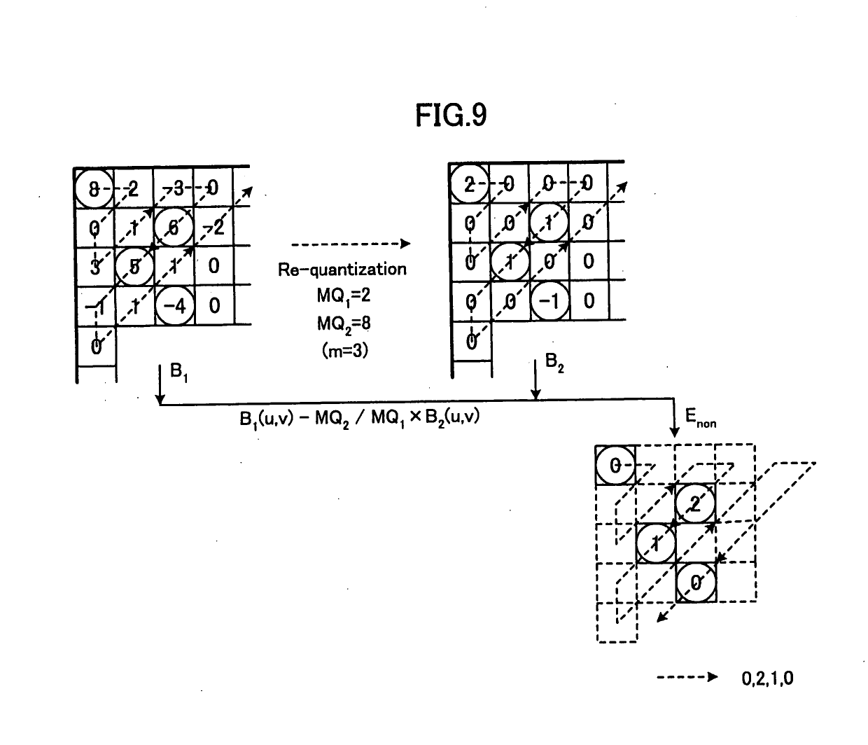

The principle of generating a partial differential coefficient information segment will be described hereinlater with reference to FIG. 9. In FIG. 9, a coefficient forming part of a block layer of a first bit stream B1 is designated by legend “B₁ (u, v)”, and a coefficient forming part of the corresponding block layer of a second bit stream B2 is designated by legend “B2 (u, v)”.

As described hereinearlier, the coefficient information includes zero coefficients (whose values are equal to zero) and non-zero coefficients (whose values are not equal to zero). Coefficients in the first bit stream B1 to be converted to zero coefficients in the second bit stream B2, referred to as zero conversion first coefficients, and coefficients in the first bit stream B1 to be converted to non-zero coefficients in the second bit stream B2, referred to as non-zero conversion first coefficients are processed differently.

With respect to the non-zero conversion first coefficients of the first bit stream B1, partial non-zero coefficient information constituted by partial non-zero coefficient designated in FIG. 9 by Enon (u, v) is calculated on the basis of the difference between the coefficients B1 (u, v) forming part of each of block layers of the first bit stream B1, coefficients B2 (u, v) forming part of each of block layers of the second bit stream B2, the quantization parameter MQ1 and the re-quantization parameter MQ2 in accordance with the following equation in the manner as disclosed in the aforementioned U.S. patent application Ser. No. 931,038.

$$Enon ( u , v ) = B1 ( u , v ) - \frac{MQ2}{MQ1} \times B2 ( u , v ) .$$

With respect to the zero conversion first coefficients of the first bit stream B1, the differential coefficient information zigzag scanning unit 1240 of the differential bit stream generator 1200 is operative to input the zero conversion first coefficient information QF1 (QF2=0) from the differential coefficient information separating unit 1220 to generate a plurality of partial differential zero coefficient information segments Ezero-1 to Ezero-n in the form of run and level. As described in the above, a plurality of extended differential bit streams E1 to En are respectively generated on the basis of a plurality of partial differential information segments. Each of partial differential information segments is generated on the basis of the basis of the partial non-zero coefficient information Enon and each of the partial differential zero coefficient information segments Ezero-i in a manner as described hereinlater. The coefficient B2 (u, v) is obtained as a result of inverse-quantizing and re-quantizing the coefficient B1 (u, v) with a quantization parameter MQ1 and a re-quantization parameter MQ2. The re-quantization parameter MQ2 is calculated on the basis of the quantization parameter MQ1 and an integer m, which is disclosed in the aforementioned U.S. patent application Ser. No. 931,038.

The differential bit stream generator 1200 is operative to compute a re-quantization parameter MQ2 in accordance with Equations (1) and (2) as follows:

intra-picture

$$MQ2 ( MQ1 , m ) = \{ \begin{matrix}MQ1 & ( m = 0 ) \\ 2 m \times MQ1 + 1 & ( m \neq 0 )\end{matrix} \qquad Equation ( 1 )$$

inter-picture
MQ2(MQ1,m)=(m+1)×MQ1 Equation (2)

It is hereinlater assumed that m is not equal to zero, and coefficients forming part of a block of the second bit stream B2 generated as a result of re-quantizing coefficients forming part of the related block of the first bit stream B1 with the re-quantization parameter MQ2 (m) and MQ2 (m−1) are respectively referred to as B2₍ₘ₎ (u, v) and B2₍ₘ₋₁₎ (u, v) to examine distributions of non-zero coefficients contained in the blocks respectively formed by the coefficients B2₍ₘ₎ (u, v) and B2₍ₘ₋₁₎ (u, v) in relationship with non-zero coefficients contained in the related block formed by the coefficient B1 (u, v).

For B1 (u, v) whose absolute value is equal to or less than m, the value of B2 (u, v) is equal to zero.

For B1 (u, v) whose absolute value is greater than m, the absolute value of B2 (u, v) is grater than zero but less than the absolute value of B1 (u, v).

This leads to the fact that the value of B2₍ₘ₎ (u, v) can be obtained in accordance with the following equation (3).

$$\{ \begin{matrix}\vert B1 ( u , v ) \vert > m ⇔ 0 < & \vert {B2}_{( m )} ( u , v ) \vert < \vert B1 ( u , v ) \vert \\ \vert B1 ( u , v ) \vert \leq m ⇔ & \vert {B2}_{( m )} ( u , v ) \vert = 0\end{matrix} \qquad Equation ( 3 )$$

Similarly, the value of B2₍ₘ₋₁₎ (u, v) can be obtained in accordance with the following equation (4).

$$\begin{matrix}\{ \begin{matrix}\vert B1 ( u , v ) \vert > m - 1 ⇔ 0 < & \vert {B2}_{( m - 1 )} ( u , v ) \vert < \vert B1 ( u , v ) \vert \\ \vert B1 ( u , v ) \vert \leq m - 1 ⇔ & \vert {B2}_{( m - 1 )} ( u , v ) \vert = 0\end{matrix} & Equation ( 4 )\end{matrix}$$

Then, a block formed by coefficient B2^{#} (u, v) whose absolute value is equal to m when the absolute value of B1 (u, v) of the related block is equal to m is defined as follows.

$${B2}^{\#} ( u , v ) = \{ \begin{matrix}B1 ( u , v ) & for & \vert B1 ( u , v ) \vert = m \\ B2 ( u , v ) & for & \vert B1 ( u , v ) \vert \neq m\end{matrix} \qquad Equation ( 5 )$$

As assumed hereinearlier, m is not equal to zero. The relationship between B2^{#} (u, v) and B1 (u, v) is therefore derived from the equation (3) and the equation (5) and represented by the expression as follows.

$$\{ \begin{matrix}\vert B1 ( u , v ) \vert > m ⇔ 0 < & \vert {B2}^{\#} ( u , v ) \vert < \vert B1 ( u , v ) \vert \\ \vert B1 ( u , v ) \vert = m ⇔ 0 < & \vert {B2}^{\#} ( u , v ) \vert = m \\ \vert B1 ( u , v ) \vert < m ⇔ & \vert {B2}^{\#} ( u , v ) \vert = 0\end{matrix} \qquad Equation ( 6 )$$

Non-zero coefficient B2^{#} (u, v) whose value is not equal to 0 is therefore derived from the equation (6) and represented by the expression as follows.

$$\{ \begin{matrix}\vert B1 ( u , v ) \vert \geq m ⇔ 0 < & \vert {B2}^{\#} ( u , v ) \vert \leq \vert B1 ( u , v ) \vert \\ \vert B1 ( u , v ) \vert < m ⇔ & \vert {B2}^{\#} ( u , v ) \vert = 0\end{matrix} \qquad Equation ( 7 )$$

Furthermore, since m is an integer, the equation (7) is expressed as follows.

$$\{ \begin{matrix}\vert B1 ( u , v ) \vert > m - 1 ⇔ 0 < & \vert {B2}^{\#} ( u , v ) \vert < \vert B1 ( u , v ) \vert \\ \vert B1 ( u , v ) \vert \leq m - 1 ⇔ & \vert {B2}^{\#} ( u , v ) \vert = 0\end{matrix} \qquad Equation ( 8 )$$

The above equation (4) and the equation (8) leads to the fact that the B2₍ₘ₋₁₎ (u, v) and the condition that B2^{#} (u, v) are not equal to 0 under the condition that |B1(u, v)|>m−1, and B2₍ₘ₋₁₎ (u, v) and B2^{#} (u, v) are equal to 0 under the condition that |B1(u,v)|≦m−1.

This means that the coefficients B1 (u, v) whose absolute values are equal to or less than (m−1) correspond to the zero coefficients forming part of the related blocks respectively represented by B2₍ₘ₋₁₎ (u, v) and B2^{#} (u, v), and the coefficients B1 (u, v) whose absolute values are greater than (m−1) correspond to the non-zero coefficients forming part of the related blocks respectively represented by B2₍ₘ₋₁₎ (u, v) and B2^{#} (u, v). The fact that the distribution of non-zero coefficients in the block represented by B2₍ₘ₋₁₎ (u, v) matches with that of non-zero coefficients in the block represented by B2^{#} (u, v) with respect to the coefficients B1 (u, v) in the related block leads to the fact that the block represented by B2₍ₘ₋₁₎ (u, v) and the block represented by B2^{#} (u, v) share the same run-length information, thereby resulting in the fact that the coefficients whose absolute values are equal to or less than m forming part of a block in the first bit stream B1 correspond to the zero coefficients forming part of the related blocks respectively represented by B2₍ₘ₋₁₎ (u, v) and B2^{#} (u, v).

In the differential bit stream generator 1200 according to the present invention, the prediction error calculating unit 1230 is operative to input the coefficients of the non-zero conversion first coefficient information represented by Bi (u, v) whose absolute values are greater than m, and the coefficients of the second non-zero coefficient information represented by B2 (u, v) whose absolute values are not equal to zero, to generate the differential non-zero coefficient information ΔQF in the same manner as disclosed in U.S. patent application Ser. No. 931,038 and will be thus omitted from description for avoiding tedious repetition.

The differential coefficient information zigzag scanning unit 1240 of the differential bit stream generator 1200 according to the present invention, on the other hand, is operative to input the zero conversion first coefficient information represented by B1 (u, v) whose absolute value is equal to or less than m from the differential coefficient information separating unit 1220 to extract differential information between the zero conversion first coefficient information represented by B1 (u, v) whose absolute value is equal to or less than m, and the second zero coefficient information represented by B2 (u, v) whose value is equal to zero to generate differential zero coefficient information in the form of run and level.

As will be understood from the above, the differential coefficient information zigzag scanning unit 1240 of the differential bit stream generator 1200 according to the present invention can extract differential information between the zero conversion first coefficient information represented by B1 (u, v) whose absolute value is equal to or less than m and equal to or greater than (m−n), and the second zero coefficient information represented by B2 whose absolute value is equal to zero to generate a differential zero coefficient information group in the form of run and level, which is indicative of non-zero coefficients contained in a block sharing the same run-length information with non-zero coefficients contained in the related block represented by B2₍ₘ₋ₙ₎, wherein n is an integer, and 0≦n<m. This means that the differential coefficient information zigzag scanning unit 1240 can generate m units of differential zero coefficient information groups in the form of run and level for 1, 2, . . . m with respect to the coefficients B2 (u, v) whose values are equal to zero. This leads to the fact that the differential coefficient information zigzag scanning unit 1240 can generate a plurality of differential zero coefficient information groups in the form of run and level each for one of the values of the zero conversion first coefficients, viz., 1, 2, . . . m with respect to the coefficients B2 (u, v) whose values are equal to zero.

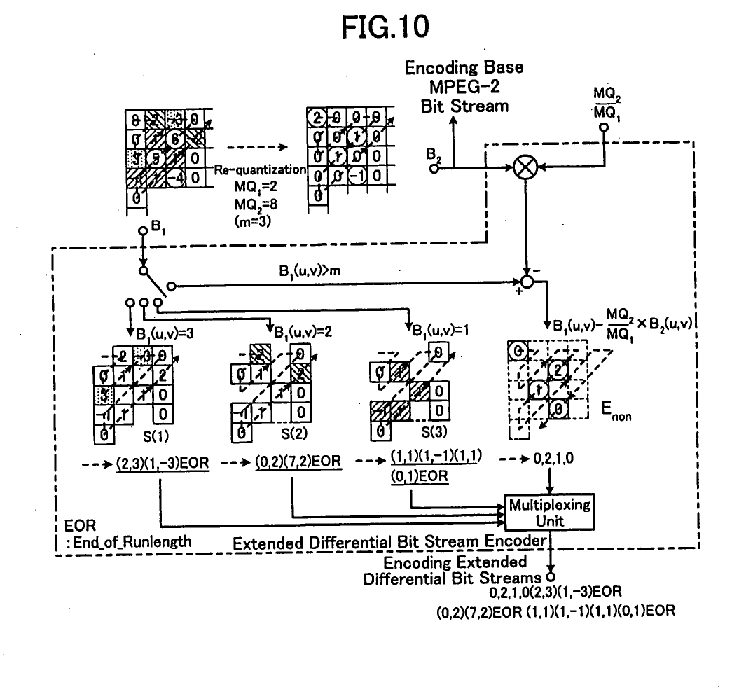

The description hereinlater will be directed to the operation performed by the differential coefficient information zigzag scanning unit 1240 in detail hereinlater with reference to FIGS. 10, 11, and 12.

As shown in FIG. 10, the differential coefficient information zigzag scanning unit 1240 is operative to extract differential information between the coefficient B1 (u, v) whose absolute value is equal to or less than m and the coefficient B2 (u, v) whose absolute value is equal to zero to generate a differential zero coefficient information group in the form of run and level for each of the values of the coefficients B1 (u, v) equal to or less than m. This means that the differential coefficient information zigzag scanning unit 1240 is operative to generate at least m units of differential zero coefficient information groups in the form of run and level for 1, 2, . . . m.

The differential coefficient information zigzag scanning unit 1240 is operative to count the number of the coefficients B1 (u, v) whose absolute value is less than level as a run-length in a zigzag order while generating each of differential zero coefficient information groups. This means that the differential coefficient information zigzag scanning unit 1240 is operative to count the number of the coefficients B1 (u, v) in a zigzag order for B1 (u, v)=0 and B1 (u, v)=1 for level=2 as shown in FIG. 10.

A principle of encoding process performed by the differential coefficient information zigzag scanning unit 1240 will be described hereinlater.

Step 1.

The differential coefficient information zigzag scanning unit 1240 is operated to scan a coefficient B1 (u, v) in a zigzag order, and judge whether or not the value of the coefficient B1 (u, v) is less than the value of level.

When it is judged that the value of the coefficient B1 (u, v) is less than the value of level, the step 1 goes forward to the step 2-1. When it is, on the other hand, judged that the value of the coefficient B1 (u, v) is greater than the value of level, the step 1 goes forward to the step 2-2. When it is judged that the value of the coefficient B1 (u, v) is equal to the value of level, the step 1 goes forward to the step 2-3.

Step 2-1. B1(u,v)<Level

The differential coefficient information zigzag scanning unit 1240 is provided with a run-length counter for counting a run-length, and is operated to increment the run-length counter by one. Then, the step 2-1 goes forward to the step 3.

Step 2-2. Bi (u, v)>Level

The step 2-2 goes forward to the step 3.

Step 2-3. B1 (u, v)=Level

The differential coefficient information zigzag scanning unit 1240 is operated to generate run-level information includes run and level, and variable-length encode the run-level information wherein run is indicative of the number of consecutive coefficients less than level, and counted by the run-level counter.

The differential coefficient information zigzag scanning unit 1240 is then operated to reset the run-length counter at zero. The step 2-3 goes forward to the step 3.

Step 3.

The differential coefficient information zigzag scanning unit 1240 is operated to judge whether or not the coefficient B1 (u, v) is the last coefficient in the block. When it is judged that the coefficient B1 (u, v) is the last coefficient in the block, the differential coefficient information zigzag scanning unit 1240 is operated to encode a code End_of_Runlength indicating the end of the run-level string. Then, the step 3 goes forward to the step 4. When it is, on the other hand, judged that the coefficient B1 (u, v) is not the last coefficient in the block, the current scanning position (u, v) is set at a subsequent scanning position in a zigzag order as shown in FIG. 10, and the step 3 goes back to the step 1.

Step 4

The differential coefficient information zigzag scanning unit 1240 is operated to judge whether or not level is equal to max_level (maximum value=m). When it is judged that level is equal to max_level, the step 4 goes to end. When it is, on the other hand, judged that level is not equal to max level, the differential coefficient information zigzag scanning unit 1240 is operated to increment level by one, and reset the scanning position (u, v) at (0, 0). The step 4 goes back to the step 1.

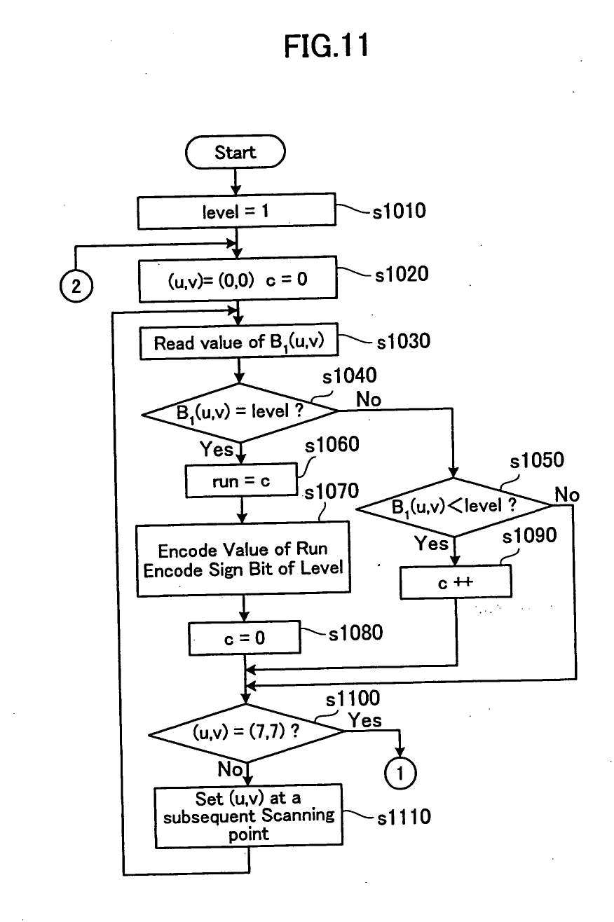

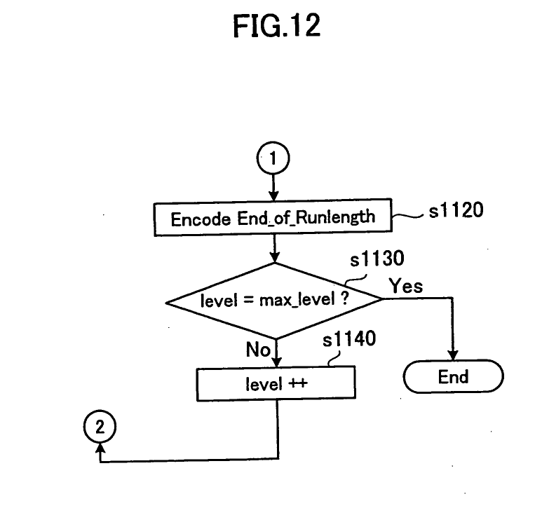

Referring then to FIGS. 11 and 12 of the drawings, there is shown a flowchart showing the flow of encoding a differential coefficient information segment performed by the preferred embodiment of the bit stream separating apparatus 1000.

In the step S1010, the value of level is set at one. The step S1010 goes forward to the step S1020, in which the current scanning position (u, v) is initialized at (0, 0), and a value c counted by the run-level counter is initialized at 0. The step S1020 goes forward to the step S1030, in which the value of the coefficient B1 (u, v) is read. The step S1030 goes forward to the step S1040, in which it is judged weather or not the value of the coefficient B1 (u, v) is equal to the value of level. When it is judged that the value of the coefficient B1 (u, v) is equal to the value of level, the step S1040 goes forward to the step S1060. When it is, on the other hand, judged that the value of the coefficient B1 (u, v) is not equal to the value of level, the step S1040 goes forward to the step S1050.

In the step S1060, the value of run is set at the value c counted by the run-length counter and run-level information is generated. The step S1060 goes forward to the step S1070, in which the value of run and the sign bit of level are encoded and the run-level information is thus encoded. The step S1070 goes forward to the step S1080, in which the value c counted by the run-length counter is reset at zero. The step S1080 goes forward to the step S1100.

In the step S1050, it is judged weather or not the value of the coefficient B1 (u, v) is less than the value of level. When it is judged that the value of the coefficient B1 (u, v) is less than the value of level, the step S1050 goes forward to the step S1090. When it is, on the other hand, judged that the value of the coefficient B1 (u, v) is not less than the value of level, the step S1050 goes forward to the step S100. In the step S1090, the value c counted by the run-level counter is incremented by one. The step S1090 goes forward to the step S1100.

In the step S1100, it is judged whether or not the current scanning position (u, v) is the position (7, 7). The position (7, 7) is intended to indicate the last coefficient in the block. When it is judged that the current scanning position (u, v) is the position (7, 7), the step S1100 goes forward to the step S1120. When it is, on the other hand, judged that the current scanning position (u, v) is not position (7, 7), the step S1100 goes forward to the step S1110, in which the current scanning position (u, v) is set at a subsequent scanning position in a zigzag order as shown in FIG. 9. The step S1110 goes back to the step S1030.

In the step S1120, End_of_Runlength is encoded. End_of_Runlength is a code indicating the end of the run-level string. The step S1120 goes forward to the step S1130, in which it is judged whether or not the value of level is equal to max_level max_level is intended to mean the maximum value of level. When it is judged that level is not equal to max_level, the step S1130 goes forward to the step S1140, in which the value of level is incremented by one. The step S1140 goes back to the step S1020. When it is judged that the value of level is equal to max_level, the step S1130 goes to END.

The description hereinlater will be directed to a concrete example of the flow of encoding a differential coefficient information segment performed by the differential coefficient information zigzag scanning unit 1240 with reference to FIGS. 9, 10, 11, and 12. It is hereinlater assumed that MQ1 is equal to two, MQ2 is equal to eight, and m is equal to three as shown in FIG. 10.

The following relationship is derived by substituting m being equal to three into the equation (3).
|B1(u,v)|≦3 [symbol] |B2(u,v)|=0

This leads to the fact that the differential coefficient information zigzag scanning unit 1240 is operative to scan the coefficient B1(u, v) whose absolute value is equal to or less than three in zigzag order, and generate a plurality of differential zero coefficient information groups designated by S(1), S(2), and S(3) in FIG. 10 in the form of run-level strings respectively for B1 (u, v) whose absolute value is equal to three, B1 (u, v) whose absolute value is equal to two, and B1 (u, v) whose absolute value is equal to one. The partial differential zero coefficient information segments Ezero are respectively constituted by differential zero coefficient information groups S(1), S(2), and S(3).

In the step S1010, the value of level is set at one. The step S1010 goes forward to the step S1020, in which (u, v) is initialized at (0, 0), and the value c counted by the run-level counter is initialized at 0. The step S1020 goes forward to the step S1030, in which the value of B1 (0, 0) is read. As shown in FIG. 10, the value of B1 (0, 0) is equal to 8. The step S1030 goes forward to the step S1040, in which it is judged that the value of B1 (0, 0) is not equal to the value of level. The step S1040 goes forward to the step S1050, in which it is judged that the value of B1 (0, 0) is not less than the value of level. The step S1050 goes forward to the step S1100. In the step S1100, it is judged that the current scanning position (0, 0) is not the position (7, 7). The step S1100 goes forward to the step S1110, in which the current scanning position (0, 0) is set at a subsequent scanning position (0, 1) in a zigzag order as shown in FIG. 10.

The step S1110 goes back to the step S1130, in which the value of (0, 1) is read. As shown in FIG. 10, the value of B1 (0, 1) is equal to 2. The step S1030 goes forward to the step S1040, in which it is judged that the value of B1 (0, 1) is not equal to the value of level. The step S1040 goes forward to the step S1050, in which it is judged that the value of B1 (0, 0) is not less than the value of level. The step S1050 goes forward to the step S1100. In the step S1100, it is judged that the current scanning position (0, 1) is not the position (7, 7). The step S1100 goes forward to the step S1110, in which the current scanning position (0, 1) is set at a subsequent scanning position (1, 0) in the zigzag order. In this manner the differential coefficient information zigzag scanning unit 1240 is operative to scan the coefficient B1 (u, v) in zigzag order.

While the differential coefficient information zigzag scanning unit 1240 is scanning the coefficient B1 (1, 0) whose absolute value is equal to zero, the value c counted by the run-length counter is incremented by one in the step S1090. While the differential coefficient information zigzag scanning unit 1240 is scanning the coefficient B1(1, 1) whose absolute value is equal to one, it is judged that the value of B1 (1, 1) is equal to the value of level in the step S1040, run is set at the value c counted by the run-length counter, which is equal to one, and run-level information being (1, 1) is generated in the step S1060, the run-level information is thus encoded in the step S1070, and the run-length counter is reset at zero in the step S1080.

In this manner, the differential coefficient information zigzag scanning unit 1240 is operative to scan the coefficient B1(u, v) in zigzag order, and generate a differential zero coefficient information group S(3) in the form of the run-level string for B1 (u, v) whose absolute value is equal to one as shown in FIG. 10.

When it is judged that the current scanning position (u, v) is the position (7, 7) in the step S1100, the step S1100 goes forward to the step S1120, in which End_of_Runlength is encoded. Thus, the differential zero coefficient information group S(3) for B1 (u, v) whose absolute value is equal to one is generated in the form of the run-level string (1, 1) (1, −1) (1, 1) (0, 1) EOR as shown in FIG. 10. Here, EOR (End_of_Runglength) is intended to mean the end of the run-level string.

Then, the value of level is set at two in the step S1140, the scanning position (u, v) is initialized at (0, 0), and the value c counted by run-level counter is initialized at 0 in the step S1020.

While the differential coefficient information zigzag scanning unit 1240 is scanning the coefficients, B1 (1, 0), B1 (0, 3), and B1 (0, 4) whose values are equal to zero, and the coefficients B1(1, 1), B1(0, 3), B1(1, 3), and B1(2, 2) whose absolute values are equal to one, the value c counted by the run-length counter is incremented by one in the step S1090.

While the differential coefficient information zigzag scanning unit 1240 is scanning the coefficients B1 (0, 1) and B1 (1, 3) whose absolute values are equal to two, it is judged that the value of B1 is equal to the value of level in the step S1040, the value of run is set at the value c counted by the run-length counter, and run-level information is generated in the step S1060, and the run-level information is thus encoded in the step S1070.

The differential zero coefficient information group S(2) for B1 (u, v) whose absolute value is equal to two is thus generated in the form of the run-level string (0, 2) (7, 2) EOR as shown in FIG. 10.

For level whose absolute value is three, the similar manner is performed as described above, and the differential zero coefficient information group S(1) for B1 (u, v) whose absolute value is equal to three is generated in the form of the run-level string (2, 3) (1, −3) EOR as shown in FIG. 10.

The run-level strings thus generated are delimited with the codes of End_of_Runglength, thereby making it possible for the value of level to be calculated on the basis of the order of the run-level strings and the frequency of the appearance of the codes of End_of_Runglength when the run-level strings are to be decoded. In the differential bit stream generator 1200 according to the present invention, the value of run and the sign bit of level are encoded but the value of level is not encoded in order to reduce the number of codes generated while encoding the run-level information. This results in the fact that only the value of run and the sign bit of level are encoded while encoding the run-level information in the step S1070.

In the bit stream separating apparatus 1000 according to the present invention, the differential coefficient information zigzag scanning unit 1240 is operative to extract differential information between the zero conversion first coefficient information QF1 (QF2=0) and the second zero coefficient information QF2=0 for each of the values of the zero conversion first coefficients, for example, one, two, and three, to generate a plurality of differential zero coefficient information groups in the form of run and level, each for one of the values of the zero conversion first coefficients, viz., one, two, and three, and the differential bit stream generator 1200 is operative to generate a plurality of extended differential coded moving picture sequence signals in the form of extended differential bit streams E1, E2, and E3 respectively on the basis of a plurality of partial differential information segments constituting the differential bit stream E wherein the partial differential information segments respectively have the plurality of differential zero coefficient information groups S(1), S(2), and S(3). The values of the zero conversion first coefficients, which are equal to or less than three and greater than zero in the present embodiment, can be derived, and determined in accordance with the equation (3). The differential coefficient information zigzag scanning unit 1240 of the bit stream separating apparatus 1000 thus constructed can generate a plurality of differential zero coefficient information groups S(1), S(2), and S(3) in the form of run and level merely on the basis of the zero conversion first coefficient information QF1 (QF2=0), and eliminate the need of having inputted therein the second coefficient information QF2, thereby being simple in operation.

Furthermore, in the bit stream separating apparatus 1000 according to the present invention, the differential coefficient information zigzag scanning unit 1240 is operative to generate a plurality of differential zero coefficient information groups S(1), S(2), and S(3) in the form of run and level in decreasing order of the values of the zero conversion first coefficients, for example, 3, 2, and 1, and delimit adjacent two differential zero coefficient information groups S(1), S(2), and S(3) with a coefficient end code, viz., EOR. According to the present invention, the differential coefficient information zigzag scanning unit 1240 is operative to generate a plurality of differential zero coefficient information groups S(1), S(2), and S(3), each of which includes only position indicators, viz., runs indicating positions of the values, viz., levels because of the fact that the values of the zero conversion first coefficients viz. levels can be estimated in decreasing order. In the present embodiment, the differential coefficient information zigzag scanning unit 1240 is operated to output 0, 2, 1, 0 (2, *) (1, −*) EOR (0, *)(7, *) EOR (1, *)(1, −*)(1, *)(0, *)EOR, which is indicative of 0, 2, 1, 0 (2, 3) (1, −3) EOR (0, 2)(7, 2) EOR(1, 1)(1, −1)(1, 1)(0, 1)EOR as shown in FIG. 10. The differential coefficient information zigzag scanning unit 1240 of the bit stream separating apparatus 1000 thus constructed can generate the plurality of differential zero coefficient information groups S(1), S(2), and S(3) in the form of run and level in decreasing order of the values of the zero conversion first coefficients, viz., three, two, and one wherein each of differential zero coefficient information groups S(1), S(2), and S(3) includes only position indicators, viz., runs indicating positions of the values, viz., levels because of the fact that the values of the zero conversion first coefficients viz. levels can be estimated in decreasing order. This leads to the fact that the differential coefficient information zigzag scanning unit 1240 of the bit stream separating apparatus 1000 thus constructed can eliminate the need of encoding levels, thereby being simple in operation.

Furthermore, in the bit stream separating apparatus 1000 according to the differential coefficient information zigzag scanning unit 1240 is operative to judge whether or not each of the values of the zero conversion first coefficients is less than a predetermined threshold value. The predetermined threshold value can be determined, for example, in accordance with the equation (3). In the present embodiment, the predetermined threshold value is equal to four. The differential coefficient information zigzag scanning unit 1240 is then operative to extract the differential information between the zero conversion first coefficient information QF1 (QF2=0) and the second zero coefficient information QF2=0 for each of the values of the zero conversion first coefficients judged as being less than the threshold value. In the present embodiment, the differential coefficient information zigzag scanning unit 1240 is then operative to extract the differential information between the zero conversion first coefficient information QF1 (QF2=0) and the second zero coefficient information QF2=0 for one, two, and three. The differential coefficient information zigzag scanning unit 1240 is then operative to generate the plurality of differential zero coefficient information groups S(1), S(2), and S(3) in the form of run and level in decreasing order of the values of the zero conversion first coefficients judged as being less than respective threshold values, viz., three, two, and one wherein each of differential zero coefficient information groups S(1), S(2), and S(3) in the form of run and level includes position indicators, viz., run indicating positions of the values, viz., level. In the present embodiment, the differential coefficient information zigzag scanning unit 1240 is operated to output 0, 2, 1, 0 (2, *) (1, −*) EOR (0, *)(7, *) EOR (1, *)(1, −*)(1, *)(0, *)EOR, which is indicative of 0, 2, 1, 0 (2, 3) (1, −3) EOR (0, 2)(7, 2) EOR(1, 1)(1, −1)(1, 1)(0, 1)EOR as shown in FIG. 10. The differential coefficient information zigzag scanning unit 1240 of the bit stream separating apparatus 1000 thus constructed can generate the plurality of differential zero coefficient information groups S(1), S(2), and S(3) in the form of run and level in decreasing order of the values of the zero conversion first coefficients, viz., three, two, and one wherein each of differential zero coefficient information groups S(1), S(2), and S(3) includes only position indicators, viz., runs indicating positions of the values, viz., levels because of the fact that the values of the zero conversion first coefficients viz. levels can be estimated in decreasing order. This leads to the fact that the differential coefficient information zigzag scanning unit 1240 of the bit stream separating apparatus 1000 thus constructed can eliminate the need of encoding levels, thereby being simple in operation.

The process of separating the original bit stream A to generate the base bit stream B and a plurality of extended differential bit streams E1 to En has thus far been described.

The process of merging the base bit stream B2 with one or more extended differential bit streams E1 to En to reconstruct the pseudo original bit stream B1* with respect to the lower layer will be described in detail hereinlater.

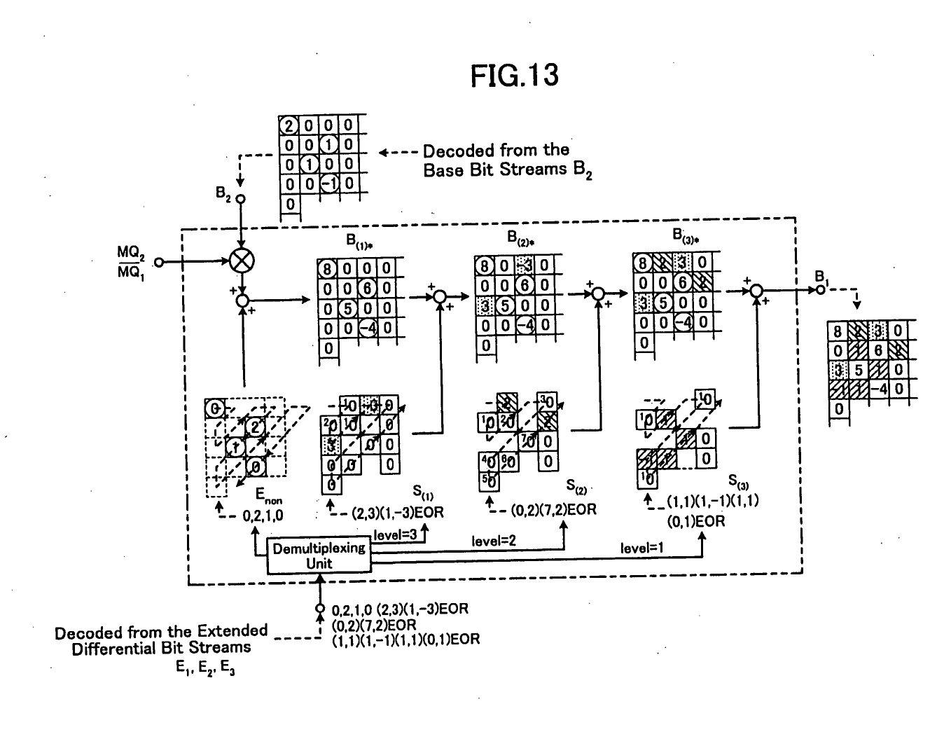

The principle of merging the second bit stream B2 with one or more extended differential bit streams E1 to En will be described hereinlater with reference to FIG. 13. In FIG. 13, a coefficient forming part of a block layer of a first bit stream Bi is referred to as “B₁ (u, v)”, a coefficient forming part of the corresponding block layer of a second bit stream B2 is referred to as “B2 (u, v)”, and a coefficient forming part of the corresponding block layer of a pseudo original bit stream B1* is referred to as “B1* (u, v)”. Here, the first bit stream B1 is intended to mean the base bit stream B1 and the second bit stream B2 is intended to mean the original bit stream B1. The second bit stream B2 and the extended differential bit streams E1 to En have been generated in a manner as described in the hereinabove. It is assumed hereinlater that the second bit stream B2 is merged with one or more extended differential bit streams E1, E2, and E3 for simplicity and better understanding.

With respect to the second non-zero coefficients of the second bit stream B2, the coefficient information reconstructing unit 2140 is operative to reconstruct partial non-zero coefficient information Enon in the form of 8 by 8 matrix of coefficients in the manner as disclosed in the aforementioned U.S. patent application Ser. No. 931,038. The process of reconstructing partial non-zero coefficient information Enon in the form of 8 by 8 matrix of coefficients will be thus omitted from the later description.

With respect to the second zero coefficients of the second bit stream B2, the differential coefficient information reconstructing unit 2150 is operative to input the differential zero coefficient information of each of the extended differential bit streams E1 to E3, viz., the differential zero coefficient information groups in the form of the coefficient information run and level to reconstruct differential zero coefficient information designated by S(1), S(2), and S(3) in FIG. 13 in the form of 8 by 8 matrix of coefficients. The adding unit 2160 is operative to add the differential zero coefficient information S(1), S(2), and S(3) in the form of 8 by 8 matrix of coefficients inputted from the differential coefficient information reconstructing unit 2150 to the partial non-zero coefficient information Enon in the form of 8 by 8 matrix of coefficients inputted from the coefficient information reconstructing unit 2140 to reconstruct coefficient information in the form of 8 by 8 matrix of coefficients constituting a reconstructed original bit stream B1. The reconstructing process of adding the differential zero coefficient information S(1), S(2), and S(3) in the form of 8 by 8 matrix of coefficients to the partial non-zero coefficient information Enon in the form of 8 by 8 matrix of coefficients to reconstruct coefficient information in the form of 8 by 8 matrix of coefficients constituting a pseudo original bit stream B1* will be described hereinlater.

As shown in FIG. 13, the differential coefficient information reconstructing unit 2150 is operative to reconstruct the differential zero coefficient information groups S(1), S(2) and S(3) in the form of combinations of run and level (run, level) in decreasing order of the value of level. This means that the differential coefficient information reconstructing unit 2150 is operative to reconstruct the differential zero coefficient information group S(1) for level whose absolute value is three, the differential zero coefficient information group S(2) for level whose absolute value is two, and the differential zero coefficient information group S(3) for level whose absolute value is one. As described hereinearlier, the value of level indicates the value of a coefficient in a block and the value of run indicates the position of the coefficient in the block.

A principle of reconstructing process performed by the differential coefficient information reconstructing unit 2150 and the adding unit 2160 will be described hereinlater.

Step 1.

The differential coefficient information reconstructing unit 2150 is operated to reconstruct the value of run to generate run-level information. The adding unit 2160 is provided with a run-length counter for counting a run-length. The adding unit 2160 is operated to set the value p to be counted by the run-length counter at the value of run. The adding unit 2160 is operative to scan a coefficient B1 (u, v) in a zigzag order.

The step 1 goes forward to the step 2.

Step 2.

The adding unit 2160 is operated to judge whether or not the value of the coefficient B1 (u, v) is greater than the value of level.

When it is judged that the value of the coefficient B1 (u, v) is greater than the value of level, the step 2 goes forward to the step 3-1. When it is, on the other hand, judged that the value of the coefficient B1(u, v) is not greater than the value of level, the step 2 goes forward to the step 3-2.

Step 3-1. B1 (u, v)>Level

The current scanning position (u, v) is set at a subsequent scanning position in a zigzag order as shown in FIG. 13. The step S3-1 goes forward to the step 4.

Step 3-2. B1 (u, v)≦Level

The run-length counter is decremented by one and the current scanning position (u, v) is set at a subsequent scanning position in a zigzag order as shown in FIG. 13. The step 3-2 goes forward to the step 4.

Step 4.

It is judged whether or not the value counted by the run-length counter is equal to zero. When it is judged that the value counted by the run-length counter is equal to zero, the value of coefficient B1 (u, v) is set at the value of level, and the step 4 goes forward to the step 5. When it is judged that the value counted by the run-length counter is not equal to zero, the step 4 goes back to the step 2.

Step 5.

The subsequent code of the run-level string is read. It is judged whether or not the subsequent code of the run-level string is EOR (End_of_Runlength). When it is judged that the subsequent code of the run-level string is EOR, the step 5 goes forward to the step 6. When it is, on the other hand, judged that the subsequent code of the run-level string is not EOR, the step 5 goes back to the step 1.

Step 6.

It is judged whether or not the value of level is equal to one. When it is judged that the value of level is equal to one, the step 6 goes to End. When it is, on the other hand, judged that the value of level is not equal to one, the value of level is decremented by one, the current scanning position (u, v) is set at an initial scanning position (0, 0). The step 6 goes back to the step 1.

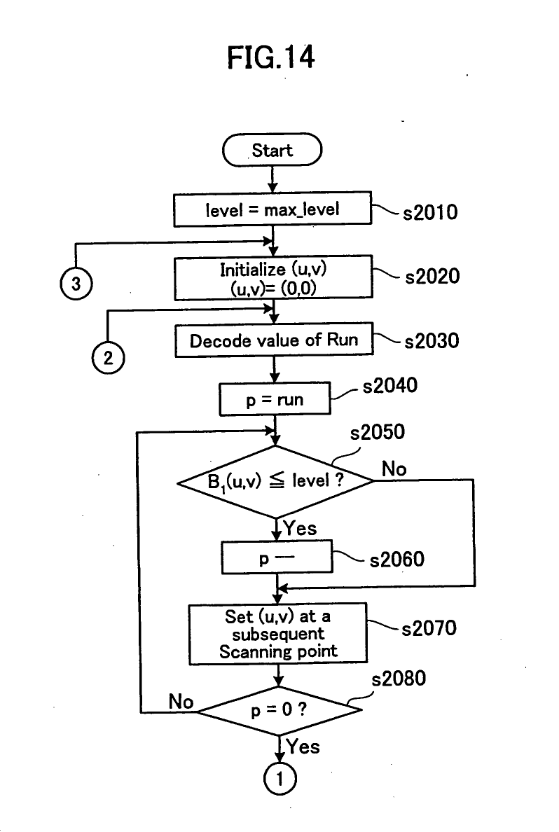

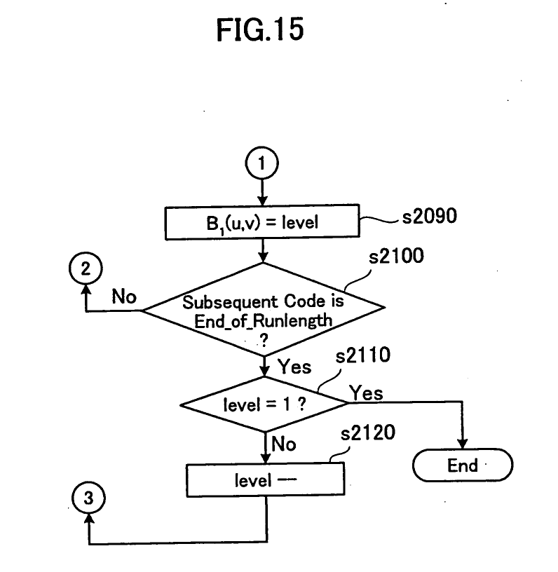

Referring then to FIGS. 14 and 15 of the drawings, there is shown a flowchart showing the flow of reconstructing differential coefficient information groups performed by the preferred embodiment of the bit stream merging apparatus 2000.

In the step S2010, the value of level is set at max_level (maximum value=m). The step S2010 goes forward to the step S2020, in which the current scanning position (u, v) is initialized at (0, 0). The step S2020 goes forward to the step S2030, in which the value of run is decoded and run-level information is generated. The step S2030 goes forward to the step S2040, in which the value p to be counted by the run-length counter is set at the value of run.

The step S2040 goes forward to the step S2050, in which it is judged whether or not the value of the coefficient B1 (u, v) is equal to or less than the value of level. If it is judged that the value of the coefficient B1 (u, v) is equal to or less than the value of level, the step S2050 goes forward to the step S2060. If it is, on the other hand, judged that the value of the coefficient B1 (u, v) is not equal to or less than the value of level, the step S2050 goes forward to the step S2070. In the step S2060, the run-length counter is decremented by one. The step S2060 goes forward to the step S2070.

In the step S2070, the current scanning position (u, v) is set at a subsequent scanning position in a zigzag order as shown in FIG. 13. The step S2070 goes forward to the step S2080, in which it is judged whether or not the value counted by counted by the run-length counter is equal to zero. If it is judged that the value counted by counted by the run-length counter is equal to zero, the step S2070 goes forward to the step S2090. If it is, on the other hand, judged that the value counted by counted by the run-length counter is not equal to zero, the step S2070 goes back to the step S2050. In the step S2090, the value of coefficient B1 (u, v) is set at the value of level. The step S2090 goes forward to the step S2100.

In the step S2100, the subsequent code of the run-level string is read. It is judged whether or not the subsequent code of the run-level string is End_of_Runlength. When it is judged that the subsequent code of the run-level string is End_of_Runlength, the step S2100 goes forward to the step S2110. When it is, on the other hand, judged that the subsequent code of the run-level string is not End_of_Runlength, the step S2100 goes back to the step S2030.

In the step S2110, it is judged whether or not the value of level is equal to one. When it is judged that the value of level is equal to one, the step S2110 goes to End. When it is, on the other hand, judged that the value of level is not equal to one, the step S2110 goes forward to the step S2120. In the step S2120, the value of level is decremented by one. The step S2120 goes back to the step S2020.

The process of merging the base bit stream B2 and a plurality of extended differential bit streams E1 to En to reconstruct the pseudo original bit stream B1 has thus far been described.

As will be seen from the foregoing description, it is to be understood that the differential coefficient information zigzag scanning unit 1240 is operative to generate a plurality of differential zero coefficient information groups in the form of run-level strings in decreasing order of the values of the zero conversion first coefficients, and delimit every adjacent two differential zero coefficient information groups with a coefficient end code EOR (End_of_Runlength), thereby making it possible for the bit stream merging apparatus 2000 to selectively merge the second pseudo original bit stream Bᵢ and one of a plurality of extended differential bit streams Ei to reconstruct the first pseudo original bit stream Bᵢ₋₁. Here, the second pseudo original bit stream Bᵢ and the first pseudo original bit stream Bᵢ₋₁, are to be respectively decoded into a second pseudo original moving picture and a first pseudo original moving picture, and the first pseudo original moving picture is more similar to the original moving picture sequence signal than the second moving picture sequence signal.

The process of merging the pseudo original bit stream Bᵢ₋₁ and one of a plurality of extended differential bit streams Ei to reconstruct the pseudo original bit stream Bi will be described hereinlater.

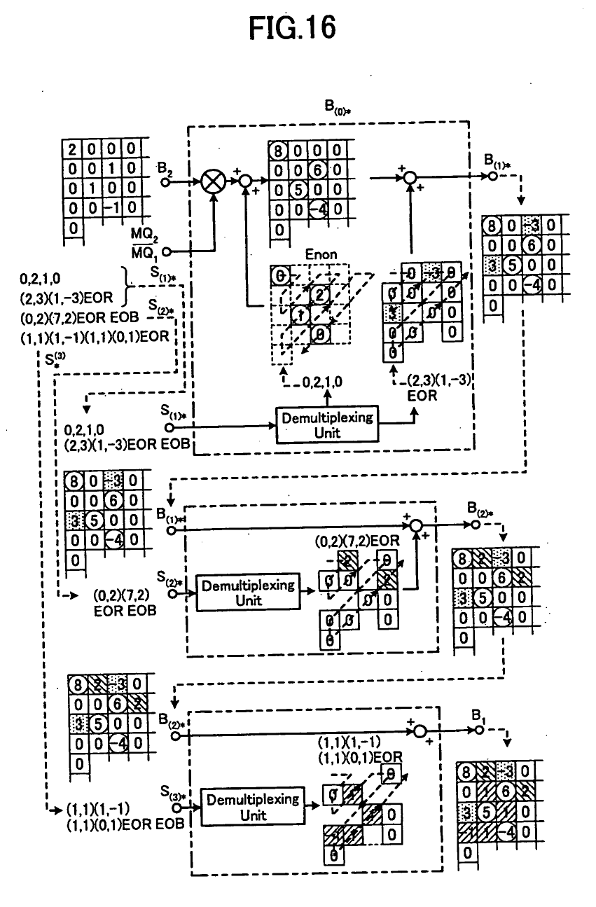

The principle of merging the second pseudo original bit stream Bi and one of the extended differential bit streams Ei to reconstruct the first pseudo original bit stream Bᵢ₋₁ will be described hereinlater with reference to FIG. 16 under the assumption that MQ1 is equal to two, MQ2 is equal to eight, and m is equal to three for simplicity and better understanding. It is assumed that the differential coefficient information zigzag scanning unit 1240 of the bit stream separating apparatus 1000 has generated extended zero coefficient information groups S(1), S(2), and S(3) as shown in FIG. 16. Each of the extended zero coefficient information groups S(1), S(2), and S(3) is in the form of a run-level string for level whose absolute value is equal to one, two, or three, and delimited with a code of EOR (End_of Runglength). In FIG. 16, a coefficient forming part of the corresponding block layer of a second bit stream B2 is referred to as “B2 (u, v)”, a coefficient forming part of the corresponding block layer of a pseudo original bit stream B1*(1) is referred to as “B1*(u, v)”, a coefficient forming part of the corresponding block layer of a pseudo original bit stream B1*(2) is referred to as “B2* (u, v)”, a coefficient forming part of the corresponding block layer of a pseudo original bit stream B1*(3) is referred to as “B3* (u, v)”, and a coefficient forming part of a block layer of a first bit stream B1 is referred to as “B₁ (u, v)”. As described earlier, the bit stream separating apparatus 1000 has generated partial non-zero coefficient information designated by Enon as follows.

$$Enon ( u , v ) = B1 ( u , v ) - \frac{MQ2}{MQ1} \times B2 ( u , v )$$

It is assumed that the bit stream separating apparatus 1000 has generated first extended differential coefficient information S(1)* including partial non-zero coefficient information Enon and a first extended zero coefficient information group S(1) in the form of a run-level string for level whose absolute value is equal to three, second extended differential coefficient information S(2)* including a second extended zero coefficient information group S(2) in the form of a run-level string for level whose absolute value is equal to two, and third extended differential coefficient information S(3)* including and a third extended zero coefficient information group S(3) in the form of a run-level string for level whose absolute value is equal to one. Each of the extended differential coefficient information S(1)*, S(2)*, and S(1)* is delimited with a code of End_of_Block (EOB) as shown in FIG. 16.

The description hereinlater will be directed to a process of merging the second coefficient block B2 with the first extended differential coefficient information S(1)* performed by the bit stream merging apparatus 2000 to reconstruct a first pseudo first coefficient block B(1)* with reference to FIG. 16.

The bit stream merging apparatus 2000 is operated to merge the second coefficient block B2 with the first extended differential coefficient information S(1)* as described hereinlater.

Firstly, the value of run is decoded to generate run-level information of the first extended differential coefficient information S(1)*.

Secondly, the second coefficient B2 (u, v) is multiplied with MQ2/MQ1 and then the partial non-zero coefficient information Enon is added to the product of the second coefficient B2 (u, v) and MQ2/MQ1 to reconstruct non-zero coefficient B(0)*(u, v) of coefficient B1 (u, v) in the form of 8 by 8 matrix of coefficients.

Thirdly, the non-zero coefficient B(0)*(u, v) of coefficient B1 (u, v) in the form of 8 by 8 matrix of coefficients is merged with the run-level information of the first extended differential coefficient information S(1)* in the form of run-level string for level whose absolute value is equal to three to reconstruct the first pseudo first coefficient B(1)*(u, v) in the form of 8 by 8 matrix of coefficients in the manner as described in the aforementioned principle of reconstructing process. The process of reconstructing the first pseudo first coefficient block B(1)* continues until the code of EOB is detected.

The first pseudo first coefficient block B(1)* thus reconstructed is in the form of 8 by 8 matrix of coefficients, respectively having absolute values being equal to or more than three as shown in FIG. 16. The abovementioned process is expressed as follows.
B2+S*(1)→B*(1)* Equation (9)

The description hereinlater will be directed to a process of merging the first pseudo first coefficient block B(1)* with the second extended differential coefficient information S(2)* performed by the bit stream merging apparatus 2000 to reconstruct a second pseudo first coefficient block B(2)* with reference to FIG. 16.

Firstly, the value of run is decoded to generate run-level information of the second extended differential coefficient information S(2)*.

Secondly, the first pseudo first coefficient B(1)*(u, v) in the form of 8 by 8 matrix of coefficients is merged with the run-level information of the second extended differential coefficient information S(2)* in the form of run-level string for level whose absolute value is equal to two to reconstruct the second pseudo first coefficient B(2)*(u, v) in the form of 8 by 8 matrix of coefficients in the manner as described in the aforementioned principle of reconstructing process. The process of reconstructing the second pseudo first coefficient block B(2)* continues until the code of EOB is detected.

The second pseudo first coefficient block B(2)* thus reconstructed is in the form of 8 by 8 matrix of coefficients, respectively having absolute values being equal to or more than two as shown in FIG. 16. The abovementioned process is expressed as follows.
B*(1)+S*(2)→B*(2) Equation (10)

The description hereinlater will be directed to a process of merging the second pseudo first coefficient block B(2)* with the third extended differential coefficient information S(3)* performed by the bit stream merging apparatus 2000 to reconstruct a first coefficient block B(1) with reference to FIG. 16.

Firstly, the value of run is decoded to generate run-level information of the third extended differential coefficient information S(3)*.

Secondly, the second pseudo first coefficient B(2)*(u, v) in the form of 8 by 8 matrix of coefficients is merged with the run-level information of the third extended differential coefficient information S(3)* in the form of run-level string for level whose absolute value is equal to one to reconstruct the first coefficient B1 (u, v) in the form of 8 by 8 matrix of coefficients in the manner as described in the aforementioned principle of reconstructing process. The process of reconstructing the first coefficient block B1 continues until the code of EOB is detected.

The first coefficient block B1 thus reconstructed is in the form of 8 by 8 matrix of coefficients, respectively having absolute values being equal to or more than one as shown in FIG. 16. The abovementioned process is expressed as follows.
B*(2)+S*(3)→B1 Equation (11)

While it has been described in the above that the bit stream merging apparatus 2000 is operative to merge the second coefficient block B2 with the first extended differential coefficient information S(1)* to reconstruct a first pseudo first coefficient block B(1)*, to merge the first pseudo first coefficient block B(1)* with the second extended differential coefficient information S(2)* to reconstruct a second pseudo first coefficient block B(2)*, and merge the second pseudo first coefficient block B(2)* with the third extended differential coefficient information. S(3)* to reconstruct a first coefficient block B(1), the bit stream merging apparatus 2000 according to the present invention may be operative to merge the second coefficient block B2 with the first extended differential coefficient information S(1)* and the second extended differential coefficient information S(2)* to reconstruct a second pseudo first coefficient block B(2)*, merge the first pseudo first coefficient block B(1)* with the second extended differential coefficient information S(2)* and the third extended differential coefficient information S(3)* to reconstruct a first coefficient block B(1) or merge the second coefficient block B2 with the first extended differential coefficient information S(1)*, the second extended differential coefficient information S(2)* and the third extended differential coefficient information S(3)* to reconstruct a first coefficient block B(1).

The description hereinlater will be directed to a process of merging the second coefficient block B2 with the first extended differential coefficient information S(1)* and the second extended differential coefficient information S(2)* to reconstruct a second pseudo first coefficient block B(2)*.

Firstly, the bit stream merging apparatus 2000 is operated to merge the first extended differential coefficient information S(1)* and the second extended differential coefficient information S(2)* to generate first and second extended differential coefficient information S(1, 2)*. The run-level information of the first and second extended differential coefficient information S(1, 2)* thus generated is in the form of run-level string for level whose absolute value is equal to two or three, and includes run-level information of the first extended differential coefficient information S(1)* and the second extended differential coefficient information S(2)*, a coefficient end code End_of_Runlength (EOR) delimiting the run-level information of the first extended differential coefficient information S(1)* with the run-level information of the second extended differential coefficient information S(2)*, and a code of End_of_Block (EOB) at the end thereof. Secondly, the second coefficient B2 (u, v) is multiplied with MQ2/MQ1 and then the partial non-zero coefficient information Enon is added to the product of the second coefficient B2 (u, v) and MQ2/MQ1 to reconstruct non-zero coefficient B(0)*(u, v) of coefficient B1 (u, v) in the form of 8 by 8 matrix of coefficients.

Thirdly, the non-zero coefficient B(0)*(u, v) of coefficient B1 (u, v) in the form of 8 by 8 matrix of coefficients is merged with the run-level information of the first and second extended differential coefficient information S(1, 2)* in the form of run-level string for level whose absolute value is equal to two or three to reconstruct the second pseudo first coefficient B(2)*(u, v) in the form of 8 by 8 matrix of coefficients in the manner as described in the above. The process of merging the non-zero coefficient B(0)*(u, v) with the run-level information of the first extended differential coefficient information S(1)* continues until the code of EOR is detected. Then, the process of merging the non-zero coefficient B(0)*(u, v) thus merged with the run-level information of the first extended differential coefficient information S(1)* with the run-level information of the second extended differential coefficient information S(2)* continues until the code of EOB is detected.

The second pseudo first coefficient block B(2)* thus reconstructed is in the form of 8 by 8 matrix of coefficients, respectively having absolute values being equal to or more than two as shown in FIG. 16. The abovementioned process is expressed as follows.
B2+S*(1,2)→B*(2) Equation (12)

The description hereinlater will be directed to a process of merging the first pseudo first coefficient block B(1)* with the second extended differential coefficient information S(2)* and the third extended differential coefficient information S(3)* to reconstruct a first coefficient block B(1).

Firstly, the bit stream merging apparatus 2000 is operated to merge the second extended differential coefficient information S(2)* and the third extended differential coefficient information S(3)* to generate second and third extended differential coefficient information S(2, 3)*. The run-level information of the second and third extended differential coefficient information S(2, 3)* is in the form of run-level string for level whose absolute value is equal to one or two, and includes run-level information of the second extended differential coefficient information S(2)* and the third extended differential coefficient information S(3)*, a coefficient end code End_of_Runlength (EOR) delimiting the run-level information of the second extended differential coefficient information S(2)* and the run-level information of the third extended differential coefficient information S(3)*, and a code of End_of_Block (EOB) at the end thereof.

Secondly, the first pseudo first coefficient block B(1)* in the form of 8 by 8 matrix of coefficients is merged with the run-level information of the second and third extended differential coefficient information S(2, 3)* in the form of run-level string for level whose absolute value is equal to one or two to reconstruct the first coefficient B(1) (u, v) in the form of 8 by 8 matrix of coefficients in the manner as described in the above. The process of merging the first pseudo first coefficient block B(1)* with the run-level information of the second extended differential coefficient information S(2)* continues until the code of EOR is detected. Then, the process of merging the first pseudo first coefficient block B(1)* thus merged with the run-level information of the second extended differential coefficient information S(2)* with the run-level information of the third extended differential coefficient information S(3)* continues until the code of EOB is detected.

The first coefficient block B(1) thus reconstructed is in the form of 8 by 8 matrix of coefficients, respectively having absolute values being equal to or more than one as shown in FIG. 16. The abovementioned process is expressed as follows.
B(1)*+S*(2,3)→B(1) Equation (13)

The description hereinlater will be directed to a process of merging the second coefficient block B2 with the first extended differential coefficient information S(1)*, the second extended differential coefficient information S(2)* and the third extended differential coefficient information S(3)* to reconstruct a first coefficient block B(1).

Firstly, the bit stream merging apparatus 2000 is operated to merge the first extended differential coefficient information S(1)*, the second extended differential coefficient information S(2)*, and the third extended differential coefficient information S(3)* to generate first, second and second extended differential coefficient information S(1, 2, 3)*. The run-level information of the first, second and third extended differential coefficient information S(1, 2, 3)* is in the form of run-level string for level whose absolute value is equal to one, two, or three, and includes run-level information of the first extended differential coefficient information S(1)*, the second extended differential coefficient information S(2)*, and the third extended differential coefficient information S(3)*, coefficient end codes End_of_Runlength (EOR) delimiting the run-level information of the first, second and the third extended differential coefficient information S(1)*, S(2)* and S(3)*, and a code of End_of_Block (EOB) at the end thereof.

Secondly, the non-zero coefficient B(0)*(u, v) of coefficient B1 (u, v) is generated in the form of 8 by 8 matrix of coefficients in a manner as described in the above.

Thirdly, the non-zero coefficient B(0)*(u, v) of coefficient B1 (u, v) in the form of 8 by 8 matrix of coefficients is merged with the run-level information of the first, second, and third extended differential coefficient information S(1, 2, 3)* in the form of run-level string for level whose absolute value is equal to one, two or three to reconstruct the first coefficient block B(1) in the form of 8 by 8 matrix of coefficients in the manner as described in the above.

The first coefficient block B(1) thus reconstructed is in the form of 8 by 8 matrix of coefficients, respectively having absolute values being equal to or more than one as shown in FIG. 16. The abovementioned process is expressed as follows.
B2+S*(1,2,3)→B(1) Equation (14)

Although illustrated and described above with reference to certain specific embodiments, the present invention is nevertheless not intended to be limited to the details shown. Rather, various modifications may be made in the details within the scope and range of equivalents of the claims and without departing from the spirit of the invention. In particular, the detailed parameters provided herein related to MQ1, MQ2, and m merely relate to exemplary embodiments, and by no means are intended to limit the invention to those embodiments, or the embodiments to those parameters.

As described in the above, the differential BS multiplexing and encoding unit 1290 is operative to multiplex and encode the upper layer information and the middle layer information inputted from the code mode switching unit 1120 and the lower layer information inputted from the prediction error calculating unit 1230 and the differential coefficient information zigzag scanning unit 1240 to generate the differential bit stream E. The lower layer information inputted from the differential coefficient information zigzag scanning unit 1240 is constituted by one or more differential zero coefficient information groups. This leads to the fact that the differential BS multiplexing and encoding unit 1290 is operative to generate an extended differential bit stream Ei in response to one of the differential zero coefficient information groups while, on the other hand, the differential BS multiplexing and encoding unit 1290 is operative to generate a plurality of extended differential bit streams E1 to En in response to a plurality of differential zero coefficient information groups inputted from the differential coefficient information zigzag scanning unit 1240.

The differential BS multiplexing and encoding unit 1290 can generate an extended differential bit stream E* in response to one or more differential zero coefficient information groups inputted from the differential coefficient information zigzag scanning unit 1240. The extended differential bit stream, for example, E*₁₊₂ generated on the basis of a plurality of differential zero coefficient information groups S* (1, 2) is greater in size than the extended differential bit stream, for example, E*₁ generated on the basis of one differential zero coefficient information group S*(1). The extended differential bit streams E1 to En thus generated are different from one another in size and, accordingly, bit rate. Each of the differential zero coefficient information groups constitutes a partial differential information segment.

From the foregoing description, it is to be understood that the bit stream separating apparatus 1000 according to the present invention is operative to generate a plurality of extended differential bit streams E1 to En respectively on the basis of a plurality of partial differential information segments, thereby enabling the bit stream separating apparatus 1000 to selectively provide a plurality of extended differential bit streams E1 to En different from one another in information and size. The bit stream separating apparatus 1000 is required to selectively transmit one or more extended differential bit streams through one or more transmission paths having respective bit rates to one or more receivers having respective requests for quality of picture. The fact that the bit stream separating apparatus 1000 can selectively provide a plurality of extended differential bit streams E1 to En different from one another in information and size leads to the fact that the bit stream separating apparatus 1000 can selectively transmit one or more extended differential bit streams E1 to En through the one or more transmission paths to the one or more receivers in accordance with the required bit rates and requests for quality of picture.

Furthermore, the original bit stream A is reconstructed by merging the base bit stream B with the differential bit stream E while, on the other hand, the pseudo original bit stream B1 is reconstructed by merging the base bit stream B with the differential bit stream E1. The differential information in the form of the bit stream E is collectively constituted by the partial differential information segments in the form of the differential zero coefficient information groups, for example, S*(1), S*(2), and S*(3). The fact that the bit stream separating apparatus 1000 according to the present invention is operative to generate a plurality of extended differential bit streams E1 to En respectively on the basis of a plurality of partial differential information segments wherein the differential information in the form of the differential bit stream E is collectively constituted by the partial differential information segments in the form of the partial differential information segments leads to the fact that the whole of the differential bit stream E is collectively constituted by the plurality of partial differential information segments and the bit stream merging apparatus 2000 can reconstruct the original bit stream A by merging the base bit stream B with the extended differential bit streams E1 to En.

While it has been described in the above that the bit stream separating apparatus 1000 is operative to generate a plurality of extended differential bit streams E1 to En different from one another in size and information, the bit stream separating apparatus 1000 according to the present invention may generate only one of the extended differential bit streams E1 to En.

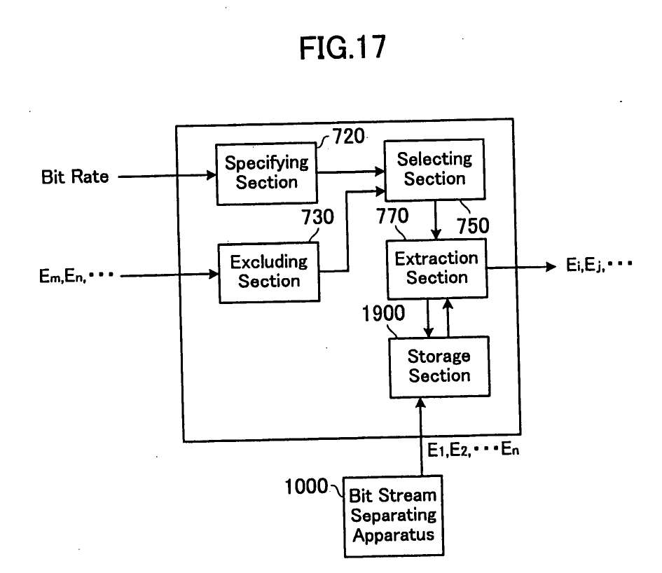

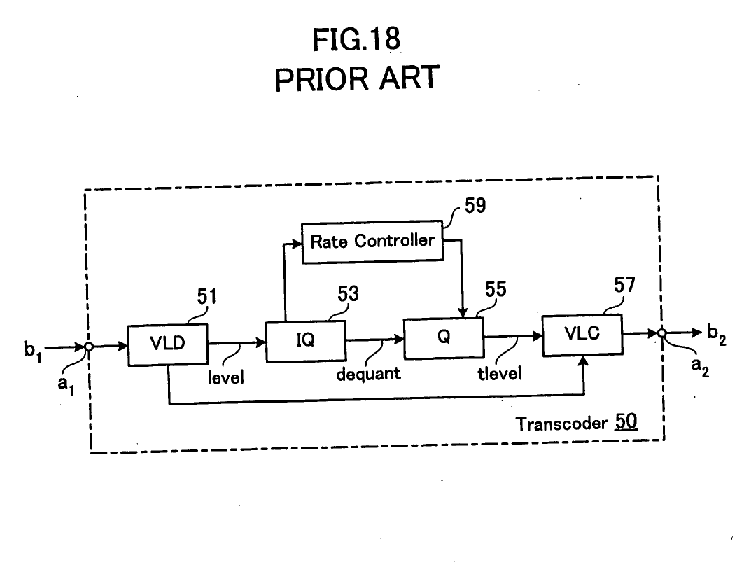

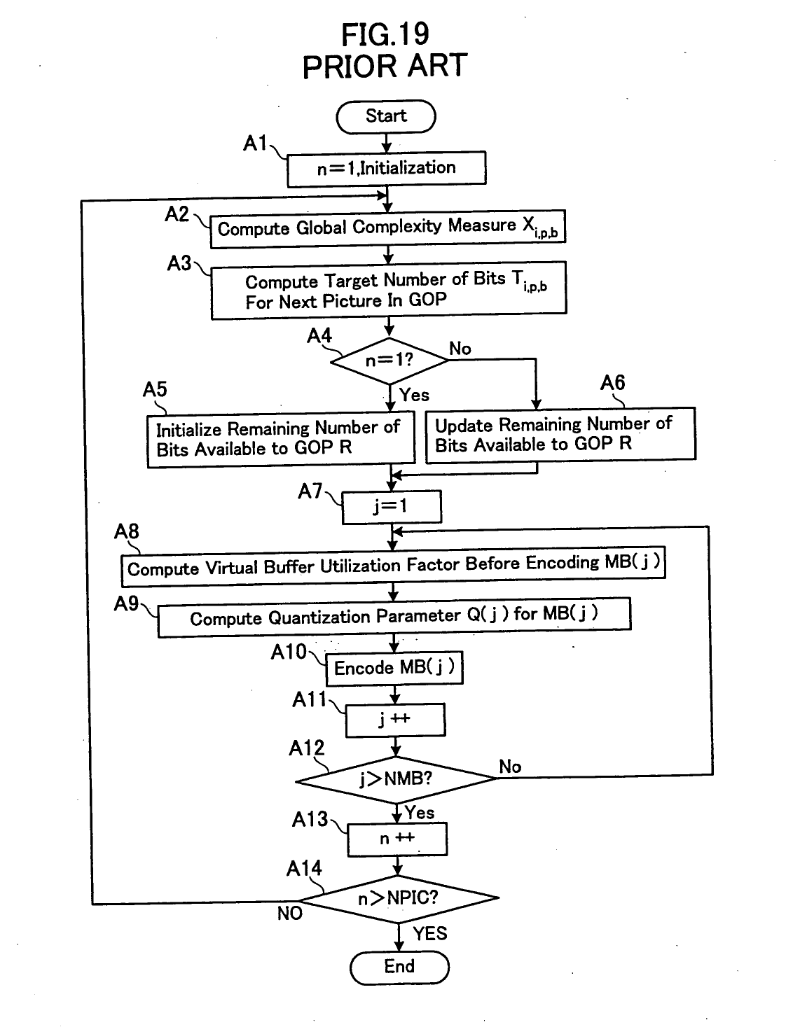

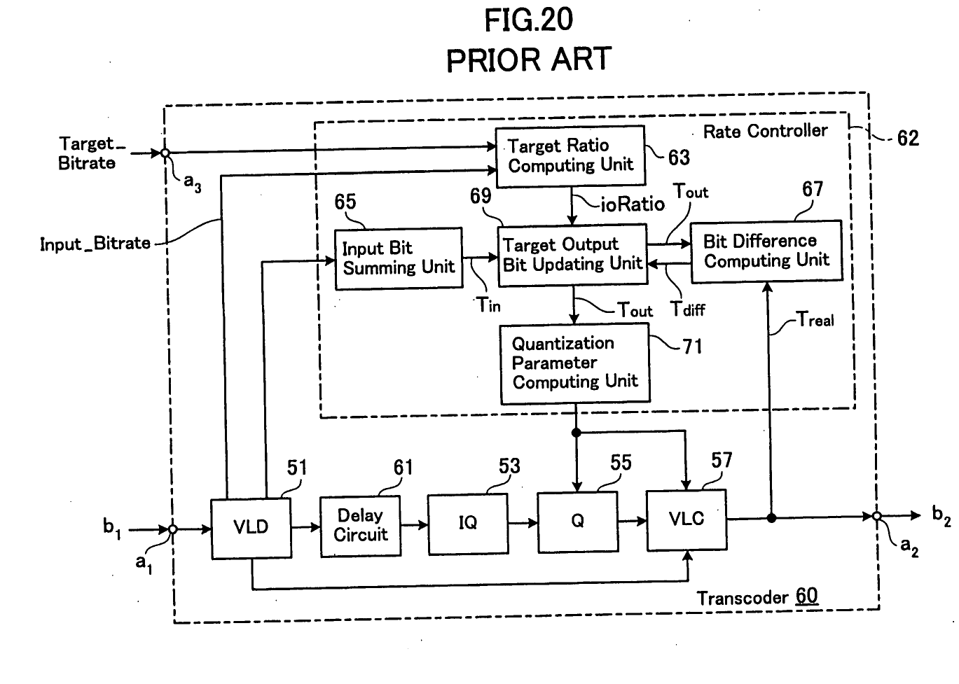

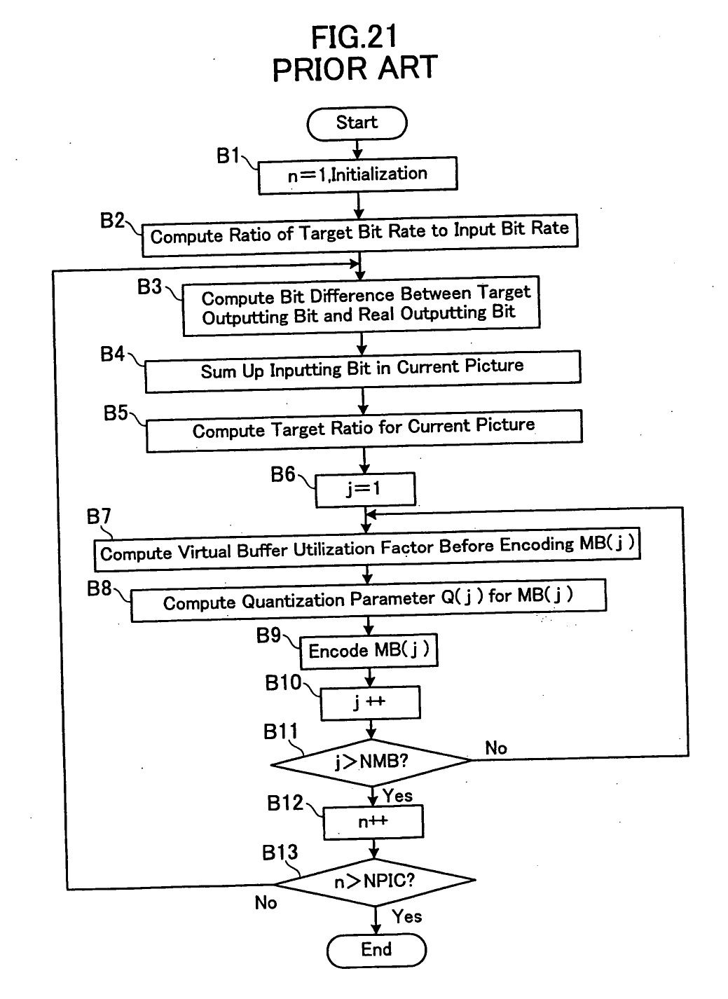

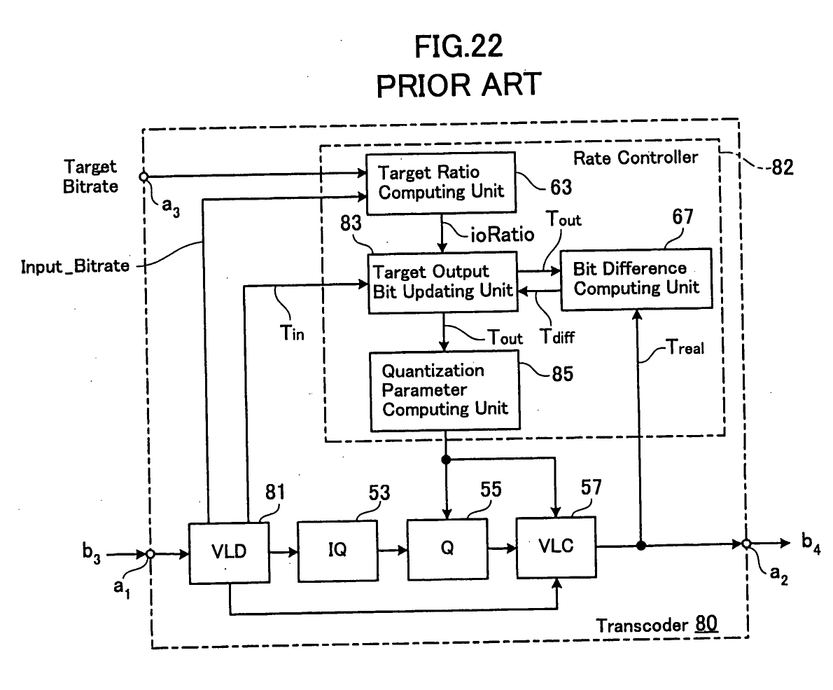

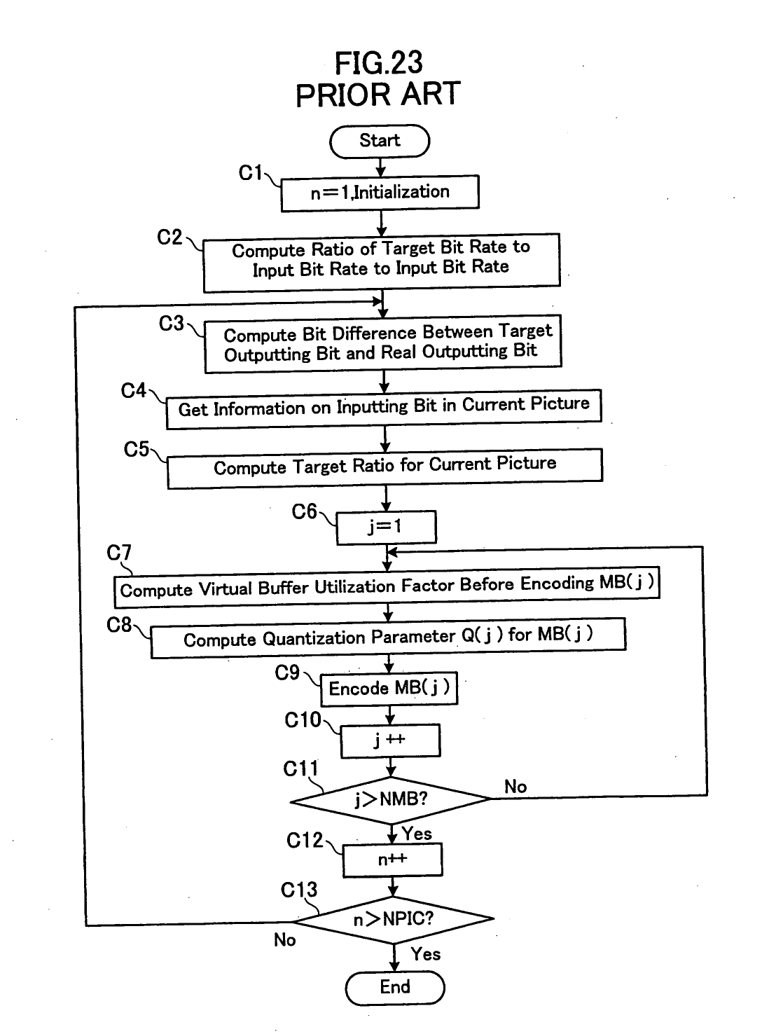

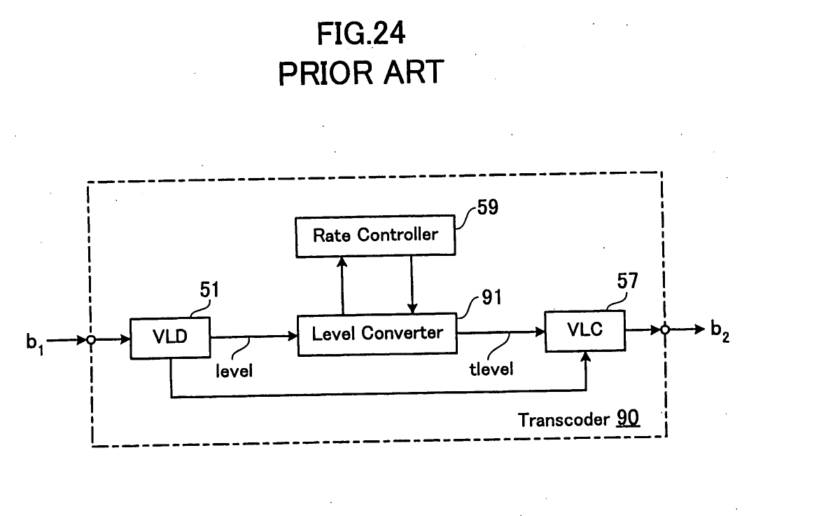

The bit stream extracting apparatus 700 according to the present invention is operative to extract one of the extended differential bit streams E1 to En from the differential bit stream E. Though it has been described in the above that the differential coded signal extracting apparatus constituted by the bit stream extracting apparatus 700 is separated from the storage section 1900 as shown in FIGS. 2, 3, and 4, the bit stream extracting apparatus 700 according to the present invention may include the storage section 1900 as will be described hereinlater with reference to FIG. 17.

According to the present invention, the bit stream extracting apparatus 700 may comprise: differential coded moving picture sequence signal storage means constituted by a storage section 1900 for storing a plurality of extended differential coded moving picture sequence signals in the form of extended differential bit streams E1 to En generated on the basis of partial differential information segments constituting differential information between a first coded moving picture sequence signal, viz., an original bit stream A and a second coded moving picture sequence signal, viz., a base bit stream B in the form of differential bit stream E, differential coded moving picture sequence signal selecting means constituted by a selecting section 750 for selecting a desired extended differential bit stream Ei from among the plurality of extended differential bit streams; and differential coded moving picture sequence signal extracting means constituted by an extracting section 770 for extracting the desired extended differential bit stream Ei selected by the selecting section 750 from among the plurality of extended differential bit streams E1 to En stored in the storage section 1900. The bit stream extracting apparatus 700 thus constructed makes it possible for a user to extract a desired extended differential bit stream Ei from among the plurality of extended differential bit streams E1 to En stored in the storage section 1900.

According to the present invention, each of the extended differential bit streams E1 to En has a bit rate, and the bit stream extracting apparatus 700 may further comprises bit rate specifying means constituted by a specifying section 720 for specifying a desired bit rate of the extended differential bit stream. The selecting section 750 may be operative to select a desired extended differential bit stream Ei having a bit rate substantially equal to said desired bit rate from among the plurality of extended differential bit streams E1 to En on the basis of the desired bit rate of the extended differential bit stream specified by the specifying section 720. The bit stream extracting apparatus 700 thus constructed makes it possible for a user to extract a desired extended differential bit stream Ei having a bit rate substantially equal to said desired bit rate from among the plurality of extended differential bit streams E1 to En stored in the storage section 1900.

In the aforesaid bit stream extracting apparatus 700, the desired extended differential bit stream Ei may be transmitted through a transmission path at a predetermined transmission bit rate for a predetermined transmission time period, and the selecting section 720 may be operative to specify the bit rate of the extended differential bit stream on the basis of the transmission bit rate and the transmission time period. The bit stream extracting apparatus 700 thus constructed enables to extract a desired extended differential bit stream Ei from among the plurality of extended differential bit streams E1 to En stored in the storage section 1900 on the basis of the transmission bit rate and the transmission time period, thereby making it easy for a user to extract the desired extended differential bit stream Ei most appropriate to the given transmitting conditions.

According to the present invention, the aforementioned bit stream extracting apparatus 700 may further comprise excluding means constituted by an excluding section 730 for excluding one or more extended differential bit streams Em, En from among the plurality of extended differential bit streams E1 to En. The selecting section 750 may be operative to select a desired extended differential bit stream Ei from among the plurality of extended differential bit streams E1 to En except for the one or more extended differential bit streams Em, En excluded by the excluding section 730. The bit stream extracting apparatus 700 thus constructed enables to extract a desired extended differential bit stream Ei from among the plurality of extended differential bit streams E1 to En stored in the storage section 1900 except for the one or more extended differential bit streams Em, En excluded by the excluding section 730, thereby making it easy for a user to prevent extended differential bit streams already transmitted to the receiving party from being transmitted redundantly.

As will be understood from the foregoing description, it is to be understood that the bit stream extracting apparatus 700 enables a user to receive one or more extended differential bit streams each at a bit rate lower than that of the original bit stream A to reconstruct a pseudo original bit stream Bi approximately similar to the original bit stream A in combination with the base bit stream B already received or stored.

Though it has been described in the above that the bit stream extracting apparatus 700 is separated from the bit stream separating apparatus 1000, the bit stream extracting apparatus 700 according to the present invention may be integrated with the bit stream separating apparatus 1000.

As will be seen from the forgoing description, it is to be understood that the bit stream separating apparatus 1000 according to the present invention can transcode an original bit stream A to separate into and generate a base bit stream B and one or more extended bit streams E1 to En. Each of the one or more extended bit streams E1 to En is generated on the basis of the original bit stream A and a partial differential information segment constituting differential information between the original bit stream A and the base bit stream B. The partial differential information segment is partly constituted by one of differential zero coefficient information groups, for example, S(1), S(2), and S(3) shown in FIG. 10. The bit stream merging apparatus 2000 according to the present invention can merge the base bit stream B and one or more the extended differential bit streams E1 to En to reconstruct a pseudo original bit stream Bi, which is approximately similar to the original bit stream A. The bit stream merging apparatus 2000 thus constructed make it possible for a user to firstly receive the base bit stream B at a bit rate lower than that of the original bit stream A to reproduce a low-quality picture information, and later receive the one or more extended differential bit streams E1 to En to reconstruct a pseudo original bit stream Bi approximately similar to the original bit stream A. Furthermore the bit stream separating apparatus 1000 and the bit stream merging apparatus 2000 thus constructed make it possible for a user to decode or transcode the moving picture sequence signal without any additional dedicated encoders or decoders unlike the aforesaid scalability and data partitioning methods. The differential bit stream generator 1200 forming part of the bit stream separating apparatus 1000 constitutes a differential coded signal generating apparatus according to the present invention.

According to the present invention, all the functions of the present embodiments of the bit stream separating apparatus 1000, the bit stream merging apparatus 2000, the bit stream extracting apparatus 700, and the differential bit stream generator 1200 may be performed by a computer comprising a central processing unit, hereinlater referred to as a “CPU”, and computer usable storage medium such as a floppy disk, a CD-ROM, a DVD-ROM, a hard disk, and so on, having computer readable code embodied therein for performing a set of method steps necessary to implement all of the functions of the aforesaid constituent elements of the present embodiments of the bit stream separating apparatus 1000, the bit stream merging apparatus 2000, the bit stream extracting apparatus 700, and the differential bit stream generator 1200.

It will be apparent to those skilled in the art and it is contemplated that variations and/or changes in the embodiments illustrated and described herein may be without departure from the present invention. Accordingly, it is intended that the foregoing description is illustrative only, not limiting, and that the true spirit and scope of the present invention will be determined by the appended claims.

### INDUSTRIAL APPLICABILITY

According to the present invention, the bit stream separating apparatus can input and transcode an original bit stream A to separate into and generate a base bit stream B, which is to be firstly transmitted, and one or more extended differential bit streams E*, which are to be later transmitted, and the bit stream merging apparatus makes it possible for a user to receive the one or more extended differential bit streams E* at respective bit rates each lower than that of original bit stream A to reconstruct the original bit stream A or a pseudo original bit stream B* in combination with the base bit stream B already received or stored wherein each of the extended differential bit streams has a partial differential information segment between the original bit stream A and the base bit stream B.

1. A coded signal separating apparatus for transcoding a first coded moving picture sequence signal to generate a second coded moving picture sequence signal and an extended differential coded moving picture sequence signal on the basis of said first coded moving picture sequence signal and a partial differential information segment constituting differential information between said first coded moving picture sequence signal and said second coded moving picture sequence signal, comprising:
inputting means for inputting said first coded moving picture sequence signal therethrough, said first coded moving picture sequence signal generated as a result of encoding an original moving picture sequence signal and having a series of first picture information including first coefficient information;
coded signal converting means for converting said first coded moving picture sequence signal inputted through said inputting means to generate said second coded moving picture sequence signal, said second coded moving picture sequence signal to be decoded into a second moving picture sequence signal approximately similar to said original moving picture sequence signal and having a series of second picture information including second coefficient information; and
differential coded signal generating means for inputting said first coded moving picture sequence signal and said second coded moving picture sequence signal from said coded signal converting means to generate said extended differential coded moving picture sequence signal,
said differential coded signal generating means being operative to generate said extended differential coded moving picture sequence signal on the basis of said partial differential information segment constituting said differential information including a difference between said first coefficient information of said first picture information of said first coded moving picture sequence signal and said second coefficient information of said second picture information of said second coded moving picture sequence signal.

2-72. (canceled)
